(19) United States
(12) Patent Application Publication
(10) Pub. No.: US 2023/0352660 A1
(43) Pub. Date: Nov. 2, 2023

(54) ELECTRODES FOR ENERGY STORAGE DEVICES

(71) Applicant: FastCAP Systems Corporation, Wakefield, MA (US)

(72) Inventors: Nicolo Brambilla, Brookline, MA (US); Wanjun Ben Cao, Boston, MA (US); Ji Chen, Natick, MA (US); Thomas M. Yu, Brookline, MA (US)

(21) Appl. No.: 18/220,050

(22) Filed: Jul. 10, 2023

Related U.S. Application Data
(63) Continuation-in-part of application No. 18/081,057, filed on Dec. 14, 2022.
(60) Provisional application No. 63/290,284, filed on Dec. 16, 2021.

(51) Int. Cl. H01M 4/36; H01M 4/525; H01M 4/505; H01M 4/58; H01M 4/131; H01M 4/38; H01M 4/587; H01M 4/134; H01M 4/133

(52) U.S. Cl. CPC H01M 4/364; H01M 4/525; H01M 4/505; H01M 4/5825; H01M 4/131; H01M 4/386; H01M 4/587; H01M 4/134; H01M 4/133

(57) ABSTRACT

An electrode for an energy storage device is disclosed. The electrode includes an active layer. The active layer includes a network of high aspect ratio carbon elements defining void spaces within the network, a plurality of electrode active material particles disposed in the void spaces within the network, wherein the active material particles comprise silicon, and a polymeric additive, the polymeric additive being at least one of a polyolefin, a Poly(acrylic acid), and a styrene-butadiene rubber (SBR).

### CROSS REFERENCE TO RELATED APPLICATIONS

This application is a continuation in part of U.S. patent application having Ser. No. 18/081,057, filed on Dec. 14, 2022, which claims the benefit of U.S. Application No. 63/290,284, filed on Dec. 16, 2021, which is incorporated herein by reference in its entirety.

### BACKGROUND

Lithium batteries are used in many products including medical devices, electric cars, airplanes, and consumer products such as laptop computers, cell phones, and cameras. Due to their high energy densities, high operating voltages, and low-self discharges, lithium ion batteries have overtaken the secondary battery market and continue to find new uses in products and developing industries.

Generally, lithium ion batteries (“LIBs” or “LiBs”) comprise an anode, a cathode, and an electrolyte material such as an organic solvent containing a lithium salt. More specifically, the anode and cathode (collectively, “electrodes”) are formed by mixing either an anode active material or a cathode active material with a binder and a solvent to form a paste or slurry which is then coated and dried on a current collector, such as aluminum or copper, to form a film on the current collector. The anodes and cathodes are then layered or coiled prior to being housed in a pressurized casing containing an electrolyte material, which all together forms a lithium ion battery.

Conventional electrodes use a binder with sufficient adhesive and chemical properties such that the film coated on the current collector will maintain contact with the current collector even when manipulated to fit into the pressurized battery casing. Because the film contains the electrode active material, there will likely be significant interference with the electrochemical properties of the battery if the film does not maintain sufficient contact with the current collector. Further, it has been important to select a binder that is mechanically compatible with the electrode active material(s) such that it is capable of withstanding the degree of expansion and contraction of the electrode active material(s) during charging and discharging of the battery. Accordingly, binders such as cellulosic binder or cross-linked polymeric binders have been used to provide good mechanical properties. However, in conventional electrodes binders selected generally require environmentally unfriendly or toxic solvents for processing.

Another area for improving the performance of energy storage devices for such electronic devices is the use of silicon based anodes in the LiBs. Although silicon exhibits excellent charge storage properties, silicon disadvantageously undergoes significant mechanical swelling when accepting charge. This swelling can cause mechanical failures in an electrode, rendering them unsuitable for use.

Accordingly, there this been interest in using composite structures of carbon and silicon to provide a high-performance electrode with suitable mechanical stability during charging and discharging processing. For example, consider International Patent Application No. PCT/US2019/013261, entitled “Silicon Micro-Reactors for Lithium Rechargeable Batteries,” the entire contents of which is incorporated herein by reference in its entirety. The '261 application discloses a process for fabricating a composite silicon carbon anode. Another example is provided in U.S. Pat. No. 10,340,520, issued Jul. 2, 2019 and entitled “Nanocomposite battery electrode particles with changing properties,” the entire contents of which is incorporated herein in its entirety. The '520 patent discloses silicon containing carbon nanoshell particles for use in electrodes.

However, in many cases, such approaches are not suitable for rapid, low cost manufacture, and may exhibit a number of other disadvantageous features. For example, in some cases electrodes made using these approaches require the inclusion of polymer binders, which reduce the performance of the electrode, and may make it unsuitable for use under operating conditions such as high voltage or high temperature.

There is a continuing need for increased power and energy in energy storage devices such as batteries and capacitors. What are needed are advancements in the physics and chemistry of electrode technology that provide for such improvements.

Production of lithium ion batteries often relies on toxic and expensive components such as solvents and fluorinated polymers to provide the desired stability and performance for the finished energy storage devices. Recycling of toxic and/or expensive solvents during manufacturing increases costs and process complexity. Furthermore, fluorine-containing binders, such as polyvinylidene fluoride (PVDF) and polytetrafluoroethylene (PTFE), both are per- and polyfluoroalkyl substances known as PFAs, introduce toxic and potentially bioaccumulating decomposition products.

A need remains for more environmentally friendly, less expensive, PFAs-free manufacturing of electrodes for energy storage devices.

### BRIEF DESCRIPTION OF THE DRAWINGS

The following is a brief description of the drawings wherein like elements are numbered alike and which are presented for the purposes of illustrating the exemplary embodiments disclosed herein and not for the purposes of limiting the same.

FIG. 1A is a diagram of an electrode according to various embodiments.

FIG. 1B is a diagram of an electrode according to various embodiments.

FIG. 1C is a diagram of an electrode according to various embodiments.

FIG. 2 is a diagram of an electrode according to various embodiments.

FIG. 3 is a diagram of an electrode according to various embodiments.

FIG. 4 is an example of an electron micrograph of an active layer according to various embodiments.

FIG. 5 is a schematic of an energy storage device.

FIG. 6 is a flow chart of a method for making an electrode according to various embodiments.

FIG. 7 shows a schematic of a pouch cell battery.

FIG. 8 is a schematic cutaway diagram depicting aspects of an energy storage device (ESD).

FIG. 9 is a schematic cutaway diagram depicting aspects of a prior art storage cell of the energy storage device (ESD) of FIG. 8.

FIGS. 10-19 are graphs depicting aspects of electrical performance of energy storage cells assembled according to various embodiments.

FIG. 20 is a schematic diagram depicting aspects of an energy storage cell assembled according to various embodiments.

FIG. 21 is a schematic diagram depicting aspects of an energy storage cell assembled according to various embodiments.

FIG. 22 is a chart depicting electrical performance of energy storage cells assembled according to various embodiments.

FIGS. 23-29 are graphs depicting aspects of electrical performance of energy storage cells assembled according to various embodiments.

FIG. 30 is a chart depicting electrical performance of energy storage cells assembled according to various embodiments.

FIG. 31 is a graph depicting electrical performance of energy storage cells assembled according to various embodiments.

FIGS. 32-33 are charts depicting electrical performance of energy storage cells assembled according to various embodiments.

FIGS. 34-36 are graphs depicting electrical performance of energy storage cells assembled according to various embodiments.

FIGS. 37-41 are graphs depicting specific capacity of energy storage cells for various compositions of anodes and cathodes in respective cells.

### DETAILED DESCRIPTION

A more complete understanding of the components, processes, and apparatuses disclosed herein can be obtained by reference to the accompanying drawings. These figures are merely schematic representations based on convenience and the ease of demonstrating the present disclosure, and are, therefore, not intended to indicate relative size and dimensions of the devices or components thereof and/or to define or limit the scope of the exemplary embodiments. Although specific terms are used in the following description for the sake of clarity, these terms are intended to refer only to the particular structure of the embodiments selected for illustration in the drawings, and are not intended to define or limit the scope of the disclosure. In the drawings and the following description below, it is to be understood that like numeric designations refer to components of like function.

Various embodiments provide an energy storage device comprising an anode having a relatively high loading of silicon particles. Silicon is relatively cheap and has a relatively high specific capacity. Accordingly, silicon can be used to increase capacities of energy storage device. However, silicon expands/swells during a charging phase of an energy storage device. Swelling of silicon during a charging phase can cause mechanical stress on the anode. Various embodiments provide a robust network of carbon elements to at least provide a strong mechanical support to maintain electrical connectivity and mechanical resilience throughout the charging/discharging cycle of the energy storage device.

Various embodiments provide an electrode that exhibits strong electrical performance and strong mechanical stability, and comprising a polymeric additive that promotes a safe and clean manufacturing process and energy storage device. Various embodiments provide an electrode that does not include (e.g., is free of) a polymeric additive that is not soluble in one or more of water or an alcohol such as ethanol. In some embodiments, the electrode is substantially free of a polymeric additive that is not soluble in one or more of water or an alcohol such as ethanol. In some embodiments, an active layer of the electrode is free, or substantially free, of a polymeric additive that is not soluble in one or more of water or an alcohol such as ethanol. For example, any polymeric additive to an electrode according to various embodiments is soluble in one or more of water and an alcohol.

According to various embodiments, an electrode comprises an active layer. In some embodiments, the active layer includes: (i) a network of high aspect ratio carbon elements defining void spaces within the network, (ii) a plurality of electrode active material particles disposed in the void spaces within the network, wherein the active material particles comprises silicon, and (iii) a polymeric additive. In some embodiments, the silicon comprised in the active material particles comprises one or more of silicon oxide and microsilicon. In some embodiments the polymeric additive is water process-able.

Disclosed herein too is a semi-dry method for preparing an electrode slurry comprising mixing a carbonaceous conductive material, a solvent, an active material, and a polymer binder to form an electrode slurry, wherein the electrode slurry has a fluorine content of less than 900 parts per million.

Disclosed herein too is a battery cell comprising a cathode comprising a cathode current collector and a cathode active layer, wherein the cathode active layer include one or more of LFP, LiCoO₂, LiNiO₂, LiNiMnCoO₂, LiNiO₂, LiMn₂O₄, LiFePO₄, and LiNiₓMn_{y}Co_{1-x-y}O₂, nickel cobalt manganese (NCM), nickel cobalt manganese aluminum (NCMA), or a combination thereof, where x has a value 0.7 to 0.85 and where y is greater than 0.1; and wherein the cathode active layer contacts the cathode current collector; an anode that comprises an anode current collector and an anode active layer; where the anode active layer comprises an anode active material that includes graphite mixed with LiₓSi_{y}O_{z}, where x is 1 to 15, y is 1 to 4 and z is 1 to 9; the anode active layer contacts the anode current collector; wherein both the anode active layer and the cathode active layer each comprise high aspect ratio carbon elements; wherein the battery cell has a fluorine content of less than 900 parts per million.

In an embodiment, the cathode active layer comprises Lithium Manganese Iron Phosphate (LMFP). LMFP's having a formula of LiMnₓFe₁₋ₓPO₄ (where x is equal to 0.03 to 0.95, preferably 0.1 to 0.7, and more preferably 0.25 to 0.5) combine the high safety of LiFePO₄ and the high energy density of LiMnPO₄. Variations of LMFP such as LiMn_{1-y}Fe_{y}PO₄, where y varies from 0.05 to 0.4 may also be used.

The addition of manganese to the LFP cathode allows for higher energy densities, but without any significant increases in cost. Thus, an LMFP cell could offer a higher energy density than an LFP cell but would remain far below NCM or NCA cell chemistries in terms of cost. In an embodiment, the anode layer of a battery cell contains SiOₓ (as the active material), while the cathode contains LMFP as the active material.

Disclosed herein too is an energy storage device comprising a housing; a separator a cathode and an anode disposed in the housing; where the anode and cathode are disposed on opposite sides of the separator; and where the cathode and the anode each comprises a current collector with an active layer disposed thereon; where the active layer comprises a carbonaceous conductive material, an active material, and a binder; wherein the active layer has a fluorine content of less than 900 parts per million.

In an exemplary embodiment, disclosed herein is an energy storage device comprising an anode and a cathode disposed on opposing sides of a separator. The active layer used in the anode (i.e., the anode active layer) comprises an anode active material—SiOx, where x has a value of 1 to 4, preferably 3 to 4 and binder with a fluorine content of less than 900 parts per million. The SiOx may be present in an amount of 5 to 80 wt %, preferably 10 to 70 wt %, and more preferably 20 to 60 wt %, based on a total weight of the anode active layer.

In an embodiment, the anode active layer may also contain graphite. A combined graphite-SiOx anode active material is preferred, with the SiOx content present in an amount of 5 to 80 wt %, preferably 10 to 70 wt %, and more preferably 20 to 60 wt %, based on a total weight of the anode active material, with the remainder being graphite. The anode active material is present in the anode active layer in an amount of greater than 85 wt %, preferably greater than 90 wt %, and more preferably in an amount of greater than or equal to 95 wt %, with the remainder being a fluorine free binder. The fluorine free binder may contain less than 900 ppm of fluorine as detailed elsewhere in this document. The anode layer may also contain an electrically conducting additive. The electrically conducting additives are described in detail elsewhere in this document.

The active layer used in the cathode contains LMFP and NCM in a blend that varies from 0 to 100 wt %, based on a total amount of LMFP and NCM. In a preferred embodiment, the LMFP is LiMnₓFe₁₋ₓPO₄ (where x is equal to 0.03 to 0.4, preferably 0.1 to 0.3). The NCM is NCM811 (80 wt % of nickel, 10 wt % of cobalt and 10 wt % of manganese (8:1:1)). Other forms of NCM may also be used. Examples include NCM111, NCM523, NCM622. Combinations of any of the foregoing NCMs may also be used in conjunction with the LMFP.

In an embodiment, the cathode active material contain the LMFP in an amount of 0.05 to 100 wt %, preferably 1 to 30 wt %, and more preferably 10 to 25 wt %, based on a total weight of the cathode active material, with the remainder being the NMC. In an embodiment, the cathode active layer comprises the cathode active material and a fluorine free binder. The fluorine free binder may contain less than 900 ppm of fluorine as detailed elsewhere in this document. The cathode layer may also contain an electrically conducting additive. The electrically conducting additives are described in detail elsewhere in this document

In some embodiments, the polymeric additive comprises one or more of a polyolefin, a poly(acrylic acid), and a styrene-butadiene rubber (SBR). In some embodiments, an amount of the polymeric material comprised in active layer is about 8% by weight of the active layer. In some embodiments, an amount of the polymeric material comprised in active layer is equal to or less than 8% by weight of the active layer. In some embodiments, an amount of the polymeric material comprised in active layer is about 10% by weight of the active layer. In some embodiments, an amount of the polymeric material comprised in active layer is equal to or less than 10% by weight of the active layer. In some embodiments, an amount of the polymeric material comprised in active layer is less 12% by weight of the active layer. In some embodiments, an amount of the polymeric material comprised in active layer is less 15% by weight of the active layer.

According to various embodiments, the active layer comprises a polymeric additive that comprises a polyolefin. In some embodiments, an average particle size of the polyolefin is 1 μm. or less. In some embodiments, the polyolefin comprises an unsaturated hydrocarbon having 3 to 6 carbon atoms, and is at least one of a propylene component and a 1-butene component. In some embodiments, the polymeric additive comprising a polyolefin is manufactured using a polyefin resin comprising 50 to 98% by mass of an unsaturated hydrocarbon having 3 to 6 carbon atoms and 0.5 to 20% by mass of an unsaturated carboxylic acid unit. In some embodiments, the polyolefin comprises an ethylene component. In some embodiments, the polyolefin comprises (i) an unsaturated hydrocarbon having 3 to 6 carbon atoms, and is at least one of a propylene component and a 1-butene component, and (ii) an ethylene component. In some embodiments, the polyolefin comprises a cross-linking agent and/or a tackifier. In some embodiments, the polyolefin comprises at least one selected from the group consisting of maleic anhydride, acrylic acid and methacrylic acid.

According to various embodiments, an electrode comprises an active layer. In some embodiments, the active layer includes: (i) a network of high aspect ratio carbon elements defining void spaces within the network, (ii) a plurality of electrode active material particles disposed in the void spaces within the network, and (iii) a polymeric additive. In some embodiments, the polymeric additive comprises one or more of a polyolefin, a Poly(acrylic acid), and a styrene-butadiene rubber (SBR). In some embodiments, the silicon comprised in the active material particles comprises one or more of silicon oxide and microsilicon.

In some embodiments, the active layer comprises between 20% and 95% silicon-based particles by weight in relation to the weight of the active layer. In some embodiments, the active layer comprises between 50% and 95% silicon-based particles by weight in relation to the weight of the active layer. In some embodiments, the active layer comprises greater than 75% silicon-based particles by weight in relation to the weight of the active layer. In some embodiments, the active layer comprises greater than 80% silicon-based particles by weight in relation to the weight of the active layer. In some embodiments, the active layer comprises between 20% and 75% silicon-based particles by weight in relation to the weight of the active layer. In some embodiments, the active layer comprises greater than 20% silicon particles (e.g., microsilicon) by weight in relation to the weight of the active layer. In some embodiments, the active layer comprises between 20% and 40% silicon particles (e.g., microsilicon) by weight in relation to the weight of the active layer. In some embodiments, the active layer comprises between 30% and 40% silicon particles (e.g., microsilicon) by weight in relation to the weight of the active layer. In some embodiments, the active layer comprises greater than 50% silicon-oxide particles by weight in relation to the weight of the active layer. In some embodiments, the active layer comprises between 60% and 70% silicon-oxide particles by weight in relation to the weight of the active layer.

In other embodiments, the anode active material can include elemental microparticle or nanoparticles of elemental Si either raw or engineered, either or alone or in combination with other anode active materials. In an embodiment, the anode layer contains an anode active material in the form of SiOx where x can vary from 2.5 to 5, preferably 3 to 4. The anode weight fraction of SiOx can be varied from 0.05 to 0.4, based on a total weight of the anode active layer. In other words, the anode active layer can contain SiOx in an amount of 5 to 40 wt %, preferably 10 to 30 wt %, based on a total weight of the active layer.

According to various embodiments, the active layer comprises silicon-based particles. In some embodiments, the active layer comprises both microsilicon particles and silicon-oxide particles. In some embodiments, the active layer comprises microsilicon particles and is substantially free of silicon-oxide particles (e.g., the active layer does not comprise any silicon-oxide particles). Silicon-oxide particles do not appear to expand to the same extent as microsilicon (e.g., pure silicon). For example, the oxide layer around silicon is sufficiently large that expansion of the silicon in the silicon-oxide does not generally expand the silicon-oxide too significantly. In contrast, microsilicon expands and contracts to a greater extent than silicon-oxide thereby creating more challenges maintaining the electrical and/or mechanical properties of the electrode (e.g., the anode). For example, the expansion of the microsilicon can break down the electrical connection within the electrode (e.g., in the active layer), or the mechanical stability of the electrode. Various embodiments provide a network of high aspect ratio carbon elements that maintain electrical connection and mechanical support through the charging/discharging cycling. In an embodiment, the anode layer contains an anode active material in the form of SiOx where x can vary from 2.5 to 5, preferably 3 to 4. The anode weight fraction of SiOx can be varied from 0.05 to 0.4, based on a total weight of the anode active layer.

According to various embodiments, an electrode comprises an active layer. In some embodiments, the active layer includes: (i) a network of high aspect ratio carbon elements defining void spaces within the network, (ii) a plurality of electrode active material particles disposed in the void spaces within the network, the plurality of electrode active material particles comprising a plurality of silicon-based particles (e.g., microsilicon, silicon-oxide, etc.), and (iii) a polymeric additive. The polymeric additive has a relatively high molecular weight. In some embodiments, the polymeric additive has a molecular weight of at least 400,000 g/mol. In some embodiments, the polymeric additive has a molecular weight of at least 1,000,000 g/mol. In some embodiments, the polymeric additive has a molecular weight of at least 1,500,000 g/mol. In some embodiments, the polymeric additive has a molecular weight between 700,000 g/mol and 1,500,000 g/mol. In some embodiments, the polymeric additive has a molecular weight between 500,000 g/mol and 1,000,000 g/mol.

According to various embodiments, an electrode comprises an active layer. In some embodiments, the active layer includes: (i) a network of high aspect ratio carbon elements defining void spaces within the network, (ii) a plurality of electrode active material particles disposed in the void spaces within the network, the plurality of electrode active material particles comprising a plurality of silicon-based particles (e.g., microsilicon, silicon-oxide, etc.), and (iii) a polymeric additive. The polymeric additive has a relatively high tensile strength. For example, the polymer additive comprises a polymer that is difficult to stretch. In some embodiments, the polymeric additive has a relatively high tensile strength and is process-able in water or alcohol. In some embodiments, the polymeric additive has a relatively high tensile strength and is process-able in water (e.g., relatively easily processable using water). In some embodiments, the polymer additive comprises a polymer exhibiting a stress greater than 20 MPa at a strain of about 10%. In some embodiments, the polymer additive comprises a polymer exhibiting a stress greater than 30 MPa at a strain of about 10%. In some embodiments, the polymer additive comprises a polymer exhibiting a stress between 30 MPa and 35 MPa at a strain of about 10%. In some embodiments, the polymer additive comprises a polymer exhibiting a stress greater than 10 MPa at a strain of about 20%. In some embodiments, the polymer additive comprises a polymer exhibiting a stress greater than 20 MPa at a strain of about 20%. In some embodiments, the polymer additive comprises a polymer exhibiting a stress greater than 25 MPa at a strain of about 20%. In some embodiments, the polymer additive comprises a polymer exhibiting a stress between 25 MPa and 30 MPa at a strain of about 20%. In some embodiments, the polymer additive comprises a polymer exhibiting a stress greater than 15 MPa at a strain of 5%. In some embodiments, the polymer additive comprises a polymer exhibiting a stress greater than 18 MPa at a strain of 5%. In some embodiments, the polymer additive comprises a polymer exhibiting a stress greater than 20 MPa at a strain of 5%. In some embodiments, the polymer additive comprises a polymer exhibiting a stress between 15 MPa and 25 MPa at a strain of 5%. In some embodiments, the polymer additive comprises a polymer having a maximum a strength greater than 20 MPa. In some embodiments, the polymer additive comprises a polymer having a maximum a strength greater than 25 MPa. In some embodiments, the polymer additive comprises a polymer having a maximum a strength greater than 30 MPa. In some embodiments, the polymer additive comprises a polymer having a maximum a strength of between 30 MPa and 35 MPa. In some embodiments, the polymer additive comprises a polymer having a maximum a strength of about 33 MPa. In some embodiments, the polymer additive comprises a polymer having a Young's modulus of greater than 5.5 MPa. In some embodiments, the polymer additive comprises a polymer having a Young's modulus of greater than 7 MPa. In some embodiments, the polymer additive comprises a polymer having a Young's modulus of greater than 7.5 MPa. In some embodiments, the polymer additive comprises a polymer having a Young's modulus of about 8 MPa. In some embodiments, the polymer additive comprises a polymer having a Young's modulus of between 5.5 MPa and 10 MPa. In some embodiments, the polymer additive comprises a polymer having a Young's modulus of between 7 MPa and 10 MPa. In some embodiments, the polymer additive comprises a polymer having a Young's modulus of between 7 MPa and 8.5 MPa.

According to various embodiments, an electrode comprises an active layer. In some embodiments, the active layer includes: (i) a network of high aspect ratio carbon elements defining void spaces within the network, (ii) a plurality of electrode active material particles disposed in the void spaces within the network, and (iii) a polymeric additive. In some embodiments, the silicon comprised in the active material particles comprises one or more of silicon oxide and microsilicon. In some embodiments, the polymeric additive comprises one or more of a polyolefin, a poly(acrylic acid), and a styrene-butadiene rubber (SBR). In some embodiments, the network of high aspect ratio carbon elements defining void spaces within the network comprises a first set of carbon nanotubes and a second set of carbon nanotubes. In some embodiments, the network of high aspect ratio carbon elements further comprises a third set of carbon elements. The third set of carbon elements may comprise graphite. The first set of carbon nanotubes comprises a plurality of first carbon nanotubes or a plurality of bundles of first carbon nanotubes. The second set of carbon nanotubes comprise a plurality of second carbon nanotubes or a plurality of bundles of second carbon nanotubes. The second set of carbon nanotubes has one or more properties different from the first set of carbon nanotubes. According to various embodiments, the first set of carbon nanotubes comprises multi-wall nanotubes, and the second set of carbon nanotubes comprises single-wall nanotubes. As an example, a ratio of an amount by weight of the first set of carbon nanotubes to the second set of carbon nanotubes is about 2:1. In some embodiments, the multi-wall carbon nanotubes comprise an average diameter of between 6 nm and 10 nm, an average wall thickness of between 6 nm and 7 nm; an average length of between 13 micron and 17 micron. In some embodiments, the average length of the multi-wall carbon nanotubes is about 13 micron. In some embodiments, the average length of the multi-wall carbon nanotubes is about 15 micron. In some embodiments, the average length of the multi-wall carbon nanotubes is about 16 micron. In some embodiments, the single-wall carbon nanotubes comprise an average diameter of between 1 nm and 2 nm, and an average length of about 5 micron. In some embodiments, the single-wall carbon nanotubes comprise an average diameter of between 3 nm and 5 nm, and an average length of between 7 and 8 micron.

According to various embodiments, the network of high aspect ratio carbon elements comprised in an active layer of an electrode comprises a first set of carbon nanotubes and a second set of carbon nanotubes. The first set of carbon nanotubes comprises a plurality of first carbon nanotubes or a plurality of bundles of first carbon nanotubes. The second set of carbon nanotubes comprise a plurality of second carbon nanotubes or a plurality of bundles of second carbon nanotubes. The second set of carbon nanotubes has one or more properties different from the first set of carbon nanotubes. In some embodiments, a ratio of an amount by weight of the first set of carbon nanotubes to the second set of carbon nanotubes is about 2:1. In some embodiments, a ratio of an amount by weight of the first set of carbon nanotubes to the second set of carbon nanotubes is about 9:1. In some embodiments, a ratio of an amount by weight of the first set of carbon nanotubes to the second set of carbon nanotubes is at least 5:1. In some embodiments, a ratio of an amount by weight of the first set of carbon nanotubes to the second set of carbon nanotubes is at least 7:1.

In some embodiments, the network of high aspect ratio carbon elements further comprises a third set of carbon elements. The third set of carbon elements may comprise graphite. Graphite may be used to increase the coulombic effective. Graphite is conductive and may void a swelling shape. In some embodiments, an active layer of an electrode comprises at least 5% of graphite by weight of the active layer. In some embodiments, an active layer of an electrode comprises about 5% of graphite by weight of the active layer. In some embodiments, an active layer of an electrode comprises at least 10% of graphite by weight of the active layer. In some embodiments, an active layer of an electrode comprises at least 15% of graphite by weight of the active layer. In some embodiments, an active layer of an electrode comprises at least 20% of graphite by weight of the active layer.

According to various embodiments, an electrode comprises an active layer. In some embodiments, the active layer includes: (i) a network of high aspect ratio carbon elements defining void spaces within the network, (ii) a plurality of electrode active material particles disposed in the void spaces within the network, and (iii) a polymeric additive, the polymeric additive being soluble in at least one of (a) water, and (b) an alcohol. The network of high aspect ratio carbon elements defining void spaces within the network may comprise a set of multi-walled carbon nanotubes. According to various embodiments, a distribution of lengths of the set of multi-wall carbon nanotubes is skewed towards a nominal length a multi-wall carbon nanotube. For example, the multi-wall carbon nanotubes are processed and/or applied in a manner that reduces or minimizes fracturing or breaking of multi-wall carbon nanotubes. The lengths of the multi-wall carbon nanotubes in the network of high aspect ratio carbon elements are generally the nominal length of the multi-wall carbon nanotubes, or a length of such the multi-wall carbon nanotubes tend to be more heavily skewed to the nominal length. In some embodiments, at least 75% of the multi-wall carbon nanotubes within the network of high aspect ratio carbon elements are within 10% of the nominal length (e.g., between 13.4 micron to about 15 micron). In some embodiments, at least 75% of the multi-wall carbon nanotubes within the network of high aspect ratio carbon elements have a length of at least 12 micron. In some embodiments, at least 75% of the multi-wall carbon nanotubes within the network of high aspect ratio carbon elements have a length of at least 13 micron. In some embodiments, at least 50% of the multi-wall carbon nanotubes within the network of high aspect ratio carbon elements are within 10% of the nominal length (e.g., between 13.4 micron to about 15 micron). In some embodiments, at least 50% of the multi-wall carbon nanotubes within the network of high aspect ratio carbon elements have a length of at least 12 micron. In some embodiments, at least 50% of the multi-wall carbon nanotubes within the network of high aspect ratio carbon elements have a length of at least 13 micron.

According to various embodiments, an electrode comprises an active layer. In some embodiments, the active layer includes: (i) a network of high aspect ratio carbon elements defining void spaces within the network, (ii) a plurality of electrode active material particles disposed in the void spaces within the network, and (iii) a polymeric additive that is soluble in water or alcohol, wherein the active layer exhibits an adhesion to a foil of the electrode of at least 75 N/m. In some embodiments, the active layer exhibits an adhesion to a foil of the electrode of at least 90 N/m. In some embodiments, the active layer exhibits an adhesion to a foil of the electrode of at least 100 N/m. In some embodiments, the active layer exhibits an adhesion to a foil of the electrode of about 100 N/m. In some embodiments, the active layer exhibits an adhesion to a foil of the electrode of at least 125 N/m. In some embodiments, the active layer exhibits an adhesion to a foil of the electrode of at least 150 N/m. The network of high aspect ratio carbon elements may comprise multi-walled carbon nanotubes. Adhesion of the active layer to the foil of the electrode may be determined according to the peel test described herein. In some embodiments, the foil comprises copper and/or a copper allow. According to various embodiments the foil is coated on both sides (e.g., opposing sides). Coating the foil on both sides may prevent a foil from folding during a drying process of drying the active layer (e.g., after application of the active layer to the foil). For example, the drying of the active layer can cause the active layer to contract which can apply forces to the foil and cause the foil to correspondingly fold in/crumple. To help avoid the foil from crumpling a thicker foil may be selected or the foil is coated on opposing sides. In some embodiments, the foil (e.g., a thickness of the foil) is determined based at least in part on a tensile strength sufficient to withstand forces applied to the foil by the contracting of the active layer during the drying process and/or forces caused during the charging/discharging cycling (e.g., forces caused by the expansion/contraction of the silicon during charging/discharging). In embodiments, the foil has a thickness of less than 10 micrometers. In embodiments, the foil has a thickness of less than 8 micrometers. In embodiments, the foil has a thickness of less than 7 micrometers. In embodiments, the foil has a thickness of less than 6 micrometers. In embodiments, the foil has a thickness of less than 5 micrometers. In embodiments, the foil has a thickness of about 6 micrometers.

According to various embodiments, an electrode comprises an active layer. In some embodiments, the active layer includes: (i) a network of high aspect ratio carbon elements defining void spaces within the network, (ii) a plurality of electrode active material particles disposed in the void spaces within the network, and (iii) a polymeric additive that is soluble in water or alcohol, wherein the active layer exhibits no cracking when the electrode is wrapped around a mandrel having at least a 6 mm diameter. The network of high aspect ratio carbon elements may comprise multi-walled carbon nanotubes. In some embodiments, the observation that the active layer does not exhibit any cracking in the active layer is determined based on a human observation of the active layer such as the surface of the active layer. In some embodiments, the human observation of the active layer is performed using analyzing the electrode under a microscope. An example of a test for determining whether the active layer exhibits cracking includes winding a sample electrode on a set of mandrels (e.g., from smallest diameter to largest diameter), open the sample electrode to observe cracking condition on front and back sides, and repeat with thicker mandrels, until no crack is observed.

According to various embodiments, an electrode comprises an active layer. In some embodiments, the active layer includes: (i) a network of high aspect ratio carbon elements defining void spaces within the network, (ii) a plurality of electrode active material particles disposed in the void spaces within the network, and (iii) a polymeric additive that is processable in water or alcohol, wherein the active layer exhibits an expansion of less than 50% when wetted with an electrolyte. The polymeric additive may be soluble in water or alcohol. In some embodiments, the active layer exhibits an expansion of less than 40% when wetted with an electrolyte. In some embodiments, the active layer exhibits an expansion of less than 30% when wetted with an electrolyte. In some embodiments, the active layer exhibits an expansion of less than 10% when wetted with an electrolyte. In some embodiments, the active layer exhibits an expansion of less than 10% when wetted with an electrolyte. In some embodiments, the active layer exhibits an expansion of between and 5% and 20% when wetted with an electrolyte. In some embodiments, the active layer exhibits an expansion of between and 5% and 15% when wetted with an electrolyte. In some embodiments, the active layer exhibits an expansion of between and 5% and 10% when wetted with an electrolyte. The network of high aspect ratio carbon elements may comprise multi-walled carbon nanotubes.

As used herein, the “peel test” means a 90 degree peel test. A sample (e.g., an electrode with an active layer adhered to a foil) having a size of 2.54 cm×10 cm is used. The test procedure for the peel tests includes (i) cutting double sided cathode electrode sample into 10 cm*2.54 cm size, (ii) place double side tape on one side and stick on the metal plate of tester; Scotch transparent tape one end fixed by the clamp, another end flatly stick-on electrode surface at 90-degree angle, (iii) zero the system: set moving mode at “cycle mode”; (iv) open test file named “sw-1x-v3”, choose “com 5” from the Setup Menu; (v) click “Clear all data” on the left menu list, set up “set sampling rate” as 0.2 s, and select “sample continuously” at the same time start the tester; (vi) select “stop sampling” in the left side menu list and stop the tester; and save the file.

As used herein, the term “high aspect ratio carbon elements” refers to carbonaceous elements having a size in one or more dimensions (the “major dimension(s)”) significantly larger than the size of the element in a transverse dimension (the “minor dimension”).

According to various embodiments, an electrode comprises an active layer. In some embodiments, the active layer includes: (i) a network of high aspect ratio carbon elements defining void spaces within the network, (ii) a plurality of electrode active material particles disposed in the void spaces within the network, wherein the active material particles comprises silicon, and (iii) a polymeric additive, the polymeric additive including a polymeric material described in U.S. Pat. No. 8,124,277, there entire disclosure of which is hereby incorporated by reference for all purposes. In some embodiments, the silicon comprised in the active material particles comprises one or more of silicon oxide and microsilicon. In some embodiments, the active material particles may include one or more of graphite, hard carbon, activated carbon, nanoform carbon, silicon, silicon oxides, carbon encapsulated silicon nanoparticles. In some embodiments an active layer of the electrode may be intercalated with lithium, e.g., using pre-lithiation methods known in the art.

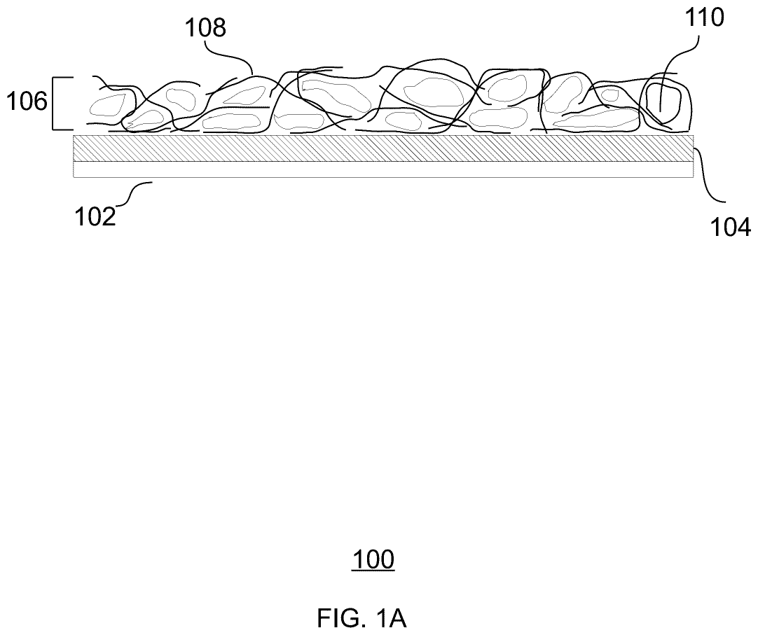

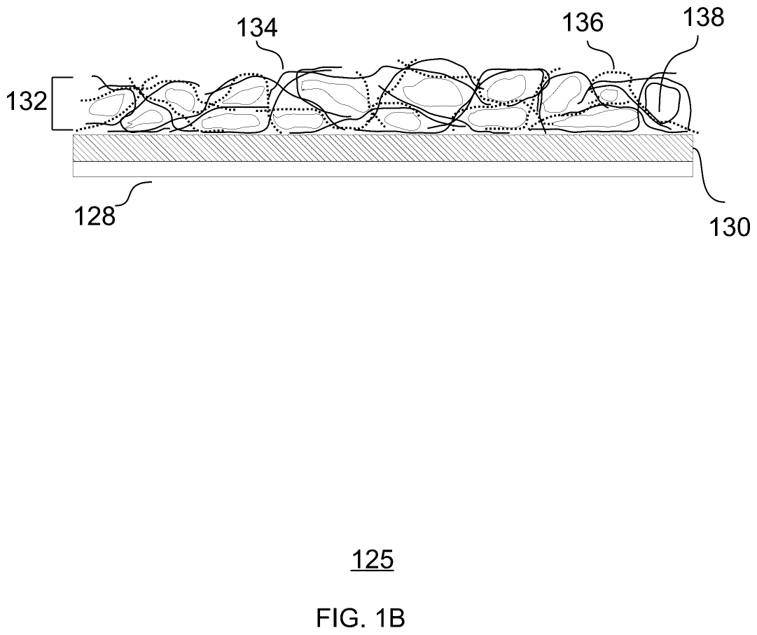

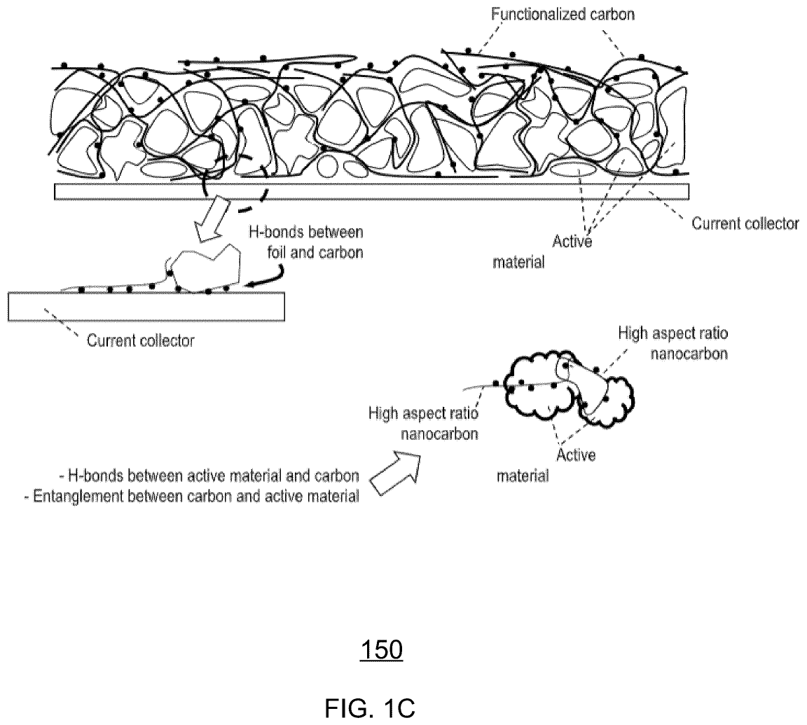

FIG. 1A is a diagram of an electrode according to various embodiments. In the example shown, electrode 100 is provided. According to various embodiments, electrode 100 comprises current collector 102 and active layer 106. Electrode 100 may optionally include an adhesion layer 104. As an example, adhesion layer 104 comprises a material that promotes adhesion between current collector 102 and active layer 106.

In some embodiments, current collector 102 is an electrically conductive layer. For example, current collector 102 may be a metal, metal alloy, etc. As another example, current collector 102 is a metal foil. In some embodiments, current collector 102 is an aluminum foil or aluminum alloy foil. In some embodiments, current collector 102 is a copper foil or copper alloy foil. Current collector 102 has a thickness of less than 15 μm. Current collector 102 has a thickness of less than 10 μm. Current collector 102 has a thickness of less than 8 μm. Current collector 102 has a thickness of less than 5 μm. Current collector 102 has a thickness of less than 15 μm. In some preferred embodiments, current collector 102 has a thickness of between about 6 μm and about 8 μm. In some preferred embodiments, current collector 102 has a thickness of between about 5 μm and about 8 μm. In some embodiments, current collector 102 is an aluminum foil or an aluminum alloy foil, and current collector 102 has a thickness of about 6 μm. In some embodiments, electrode comprises a foil on which active layer are provided on opposing sides.

In some embodiments, active layer 106 may include a three-dimensional network of high aspect ratio carbon elements 108 defining void spaces within the network. A plurality of active material particles 110 are disposed in the void spaces within the network. Accordingly, active material particles 110 are enmeshed or entangled in the network, thereby improving the cohesion of active layer 106. In some embodiments, the three-dimensional network of high aspect ratio carbon elements 108 provides mechanical support for active material particles 110.

According to various embodiments, three-dimensional network of high aspect ratio carbon elements 108 comprises one or more of single-wall carbon nanotubes, multi-wall carbon nanotubes, a set of carbon nanotubes having a small number of walls (e.g., less than 6 walls), and a set of carbon nanotubes having a large number of walls (e.g., greater than 6 walls), carbon nanostructures, fragments of single-wall carbon nanotubes, fragments of multi-wall carbon nanotubes, fragments of carbon nanostructures, carbon black, etc. Various other high aspect ratio carbon elements may be implemented. The three-dimensional network of high aspect ratio carbon elements 108 maintains an electrical connection among the high aspect ratio carbon elements (e.g., the carbon nanotubes) during the charging/discharging cycling of the electrode. For example, the three-dimensional network of high aspect ratio carbon elements 108 maintains an electrical connection among the high aspect ratio carbon elements (e.g., the carbon nanotubes) as silicon particles comprised in the active layer expand and/or contract during the charging/discharging cycling. Multi-wall carbon nanotubes (or carbon nanotubes having a large number of walls) provide good binding or covering of silicon particles such as silicon-oxide as the silicon expands (e.g., silicon particles can expand about 300%). Single-wall carbon nanotubes (or carbon nanotubes having a small number of walls) can expand with the silicon as the silicon expands during the charging/discharging cycling, and thus such carbon nanotubes generally do not decrease an energy transfer.

According to various embodiments, active layer 106 (e.g., three-dimensional network of high aspect ratio carbon elements 108) comprises multi-wall carbon nanotubes or a set of carbon nanotubes having a large number of walls (e.g., greater than 5 walls, or a wall having 5 layers, etc.). In some embodiments, an amount of multi-wall carbon nanotubes (or a set of carbon nanotubes having a large number of walls) comprised in active layer 106 is between 2% and 5% by weight of the active layer. In some embodiments, an amount of multi-wall carbon nanotubes (or a set of carbon nanotubes having a large number of walls) comprised in active layer 106 is between 3% and 5% by weight of the active layer. In some embodiments, an amount of multi-wall carbon nanotubes (or a set of carbon nanotubes having a large number of walls) comprised in active layer 106 is between 3.75% and 5% by weight of the active layer. In some embodiments, an amount of multi-wall carbon nanotubes (or a set of carbon nanotubes having a large number of walls) comprised in active layer 106 is about 4% by weight of the active layer.

Active layer 106 has an average thickness of between 10 microns and 200 microns. In some embodiments, active layer 106 has an average thickness of 15 microns to 50 microns. In some embodiments, active layer 106 has an average thickness of 10 microns to 25 microns. In some embodiments, active layer 106 has an average thickness of about 100 microns. In some embodiments, active layer 106 has an average thickness of about 50 microns. In some embodiments, active layer 106 has an average thickness of between 25 microns and 50 microns. Generally, an active layer swells when wetted in an electrolyte. An example for measuring an amount of swelling (e.g., expansion in at least the thickness direction) may be include obtain a sample electrode having 1 inch diameter such as by punch out sample from large sheet of electrodes by 1 inch diameter round punch, measure the thickness of the active layer and record, place sample electrode in a coin cell case, inject the sample electrolyte into the coin cell case, allow sample (e.g., with injected electrolyte) to sit for 1 hour, and after 1 hour, measure thickness and record, then electrode (as soaked by the electrolyte) is placed in a dry room, covered by a metal tray for 48 hours, and after sitting for 48 hours, the thickness of the electrode is measured and recorded. According to various embodiments, a volume of the active layer 106 expands (e.g., swells) less than 10% when wetted with an electrolyte. For example, a thickness of active layer 106 after wetted with an electrolyte is less than 110% the thickness of active layer 106 in the absence of the electrolyte. According to various embodiments, a volume of the active layer 106 expands (e.g., swells) less than 20% when wetted with an electrolyte. For example, a thickness of active layer 106 after wetted with an electrolyte is less than 120% the thickness of active layer 106 in the absence of the electrolyte.

According to various embodiments, in the case active layer 106 comprises multi-wall carbon nanotubes and single-wall carbon nanotubes, the multi-wall carbon nanotubes swell more than single-wall carbon nanotubes when wetted with an electrolyte in an energy storage device in which electrode 100 is comprised. In some embodiments, the multi-wall carbon nanotubes swell at least 15% more than single-wall carbon nanotubes when wetted with an electrolyte in an energy storage device in which electrode 100 is comprised. For example, a length of the multi-wall carbon nanotubes expands at least 15% more than a length of the single-wall carbon nanotubes when wetted with the electrolyte. In some embodiments, the multi-wall carbon nanotubes swell at least 25% more than single-wall carbon nanotubes when wetted with an electrolyte in an energy storage device in which electrode 100 is comprised. For example, a length of the multi-wall carbon nanotubes expands at least 25% more than a length of the single-wall carbon nanotubes when wetted with the electrolyte. In some embodiments, the multi-wall carbon nanotubes swell at least 50% more than single-wall carbon nanotubes when wetted with an electrolyte in an energy storage device in which electrode 100 is comprised. For example, a length of the multi-wall carbon nanotubes expands at least 50% more than a length of the single-wall carbon nanotubes when wetted with the electrolyte. In some embodiments, the multi-wall carbon nanotubes swell up to 50% when wetted (e.g., a length of the multi-wall carbon nanotubes is 50% larger after wetting with an electrolyte, and/or a diameter of the multi-wall carbon nanotubes is 50% larger after wetting, etc.).

According to various embodiments, three-dimensional network of high aspect ratio carbon elements 108 comprises carbon nanotubes, and the carbon nanotubes are only multi-wall carbon nanotubes and/or fragment of carbon nanotubes. For example, three-dimensional network of high aspect ratio carbon elements 108 does not include single-wall carbon nanotubes or fragments of single-wall carbon nanotubes. According to various embodiments, three-dimensional network of high aspect ratio carbon elements 108 comprises at least 99% carbon by weight. In some embodiments, three-dimensional network of high aspect ratio carbon elements 108 comprises an electrically interconnected network of carbon elements exhibiting connectivity above a percolation threshold and wherein the network defines one or more highly electrically conductive pathways having a length greater than 100 μm. In some embodiments, the three-dimensional network of high aspect ratio carbon elements 108 maintains an electrical connection as silicon particles comprised in the active layer expand or contract during the charging/discharging cycling of electrode 100.

According to various embodiments, the network of high aspect ratio carbon elements defines void spaces within the network, and the network of high aspect ratio carbon elements comprises a first set of carbon nanotubes and a second set of carbon nanotubes. In some embodiments, the first set of carbon nanotubes comprises a plurality of first carbon nanotubes or a plurality of bundles of first carbon nanotubes, and the second set of carbon nanotubes comprise a plurality of second carbon nanotubes or a plurality of bundles of second carbon nanotubes. The second set of carbon nanotubes has one or more properties different from the first set of carbon nanotubes. For example, the second set of carbon nanotubes has a number of layers (e.g., walls) that is different from a number of layers (e.g., walls) of the first set of carbon nanotubes. In some embodiments, the first set of carbon nanotubes comprises multi-wall carbon nanotubes. In some embodiments, the second set of carbon nanotubes comprises single-wall carbon nanotubes. For example, the network of high aspect ratio carbon elements comprises a set of multi-wall carbon nanotubes and a set of single-wall carbon nanotubes. The set of multi-wall carbon nanotubes may have fragments of multi-wall carbon nanotubes, and/or the set of single-wall carbon nanotubes may have fragments of multi-wall carbon nanotubes. According to various embodiments, the active layer comprises a larger amount by weight of multi-wall carbon nanotubes than single-wall carbon nanotubes. In some embodiments, a ratio of an amount by weight of the first set of carbon nanotubes to the second set of carbon nanotubes comprised in the active layer is about 1.5:1. In some embodiments, a ratio of an amount by weight of the first set of carbon nanotubes to the second set of carbon nanotubes comprised in the active layer is at least 1.5:1. In some embodiments, a ratio of an amount by weight of the first set of carbon nanotubes to the second set of carbon nanotubes comprised in the active layer is about 2:1. In some embodiments, a ratio of an amount by weight of the first set of carbon nanotubes to the second set of carbon nanotubes comprised in the active layer is at least 5:1. In some embodiments, a ratio of an amount by weight of the first set of carbon nanotubes to the second set of carbon nanotubes comprised in the active layer is about 9:1.

In related art energy storage devices, a network of carbon elements includes fragmented carbon nanotubes, such as fragmented multi-wall carbon nanotubes. Related art processes for manufacturing electrodes is. For example, fragmented multi-wall carbon nanotubes comprised in related art electrodes generally have average lengths significantly less than a nominal length of the multi-wall carbon nanotube (e.g., a length of the multi-wall carbon nanotube before being input to the process for manufacturing the electrode, such as the process to create the active layer or to apply the active layer on the current collector). Fragmented multi-wall carbon nanotubes comprised in related art electrodes generally have average lengths significantly less than half the nominal length of the multi-wall carbon nanotube. Fragmented multi-wall carbon nanotubes comprised in related art electrodes generally have average lengths significantly less than a third of the nominal length of the multi-wall carbon nanotube. The process for preparing the multi-wall carbon nanotube or for preparing/manufacturing/applying the active layer for a related art electrode does not gently handle the multi-wall carbon nanotube and causes the multi-wall carbon nanotubes to break up or be crushed. Longer multi-wall carbon nanotubes may generally provide better mechanical support for active material particles within an active layer. For example, as active material particles expand/contract during the charge/discharge cycle, longer multi-wall carbon nanotubes provide better mechanical support for the active material particle (e.g., the active material particles are better enmeshed among the relatively longer multi-wall carbon nanotubes). In addition, longer multi-wall carbon nanotubes may form longer interconnected network of highly electrically conductive paths formed in the network may provide long conductive paths to facilitate current flow within and through the active layer (e.g. conductive paths on the order of the thickness of the active layer such as active layer 106 of electrode 100 of FIG. 1A).

According to various embodiments, the electrode comprises multi-wall carbon nanotubes that are relatively longer in comparison to multi-wall carbon nanotubes comprised in related art electrodes. The use of relatively longer multi-wall carbon nanotubes in electrodes is found to have beneficial mechanical and/or electrical properties. For example, multi-wall carbon nanotubes provide relatively good power at low densities. As another example, shorter multi-wall carbon nanotubes generally do not swell (e.g., expand) as much as longer multi-wall carbon nanotubes. As such use of shorter multi-wall carbon nanotubes loses (or reduces) some of the beneficial properties associated with swelling of the carbon nanotubes. As an extreme example, carbon black does not exhibit swelling because carbon black is merely particles of carbon without entanglement such as the entanglement exhibited by a set of multi-wall carbon nanotubes. An indication that a length of a certain amount of multi-wall carbon nanotubes have a length exceeding a threshold length and thus have sufficient swelling properties is an observation during a calendaring process—a relatively larger amount of pressure or effort to calendar the slurry in connection with applying to the foil is indicative that the collective swelling (e.g., an average swelling) of the multi-wall carbon nanotubes in the active layer will satisfy a certain performance threshold. However, multi-wall carbon nanotubes are generally difficult to process. The processing of the multi-wall carbon nanotubes in connection with preparing/forming the active layer and/or electrode is gentler than processes for related art electrodes. As such, the processes according to various embodiments maintain longer multi-wall carbon nanotubes (e.g., less multi-wall carbon nanotubes are crushed, fragmented, broken, etc.). In some embodiments, the active layer of the electrode comprises a set of multi-wall carbon nanotubes having an average length that is more an average length of the multi-wall carbon nanotubes in related art electrodes. According to various embodiments, a distribution of lengths of the set of multi-wall carbon nanotubes is skewed towards a nominal length a multi-wall carbon nanotube. As an example, the nominal length of a multi-wall carbon nanotube is about 16 micron. For example, the multi-wall carbon nanotubes are processed and/or applied in a manner that reduces or minimizes fracturing or breaking of multi-wall carbon nanotubes. The lengths of the multi-wall carbon nanotubes in the network of high aspect ratio carbon elements are generally the nominal length of the multi-wall carbon nanotubes, or a length of such the multi-wall carbon nanotubes tend to be more heavily skewed to the nominal length. In some embodiments, at least 75% of the multi-wall carbon nanotubes within the network of high aspect ratio carbon elements are within 10% of the nominal length (e.g., between 13.4 micron to about 15 micron). In some embodiments, at least 75% of the multi-wall carbon nanotubes within the network of high aspect ratio carbon elements have a length of at least 12 micron. In some embodiments, at least 75% of the multi-wall carbon nanotubes within the network of high aspect ratio carbon elements have a length of at least 13 micron. In some embodiments, at least 50% of the multi-wall carbon nanotubes within the network of high aspect ratio carbon elements are within 10% of the nominal length (e.g., between 13.4 micron to about 15 micron). In some embodiments, at least 50% of the multi-wall carbon nanotubes within the network of high aspect ratio carbon elements have a length of at least 12 micron. In some embodiments, at least 50% of the multi-wall carbon nanotubes within the network of high aspect ratio carbon elements have a length of at least 8 micron. In some embodiments, at least 50% of the multi-wall carbon nanotubes within the network of high aspect ratio carbon elements have a length of at least 13 micron. In some embodiments, at least 50% of the multi-wall carbon nanotubes within the network of high aspect ratio carbon elements are within 50% of the nominal length (e.g., between 13.4 micron to about 15 micron). In some embodiments, at least 50% of the multi-wall carbon nanotubes within the network of high aspect ratio carbon elements are within 60% of the nominal length (e.g., between 13.4 micron to about 15 micron). In some embodiments, at least 50% of the multi-wall carbon nanotubes within the network of high aspect ratio carbon elements are within 75% of the nominal length (e.g., between 13.4 micron to about 15 micron). In some embodiments, an amount of multi-wall carbon nanotubes having a length shorter than half the nominal length of the multi-wall carbon nanotubes is less than 50% by weight of the active layer. In some embodiments, an amount of multi-wall carbon nanotubes having a length shorter than half the nominal length of the multi-wall carbon nanotubes is less than 30% by weight of the active layer. In some embodiments, an amount of multi-wall carbon nanotubes having a length shorter than half the nominal length of the multi-wall carbon nanotubes is less than 25% by weight of the active layer.

The multi-wall carbon nanotubes comprised in the electrode exhibit on average higher aspect ratios, such as with longer lengths, than multi-wall carbon nanotubes in related art electrodes. A slurry having high viscosities is prepared and subject to relatively low shear forces during processing. As such, the aspect ratio of the multi-wall carbon nanotubes is preserved. In some embodiments, at least a subset of the multi-wall carbon nanotubes comprised in the active layer are branched carbon nanotubes. In some embodiments, at least a subset of the multi-wall carbon nanotubes comprised in the active layer are branched, interdigitated, entangled and/or share common walls. Properties of the multi-wall carbon nanotubes may be obtained using scanning electron microscopy (SEM). According to various embodiments, the multi-wall carbon nanotubes comprise an average length of at least 5 micron. In some embodiments, the multi-wall carbon nanotubes comprise an average length of at least 10 micron. In some embodiments, the multi-wall carbon nanotubes comprise an average length of between 10 micron and 15 micron. According to various embodiments, the multi-wall carbon nanotubes comprise an average diameter of between 6 nm and 15 nm. In some embodiments, the multi-wall carbon nanotubes comprise an average diameter of between 6 nm and 10 nm. According to various embodiments, the multi-wall carbon nanotubes comprise an average of between 3 layers to 15 layers. In some embodiments, the multi-wall carbon nanotubes comprise an average of between 3 layers to 15 layers. In some embodiments, the multi-wall carbon nanotubes comprise an average of between 5 layers to 10 layers. In some embodiments, the multi-wall carbon nanotubes comprise an average of between 6 layers to 7 layers. In some embodiments, the multi-wall carbon nanotubes comprise at least 6 layers on average. In some embodiments, the multi-wall carbon nanotubes (e.g., a set of carbon nanotubes having a large number of walls) comprise an average aspect ratio of at least 100. In some embodiments, the multi-wall carbon nanotubes comprise an average aspect ratio between 200 and 1000. In some embodiments, the high aspect ratio carbon elements may include flake or plate shaped elements having two major dimensions and one minor dimension. For example, in some such embodiments, the ratio of the length of each of the major dimensions may be at least 5 times, 10 times, 100 times, 500 times, 1,000 times, 5,000 times, 10,000 times or more of that of the minor dimension.

According to various embodiments, the electrodes comprise particles of a silicon-based active material. In some embodiments, the electrode comprises at least one electrode active material selected from the group consisting of silicon (e.g., microsilicon), silicon-oxide (e.g., SiOx), SiOx Powder (Shin-Etsu 7131). Various other silicon-based particles may implemented. In some embodiments, the active material includes one or more of graphite, hard carbon, activated carbon, nanoform carbon, silicon, silicon oxides, carbon encapsulated silicon nanoparticles.

According to various embodiments, the plurality of active material particles 110 comprise a microsilicon.

Active layer 106 comprises a relatively large amount of active material particles. In some embodiments, active layer 106 comprises at least 50.0% of the active material particles by weight by weight of the active layer. In some embodiments, active layer 106 comprises between 70.0% to 90.0% of the active material particles by weight of the active layer. In some embodiments, active layer 106 comprises greater than 80% of the active material particles by weight of the active layer.

According to various embodiments, active layer 106 comprises a polymeric additive. The polymeric additive may provide mechanical support for at least a subset of the plurality of active material particles 110 and/or at least part of the three-dimensional network of high aspect ratio carbon elements 108. For example, the polymeric additive may bind or adhere to the active material particles or the carbon elements such as the carbon nanotubes (e.g., the multi-wall carbon nanotubes and/or the single-wall carbon nanotubes). According to various embodiments, polymers that are electrochemically stable are found to have beneficial properties as polymeric additives to active layer 106. The polymeric additive may be selected as a polymer that is completely dissolvable, or highly soluble in a solvent used in processing electrode 100. For example, the polymeric additive is dissolvable or highly soluble in water or an alcohol such as ethanol. In some embodiments, the polymeric additive is processable in water.

According to various embodiments, the polymeric additive has a relatively high tensile strength. For example, the polymer additive comprises a polymer that is difficult to stretch. In some embodiments, the polymeric additive has a relatively high tensile strength and is process-able in water or alcohol. In some embodiments, the polymeric additive has a relatively high tensile strength and is process-able in water (e.g., relatively easily processable using water). In some embodiments, the polymer additive comprises a polymer exhibiting a stress greater than 20 MPa at a strain of about 10%. In some embodiments, the polymer additive comprises a polymer exhibiting a stress greater than 30 MPa at a strain of about 10%. In some embodiments, the polymer additive comprises a polymer exhibiting a stress between 30 MPa and 35 MPa at a strain of about 10%. In some embodiments, the polymer additive comprises a polymer exhibiting a stress greater than 10 MPa at a strain of about 20%. In some embodiments, the polymer additive comprises a polymer exhibiting a stress greater than 20 MPa at a strain of about 20%. In some embodiments, the polymer additive comprises a polymer exhibiting a stress greater than 25 MPa at a strain of about 20%. In some embodiments, the polymer additive comprises a polymer exhibiting a stress between 25 MPa and 30 MPa at a strain of about 20%. In some embodiments, the polymer additive comprises a polymer exhibiting a stress greater than 15 MPa at a strain of 5%. In some embodiments, the polymer additive comprises a polymer exhibiting a stress greater than 18 MPa at a strain of 5%. In some embodiments, the polymer additive comprises a polymer exhibiting a stress greater than 20 MPa at a strain of 5%. In some embodiments, the polymer additive comprises a polymer exhibiting a stress between 15 MPa and 25 MPa at a strain of 5%. In some embodiments, the polymer additive comprises a polymer having a maximum a strength greater than 20 MPa. In some embodiments, the polymer additive comprises a polymer having a maximum a strength greater than 25 MPa. In some embodiments, the polymer additive comprises a polymer having a maximum a strength greater than 30 MPa. In some embodiments, the polymer additive comprises a polymer having a maximum a strength of between 30 MPa and 35 MPa. In some embodiments, the polymer additive comprises a polymer having a maximum a strength of about 33 MPa. In some embodiments, the polymer additive comprises a polymer having a Young's modulus of greater than 5.5 MPa. In some embodiments, the polymer additive comprises a polymer having a Young's modulus of greater than 7 MPa. In some embodiments, the polymer additive comprises a polymer having a Young's modulus of greater than 7.5 MPa. In some embodiments, the polymer additive comprises a polymer having a Young's modulus of about 8 MPa. In some embodiments, the polymer additive comprises a polymer having a Young's modulus of between 5.5 MPa and 10 MPa. In some embodiments, the polymer additive comprises a polymer having a Young's modulus of between 7 MPa and 10 MPa. In some embodiments, the polymer additive comprises a polymer having a Young's modulus of between 7 MPa and 8.5 MPa.

In some embodiments, the polymeric additive comprises one or more of a polyolefin, a Poly(acrylic acid), and a styrene-butadiene rubber (SBR). In some embodiments, the polymeric additive comprises AquaCharge Binder.

According to various embodiments, the electrode comprises 89 wt. % Wacker Micro-silicon Powder+1 wt. % Pre-dispersed Single-wall Carbon Nanotube Neocarbonix Ethanol-based Suspension+10 wt. % AquaCharge Binder (10 wt. % Water-based Solution). AQUACHARGE is a tradename for an aqueous binder for electrodes, that was developed by applying water-soluble resin technology. AQUACHARGE is produced by Sumitomo Seika Chemicals Co., Ltd. of Hyogo Japan. A similar example is provided in U.S. Pat. No. 8,124,277, entitled “Binder for electrode formation, slurry for electrode formation using the binder, electrode using the slurry, rechargeable battery using the electrode, and capacitor using the electrode,” and incorporated herein by reference in it's entirety. Further examples include polyacrylic acid (PAA) which is a synthetic high-molecular weight polymer of acrylic acid as well as sodium polyacrylate which is a sodium salt of polyacrylic acid.

Related art electrodes generally use a polymer binder that is soluble only in toxic or environmentally-unfriendly solvents. The polymer binder is used to disperse, adhere, bind particles, and survive in a harsh environment. An energy storage device battery may slowly lose capacity over cycling and charging/discharging hundreds or thousands of times. The polymer binder may assist in maintaining capacity of an energy storage device over its operational lifetime.

According to various embodiments, electrode 100 and/or active layer 106 does not include (e.g., is free of) a polymeric additive that is not processable or not soluble in one or more of water or an alcohol such as ethanol. In some embodiments, the electrode is substantially free of a polymeric additive that is not processable or not soluble in one or more of water or an alcohol such as ethanol. In some embodiments, electrode 100 and/or active layer 106 of electrode 100 is free, or substantially free, of a polymeric additive that is not soluble in one or more of water or an alcohol such as ethanol. For example, any polymeric additive to an electrode 100 according to various embodiments is soluble in one or more of water and an alcohol (e.g., methanol, ethanol, etc.).

The polymeric additive may be selected based at least in part on its reaction to certain electrolytes used in the energy storage device comprising electrode 100. In some embodiments, a polymeric additive having a relatively high (e.g., very high) molecular weight is selected such as because such polymeric additives are generally resistant to solvents. For example, polymeric additives having high molecular weights do not dissolve in a solvent while polymers having low molecular weights become a goo. In some embodiments, the polymeric additive is selected as a polymer that does not get softer (e.g., softer than a softness threshold) when mixed with the electrolyte. In some embodiments, the polymeric additive is selected as a polymer that does not substantially swell (e.g., swell or expand more than a predefined swelling threshold) when wetted/mixed with the electrolyte to be used in the energy storage device.

Active layer 106 may include a polymeric additive that is processable or soluble in water and/or an alcohol such as ethanol. In some embodiments, the polymeric additive has a relatively high molecular weight. For example, the polymeric additive has a molecular weight greater than 200 g/mol. In some embodiments, the polymeric additive has a molecular weight greater than 0.4 million g/mol. In some embodiments, the polymeric additive has a molecular weight greater than 0.5 million g/mol. In some embodiments, the polymeric additive has a molecular weight greater than 1 million g/mol. In some embodiments, the polymeric additive has a molecular weight between 0.5 million g/mol and 1.5 million g/mol.

The polymeric additive may have a specific gravity of between 1.0 g/cm³ and 2.5 g/cm³. In some embodiments, the polymeric additive has a specific gravity of at greater than 1.135 g/cm³. In some embodiments, the polymeric additive has a specific gravity of at greater than 1.20 g/cm³. The specific gravity of the polymeric additive may be measured according to the ASTM D792 test method.

The polymeric additive may have a specific heat of between 1.5 J/g° C. at 23° C. and 3.5 J/g° C. at 23° C. In some embodiments, the polymeric additive has a specific heat of at greater than 2.0 J/g° C. at 23° C. In some embodiments, the polymeric additive has a specific heat of at greater than 2.2 J/g° C. at 23° C. In some embodiments, the polymeric additive has a specific heat of about 2.4 J/g° C. at 23° C. The specific heat of the polymeric additive may be measured based on a DSC measurement.

The polymeric additive may have a tensile strength of between 4 MPa and 100 MPA when the polymer additive is dry. As an example, the polymeric additive has a tensile strength of between 4 MPa and 70 MPA when the polymer additive is dry. In some embodiments, the polymeric additive has a tensile strength of less than 70 MPa as measured when the polymer additive is dry. In some embodiments, the polymeric additive has a tensile strength of less than 50 MPa as measured when the polymer additive is dry. In some embodiments, the polymer additive comprises a polymer exhibiting a stress between 15 MPa and 25 MPa at a strain of 5%. In some embodiments, the polymer additive comprises a polymer having a maximum a strength greater than 20 MPa. In some embodiments, the polymer additive comprises a polymer having a maximum a strength greater than 25 MPa. In some embodiments, the polymer additive comprises a polymer having a maximum a strength greater than 30 MPa. In some embodiments, the polymer additive comprises a polymer having a maximum a strength of between 30 MPa and 35 MPa. In some embodiments, the polymer additive comprises a polymer having a maximum a strength of about 33 MPa. In some embodiments, the polymer additive comprises a polymer having a Young's modulus of greater than 5.5 MPa. In some embodiments, the polymer additive comprises a polymer having a Young's modulus of greater than 7 MPa. In some embodiments, the polymer additive comprises a polymer having a Young's modulus of greater than 7.5 MPa. In some embodiments, the polymer additive comprises a polymer having a Young's modulus of about 8 MPa. In some embodiments, the polymer additive comprises a polymer having a Young's modulus of between 5.5 MPa and 10 MPa. In some embodiments, the polymer additive comprises a polymer having a Young's modulus of between 7 MPa and 10 MPa. In some embodiments, the polymer additive comprises a polymer having a Young's modulus of between 7 MPa and 8.5 MPa. The tensile strength of the polymeric additive may be measured based on the ASTM D638 test method.

The polymeric additive may have an elongation at yield of greater than 4%. As an example, the polymeric additive has an elongation at yield of greater than 4% and less than 50% as measured when the polymer additive is dry. In some embodiments, the polymeric additive has an elongation at yield of greater than 5% as measured when the polymer additive is dry. In some embodiments, the polymeric additive has an elongation at yield of greater than 10% as measured when the polymer additive is dry. In some embodiments, the polymeric additive has an elongation at yield of greater than 20% as measured when the polymer additive is dry. In some embodiments, the polymeric additive has an elongation at yield of greater than 25% as measured when the polymer additive is dry. In some embodiments, the polymeric additive has an elongation at yield of between 20% and 30% as measured when the polymer additive is dry. The elongation at yield of the polymeric additive may be measured based on the ASTM D638 test method.

According to various embodiments, active layer 106 comprises a polymeric additive that is selected from a family of polyamides, or a modified polyamide or derivative of a polyamide. The polymeric additive is soluble in water or an alcohol such as ethanol. In some embodiments, the polymeric additive has a relatively high molecular weight. The polymeric additive may be at least partially disposed in at least one void space defined by the network of high aspect ratio carbon elements. In some embodiments, the polymeric additive serves as a polymeric binder. The polymeric additive may exhibit gelling when a mixture of the polymeric additive and ethyl cellosolve is cooled. As an example, the polymeric additive may be completely soluble in each of water, ethylene glycol, benzyl alcohol, acetic acid, and isobutanol. As an example, the polymeric additive completely soluble in N-methyl pyrrolidone. Solubility of the polymeric additive may be measured by adding 10 g of the polymeric additive to 100 ml of a particular solvent, the mixture is stirred for about 3 hours at 80° C., and after stirring, the mixture is cooled to room temperature, after which the mixture is observed.

Because the polymeric additive provides at mechanical support for electrode 100 (e.g., providing mechanical support for active material particles and/or the carbon elements), a polymeric additive is selected such that the polymeric additive has a glass transition temperature that is generally outside the operating temperatures of the energy storage device. In some embodiments, the polymeric additive has a glass transition temperature of less than 0° C. In some embodiments, the polymeric additive has a glass transition temperature of less than −10° C. In some embodiments, the polymeric additive has a glass transition temperature of less than −25° C. In some embodiments, the polymeric additive has a glass transition temperature of less than −30° C. In some embodiments, the polymeric additive has a glass transition temperature of less than −40° C. In some embodiments, the polymeric additive has a glass transition temperature of less than −45° C. In some embodiments, the polymeric additive has a glass transition temperature of between −50° C. and −40° C. The glass transition temperature of the polymeric additive may be measured based on a DSC measurement.

According to various embodiments, the polymeric additive has a 5% weight reduction temperature of between 375° C. and 400° C. In some embodiments, the polymeric additive has a 5% weight reduction temperature of about 385° C. The polymeric additive may be selected such that an aqueous solution of the polymeric additive and at least one of water and alcohol exhibits a viscosity of at least 60 Pas at a concentration of about 50% by weight of polymeric additive.

Active layer 106 may comprise less than 5% of polymeric additive by weight of the active layer. In some embodiments, an amount of the polymeric material comprised in active layer 106 is about 8% by weight of the active layer. In some embodiments, an amount of the polymeric material comprised in active layer 106 is equal to or less than 8% by weight of the active layer. In some embodiments, an amount of the polymeric material comprised in active layer 106 is about 10% by weight of the active layer. In some embodiments, an amount of the polymeric material comprised in active layer 106 is equal to or less than 10% by weight of the active layer. In some embodiments, an amount of the polymeric material comprised in active layer 106 is less 12% by weight of the active layer. In some embodiments, an amount of the polymeric material comprised in active layer 106 is less 15% by weight of the active layer.

Examples of a polymeric additive include a polyolefin, a Poly(acrylic acid), a styrene-butadiene rubber (SBR), a Polyethylene oxide (PEO), a polyether, derivatives of poly(ethylene glyol) (PEG), a fluorine-containing polymers, particularly poly(vinylidene difluoride) (PVDF), polyurethane (PU), Polytetrafluoroethylene (PTFE), an Alginate (Alg), Renatured DNA/Alg, Alg-catechol, PAA-catechol, Carboxymethyl chitosan, Guar gum, Agarose, Konjac glucomannan, Carboxymethylated gellan gum, PDA-PAA-PEO, Pectin/PAA, Partially lithiated PAA and Nafion, Sequence-defined peptoids, PMDOPA, Branched PAA, NaPAA-g-CMC, CS-g-PAANa, PVA-g-PAA, GC-g-LiPAA, PVDF-g-PAA, Branched PAA-PEG, CS-g-PANI, Hyperbranched β-cyclodextrin, double-helical native xanthan gum, Li-Nafion, PAA/CMC, Crosslinked PAA/PVA, Glycerol-crosslinked PEDOT:PSS, MAH crosslinked corn starch, MAH crosslinked CMC, Crosslinked natural GG polymer, Crosslinked chitosan, CS-CG+GA, Crosslinked dextrin, Crosslinked CMC-PEG, Crosslinked hyperbranched PEI, Crosslinked PAM hydrogel, Crosslinked PU elastomer, Crosslinked PVA-PEI, TMM functionalized PVA network, a polymer comprising a polyamide (e.g., a nylon), a functionalized polyamide, a copolymer of PEO and a polyamide, Self-healing polymers, PAA-Upy supramolecular, Self-healing PAU-g-PEG, Ca²⁺ crosslinked SA hydrogel, (Fe³⁺) crosslinked (PANa_{0.8}Fe_{y}), crosslinked PEDOT:PSS, PAA-PEG-PBI, Crosslinked CMC-CPAM, Metallopolymer, Si@Fe³⁺-PDA-PAA, β-CDp/6 AD, Slide-ring PR-PAA, Conductive PFFOMB, PEG grafted PFP, PF-COONa, PFPQ-COONa, Pyrene-based (PPyE), Pyrene-based (PPyMAA), Pyrene-based (PPyMADMA), PANI, FA dopped PEDOT:PSS, Stretchable conductive glue, Poly(phenanthrenequinone), Cyclized-PAN, PAA-P(HEA-co-DMA), PEDOT:PSS/PEO/PEI, PAA/PVA+Elastic gel polymer electrolyte, PAA+BFPU, a hybrid of PU and poly(acrylic acid) (PAA), a co-polymer of any subset of the foregoing, etc. Zhao, Y-M., et al. 2021, “Various other polymers may be implemented as the polymeric additive,” InfoMat, Vol. 3, Issue 5, p. 460-501 (hereinafter “Zhao”) provides a description of various polymers that may be implemented as a polymer additive. Zhao is hereby incorporate in its entirety for all purposes.

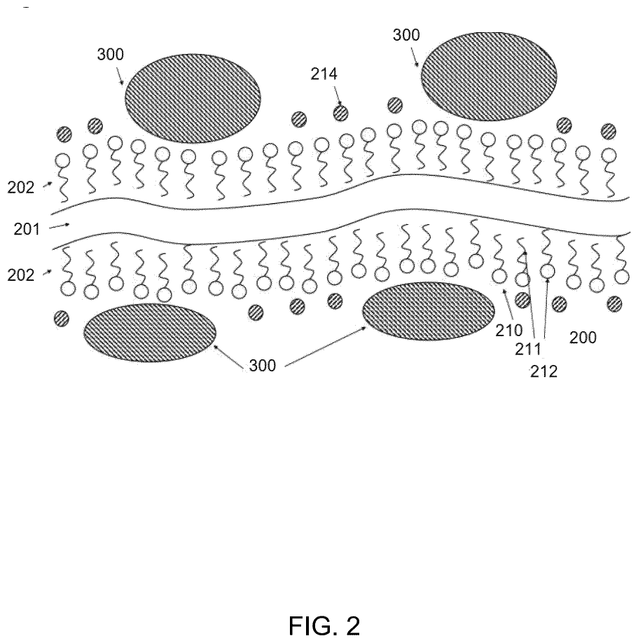

In some embodiments, a surface treatment 202 (not shown, refer to FIG. 2) is applied on the surface of the high aspect ratio carbon elements 108 of the network. The surface treatment promotes adhesion between the high aspect ratio carbon elements and the active material particles 110. The surface treatment may also promote adhesion between the high aspect ratio carbon elements and the current collector 102 (also referred to herein as a “conductive layer”), the optional adhesion layer 104, and/or at least a subset of active material particles 110. The surface treatment may include a surfactant layer that is bonded to the high aspect ratio carbon elements 108 and comprises a plurality of surfactant elements each having a hydrophobic end and a hydrophilic end, wherein the hydrophobic end is disposed proximal a surface one of the high aspect ratio carbon elements 108 and the hydrophilic end is disposed distal said surface one of the high aspect ratio carbon elements 108. In some embodiments, surface treatment 202 comprises at least part of the polymeric additive. In some embodiments, the surface treatment comprises a material which is soluble in a solvent having a boiling point less than 202° C. In some embodiments, the surface treatment comprises a material which is soluble in a solvent having a boiling point less than 185° C.

In some embodiments, the surface treatment 202 may be formed a layer of carbonaceous material which results from the pyrolyzation of polymeric material disposed on the high aspect ratio carbon elements. This layer of carbonaceous material (e.g., graphitic or amorphous carbon) may attach (e.g., via covalent bonds) to or otherwise promote adhesion with the active material particles. Examples of suitable pyrolyzation techniques are described in U.S. Patent Application Ser. No. 63/028,982 filed May 22, 2020. One suitable polymeric material for use in this technique is polyacrylonitrile (PAN).

According to various embodiments, active layer 106 comprises a dispersant. The dispersant may be selected based on a compatibility with water and/or alcohol such as ethanol. In some embodiments, the dispersant is a water-soluble polymer. In some embodiments, the dispersant is an alcohol-soluble polymer. In some embodiments, the dispersant is a polymer that is processable in water or alcohol. In some embodiments, the dispersant corresponds to, or comprises, polyvinylpyrrolidone (PVP). The PVP used in the dispersant may be a PVP having a relatively high molecular weight.

According to various embodiments, active layer 106 comprises about 25% of dispersant by weight of active layer 106. In some embodiments, an amount of dispersant comprised in active layer 106 is between 10% and 50% of active layer 106 by weight. In some embodiments, an amount of dispersant comprised in active layer 106 is between 15% and 40% of active layer 106 by weight. In some embodiments, an amount of dispersant comprised in active layer 106 is between 20% and 30% of active layer 106 by weight.

FIG. 1B is a diagram of an electrode according to various embodiments. In the example shown, electrode 125 is provided. According to various embodiments, electrode 125 comprises current collector 128 and active layer 132. Electrode 125 may optionally include an adhesion layer 130. As an example, adhesion layer 130 comprises a material that promotes adhesion between current collector 128 and active layer 132. In some embodiments, current collector 128 corresponds to (or is similar to) current collector 102 of FIG. 1A.

In some embodiments, active layer 132 corresponds to (or is similar to) current active layer 106 of FIG. 1A. According to various embodiments, the active layer of the electrode comprises a set of multi-wall carbon nanotubes (e.g., denoted by 134 and illustrated with a solid line) and a set of single-wall carbon nanotubes (e.g., denoted by 136 and illustrated with a dotted line). In some embodiments, an average aspect ratio of the set multi-wall carbon nanotubes is larger than an average aspect ratio of the set of single-wall carbon nanotubes.

According to various embodiments, active layer 132 (comprises multi-wall carbon nanotubes and single-wall carbon nanotubes. In some embodiments, an amount of multi-wall carbon nanotubes comprised in active layer 132 is between 0.25% and 4% by weight of the active layer. In some embodiments, an amount of single-wall carbon nanotubes comprised in active layer 136 is between 0.01% and 2% by weight of the active layer. In some embodiments, an amount of single-wall carbon nanotubes comprised in active layer 136 is between 0.5% and 1.5% by weight of the active layer. According to various embodiments, a ratio of an amount by weight of active layer of multi-wall carbon nanotubes in active layer 132 to the single-wall carbon nanotubes in active layer 132 is about 2:1. In some embodiments, a ratio of an amount by weight of active layer of multi-wall carbon nanotubes in active layer 132 to the single-wall carbon nanotubes in active layer 132 is about 5:1. In some embodiments, a ratio of an amount by weight of active layer of multi-wall carbon nanotubes in active layer 132 to the single-wall carbon nanotubes in active layer 132 is about 9:1. In some embodiments, a ratio of an amount by weight of active layer of multi-wall carbon nanotubes in active layer 132 to the single-wall carbon nanotubes in active layer 132 is at least 7:1.

In some embodiments, an amount of multi-wall carbon nanotubes comprised in active layer 132 is between 0.25% and 5% by weight of the active layer. In some embodiments, an amount of single-wall carbon nanotubes comprised in active layer 132 is between 0.01% and 2% by weight of the active layer. In some embodiments, an amount of multi-wall carbon nanotubes comprised in active layer 132 is between 3% and 6% by weight of the active layer. In some embodiments, an amount of multi-wall carbon nanotubes comprised in active layer 132 is between 3% and 5% by weight of the active layer. In some embodiments, an amount of multi-wall carbon nanotubes comprised in active layer 132 is between 4% and 5% by weight of the active layer. In some embodiments, an amount of multi-wall carbon nanotubes comprised in active layer 132 is about 4% by weight of the active layer.

In some embodiments, active layer 132 further graphite. Graphite may be used to increase the coulombic effective. Graphite is conductive and may void a swelling shape. In some embodiments, active layer 132 of an electrode comprises at least 5% of graphite by weight of active layer 132. In some embodiments, active layer 132 of an electrode comprises between 4% and 7% of graphite by weight of active layer 132. In some embodiments, active layer 132 of an electrode comprises about 5% of graphite by weight of active layer 132. In some embodiments, active layer 132 of an electrode comprises at least 10% of graphite by weight of active layer 132. In some embodiments, active layer 132 comprises at least 15% of graphite by weight of active layer 132. In some embodiments, active layer 132 comprises at least 20% of graphite by weight of active layer 132.

The single-wall carbon nanotubes comprised in the electrode exhibit, on average, longer lengths than single-wall carbon nanotubes in related art electrodes. A slurry having high viscosities is prepared and subject to relatively low shear forces during processing. Properties of the multi-wall carbon nanotubes may be obtained using scanning electron microscopy (SEM). According to various embodiments, the single-wall carbon nanotubes comprise a range of lengths between 1 nm and 34 nm. The average length of the single-wall carbon nanotubes may be between 7 and 8 micron. In some embodiments, the single-wall carbon nanotubes comprise an average diameter of between 1 nm and 2 nm, and an average length of about 5 micron. In some embodiments, the single-wall carbon nanotubes comprise an average diameter of between 3 nm and 5 nm, and an average length of at least 200 micron. In some embodiments, the single-wall carbon nanotubes comprise an average diameter of between 3 nm and 5 nm, and an average length of between 7 and 8 micron. In some embodiments, the single-wall carbon nanotubes comprise an average diameter of between 5 nm and 6 nm, and an average length of between 7 and 8 micron. In some embodiments, the single-wall carbon nanotubes comprise on average 1 or 2 layers of walls.

FIG. 1C is a diagram of an electrode according to various embodiments. In the example shown, the active layer of electrode 150 comprises functionalized carbon elements. As an example, the functionalized carbon elements may be obtained based at least in part on subjecting the high aspect ratio carbon elements 108 (e.g., a set of multi-wall carbon nanotubes and/or a set of single-wall carbon nanotubes, etc.) of active layer 106 of electrode 100 illustrated in FIG. 1A to a surface treatment.

In some embodiments, the functionalized carbon elements are formed from dried (e.g., lyophilized) aqueous dispersion comprising nanoform carbon and functionalizing material such as a surfactant. In some such embodiments, the aqueous dispersion is substantially free of materials that would damage the carbon elements, such as acids.

In some embodiments, surface treatment of the high aspect ratio carbon elements includes a thin polymeric layer disposed on the carbon elements that promotes adhesion of the active material to the network. In some such embodiments the thin polymeric layer comprises a self-assembled and or self-limiting polymer layer. In some embodiments, the thin polymeric layer bonds to the active material, e.g., via hydrogen bonding.

In some embodiments the thin polymeric layer may have a thickness in the direction normal to the outer surface of the carbon elements of less 3 times, 2 times, 1 times, 0.5 times, 0.1 times that the minor dimension of the element (or less).

In some embodiments, the thin polymeric layer includes functional groups (e.g., side functional groups) that bond to the active material, e.g., via non-covalent bonding such a π-π bonding. In some such embodiments the thin polymeric layer may form a stable covering layer over at least a portion of the carbon elements.

In some embodiments, the thin polymeric layer on some of the elements may bond with a current collector or and adhesion layer disposed thereon and underlying an active layer containing the energy storage (i.e., active) material. For example, in some embodiments, the thin polymeric layer includes side functional groups that bond to the surface of the current collector or adhesion layer, e.g., via non-covalent bonding such a π-π bonding. In some such embodiments, the thin polymeric layer may form a stable covering layer over at least a portion of the elements. In some embodiments, this arrangement provides for excellent mechanical stability of the electrode.

In some embodiments, the polymeric material is miscible in solvents of the type described in the examples above. For example, in some embodiments the polymeric material is miscible in a solvent that includes an alcohol such as methanol, ethanol, or 2-propanol (isopropyl alcohol, sometimes referred to as IPA) or combinations thereof. In some embodiments, the solvent may include one or more additives used to further improve the properties of the solvent, e.g., low boiling point additives such as acetonitrile (ACN), de-ionized water, and tetrahydrofuran. In this example, the mixture is formed in an NMP free solvent.

In yet further exemplary embodiments, the surface treatment may be formed of a layer of carbonaceous material which results from the pyrolization of polymeric material disposed on the high aspect ratio carbon elements. This layer of carbonaceous material (e.g., graphitic or amorphous carbon) may attach (e.g., via covalent bonds) to or otherwise promote adhesion with the active material particles. Examples of suitable pyrolization techniques are described in U.S. Patent Application Ser. No. 63/028,982 filed May 22, 2020, the entirety of which is hereby incorporated herein for all purposes. One suitable polymeric material for use in this technique is polyacrylonitrile (PAN)

According to various embodiments, active layer 106 comprises a dispersant. The dispersant may be selected based on a compatibility with water and/or alcohol such as ethanol. In some embodiments, the dispersant is a water-soluble polymer. In some embodiments, the dispersant corresponds to, or comprises, Polyvinylpyrrolidone (PVP). The PVP used in the dispersant may be a PVP having a relatively high molecular weight.

Dispersants and additives may be added to the mixture. An example of a dispersant is PVP. Polyvinylpyrrolidone (PVP), also commonly called “polyvidone” or “povidone,” is a water-soluble polymer made from the monomer N-vinylpyrrolidone. Generally, the dispersant serves as an emulsifier and disintegrant for solution polymerization and as a surfactant, reducing agent, shape controlling agent and dispersant in nanoparticle synthesis and their self-assembly. Another example of a dispersant includes AQUACHARGE, which is a tradename for an aqueous binder for electrodes, that was developed by applying water-soluble resin technology. AQUACHARGE is produced by Sumitomo Seika Chemicals Co., Ltd. of Hyogo Japan. A similar example is provided in U.S. Pat. No. 8,124,277, entitled “Binder for electrode formation, slurry for electrode formation using the binder, electrode using the slurry, rechargeable battery using the electrode, and capacitor using the electrode,” and incorporated herein by reference in it's entirety. Further examples include polyacrylic acid (PAA) which is a synthetic high-molecular weight polymer of acrylic acid as well as sodium polyacrylate which is a sodium salt of polyacrylic acid.

TABLE III
Dispersant Additions and Mixing

| Parameters | Motivations | Value | Comment |
|---|---|---|---|
| Duration | | 60 min | Low Specific Capacity (mAh/g) for |
| | | (40 to 80 mins) | Cathode and Anode Electrodes |
| | | 120 min | High Specific Capacity (mAh/g) for |
| | | (90 to 150 mins) | Cathode and Anode Electrodes |
| Dispersion | should be | ~800 rpm | for low viscosity/small volume |
| Speed | maximized | (600 to 1000 rpm) | |
| | while avoid | 1000 rpm | Experiments show 1300-1400 rpm is |
| | splash | (800 to 1200 rpm) | better for mixing dispersant additives |
| | | | (ex. PVP) in slurry |
| | | ~1300-1400 rpm | for high viscosity/high volume |
| | | (1200 to 1600 rpm) | |

TABLE IV
Target Viscosity Range of Slurry

| Shear Rate (rpm) | Viscosity (mPa s) |
|---|---|
| 6 | 20000-10000 |
| 12 | 6000-3000 |
| 30 | 3000-1500 |
| 60 | 1200-800 |

FIG. 2 is a diagram of an electrode according to various embodiments. In the example illustrated, a detailed view is provided of high aspect ratio carbon element 201 of the network 200 (as shown in FIGS. 1A and 1B), located near several active material particles 300. In the embodiment shown, the surface treatment 202 on the element 201 is a surfactant layer bonded to the outer layer of the surface of the element 201. As shown, the surfactant layer comprises a plurality of surfactant elements 210 each having a hydrophobic end 211 and a hydrophilic end 212, wherein the hydrophobic end is disposed proximal the surface of the carbon element 201 and the hydrophilic end 212 is disposed distal the surface.

In some embodiments where the carbon element 201 is hydrophobic (as is typically the case with nanoform carbon elements such as CNTs, CNT bundles, and graphene flakes), the hydrophobic end 211 of the surfactant element 210 will be attracted to the carbon element 201. Accordingly, in some embodiments, the surface treatment 202 may be a self-assembling layer. For example, as detailed below, in some embodiments, when the carbon elements 201 are mixed in a solvent with a surfactant elements 210 to form a slurry, the surface treatment 202 layer self assembles on the surface due to electrostatic interactions between the elements 201 and 210 within the slurry.

In some embodiments, a surface treatment 202 is applied on the surface of the high aspect ratio carbon elements of the three-dimensional network (e.g., high aspect ratio carbon elements 108 of electrode 100 of FIG. 1A). The surface treatment promotes adhesion between the high aspect ratio carbon elements and the active material particles 300 (e.g., active material particles 110 of electrode 100 of FIG. 1A). The surface treatment may also promote adhesion between the high aspect ratio carbon elements and the current collector (also referred to herein as a “conductive layer”), such as current collector 102 of electrode 100 of FIG. 1A, and/or the optional adhesion layer (e.g., adhesion layer 104 of electrode 100 of FIG. 1A).

In some embodiments, the surface treatment 202 may a self-limiting layer. For example, as detailed below, in some embodiments, when the elements 201 are mixed in a solvent with a surfactant elements 210 to form a slurry, the surface treatment 202 layer self assembles on the surface due to electrostatic interactions between the elements 201 and 210 within the slurry. In some such embodiments, once an area of the surface of the element 201 is covered in surfactant elements 210, additional surfactant elements 210 will not be attracted to that area. In some embodiments, once the surface of the element 201 is covered with surfactant elements 202, further elements are repulsed from the layer, resulting in a self-limiting process. For example, in some embodiments the surface treatment 202 may form in a self-limiting process, thereby ensuring that the layer will be thin, e.g., a single molecule or a few molecules thick.

In some embodiments, the hydrophilic ends 212 of at least a portion of the surfactant elements form bonds with the active material particles 300. Accordingly, the surface treatment 202 can provide good adhesion between the elements 201 of the network 200 and the active material particles. In some embodiments, the bonds may be covalent bonds, or non-covalent bonds such as π-π bonds, hydrogen bonds, electrostatic bonds or combinations thereof.

For example, in some embodiments, the hydrophilic end 212 of the surfactant element 210 has a polar charge of a first polarity; while the surface of the active material particles 300 carry a polar charge of a second polarity opposite that of the first polarity, and so are attracted to each other.

For example, in some embodiments where, during formation of the layer 100, the active material particles 300 are combined in a solvent with carbon elements 201 bearing the surface treatment 202 (as described in greater detail below), the outer surface of the active material particles 300 may be characterized by a Zeta potential (as is known in the art) having the opposite sign of the Zeta potential of the outer surface of the surface treatment 202. Accordingly, in some such embodiments, attractions between the carbon elements 201 bearing the surface treatment 202 and the active material products 300 promote the self-assembly of a structure in which the active material particles 300 are enmeshed with the carbon elements 201 of the network 200.

In some embodiments the hydrophilic ends 212 of at least a portion of the surfactant elements form bonds with a current collector layer or adhesion layer underlying the active material layer 100. Accordingly, the surface treatment 202 can provide good adhesion between the elements 201 of the network 200 and such underlying layer. In some embodiments, the bonds may be covalent bonds, or non-covalent bonds such as π-π bonds, hydrogen bonds, electrostatic bonds or combinations thereof. In some embodiments, this arrangement provides for excellent mechanical stability of the electrode 10, as discussed in greater detail below.

In various embodiments, the surfactant used to form the surface treatment 202 as described above may include any suitable material. For example, in some embodiments the surfactant may include one or more of the following: hexadecyltrimethylammonium hexafluorophosphate (CTAP), hexadecyltrimethylammonium tetrafluoroborate (CTAB), hexadecyltrimethylammonium acetate, hexadecyltrimethylammonium nitrate, hocamidopropyl betaine, N-(cocoalkyl)-N,N,N-trimethylammonium methyl sulfate, and cocamidopropyl betaine. Additional suitable materials are described below.

In some embodiments, the surfactant layer 202 may be formed by dissolving a compound in a solvent, such that the layer of surfactant is formed from ions from the compound (e.g., in a self-limiting process as described above). In some such embodiments, the active layer 100 will then include residual counter ions 214 to the surfactant ions forming the surface treatment 202.

In some embodiments, these surfactant counter ions 214 are selected to be compatible with use in an electrochemical cell. For example, in some embodiments, the counter ions are selected to be unreactive or mildly reactive with materials used in the cell, such as an electrolyte, separator, housing, or the like. For example, if an aluminum housing is used the counter ion may be selected to be unreactive or mildly reactive with the aluminum housing.

For example, in some embodiments, the residual counter ions are free or substantially free of halide groups. For example, in some embodiments, the residual counter ions are free or substantially free of bromine.

In some embodiments, the residual counter ions may be selected to be compatible with an electrolyte used in an energy storage cell containing the active layer 200. For example, in some embodiments, residual counter ions maybe the same species of ions used in the electrolyte itself. For example, if the electrolyte includes a dissolved Li PF6 salt, the electrolyte anion is PF6. In such a case, the surfactant may be selected as, for example, CTA PF6, such that the surface treatment 202 is formed as a layer of anions from the CTA PF6, while the residual surfactant counter ions are the PF6 anions from the CTA PF6 (thus matching the anions of the electrolyte).

In some embodiments, the surfactant material used may be soluble in a solvent which exhibits advantageous properties. For example, in some embodiments, the solvent may include water or an alcohol such as methanol, ethanol, or 2-propanol (isopropyl alcohol, sometimes referred to as IPA) or combinations thereof. In some embodiments, the solvent may include one or more additives used to further improve the properties of the solvent, e.g., low boiling point additives such as acetonitrile (ACN), de-ionized water, and tetrahydrofuran.

For example, if a low boiling point solvent is used in the formation of the surface treatment 202, the solvent may be quickly removed using a thermal drying process (e.g., of the type described in greater detail below) performed at a relatively low temperature. As will be understood by those skilled in the art, this can improve the speed and or cost of manufacture of the active layer 202.

For example, in some embodiments, the surface treatment 202 is formed from a material which is soluble in a solvent having a boiling point less than 250° C., 225° C., 202° C., 200° C., 185° C., 180° C., 175° C., 150° C., 125° C., or less, e.g., less than or equal to 100° C.

In some embodiments, the solvent may exhibit other advantageous properties. In some embodiments the solvent may have a low viscosity, such a viscosity at 20° C. of less than or equal to 3.0 centipoise, 2.5 centipoise, 2.0 centipoise, 1.5 centipoise, or less. In some embodiments the solvent may have a low surface tension such a surface tension at 20° C. of less than or equal to 40 mN/m, 35 mN/m, 30 mN/m, 25 mN/m or less. In some embodiments the solvent may have a low toxicity, e.g., toxicity comparable to alcohols such as isopropyl alcohol.

Notably, this contrasts with the process used to form conventional electrode active layers featuring bulk binder materials such as polyvinylidene fluoride or polyvinylidene difluoride (PVDF). Such bulk binders require aggressive solvents often characterized by high boiling points. One such example is n-methyl-2-pyrrolidone (NMP). Use of NMP (or other pyrrolidone based solvents) as a solvent requires the use of high temperate drying processes to remove the solvent. Moreover, NMP is expensive, requiring a complex solvent recovery system, and highly toxic, posing significant safety issues. In contrast, as further detailed below, in various embodiments the active layer 200 may be formed without the use of NMP or similar compounds such pyrrolidone compounds.

While one class of exemplary surface treatment 202 is described above, it is understood that other treatments may be used. For example, in various embodiments the surface treatment 202 may be formed by functionalizing the high aspect ratio carbon elements 201 using any suitable technique as described herein or known in the art. Functional groups applied to the elements 201 may be selected to promote adhesion between the active material particles 300 and the network 200. For example, in various embodiments the functional groups may include carboxylic groups, hydroxylic groups, amine groups, silane groups, or combinations thereof.

As will be described in greater detail below, in some embodiments, the functionalized carbon elements 201 are formed from dried (e.g., lyophilized) aqueous dispersion comprising nanoform carbon and functionalizing material such as a surfactant. In some such embodiments, the aqueous dispersion is substantially free of materials that would damage the carbon elements 201, such as acids.

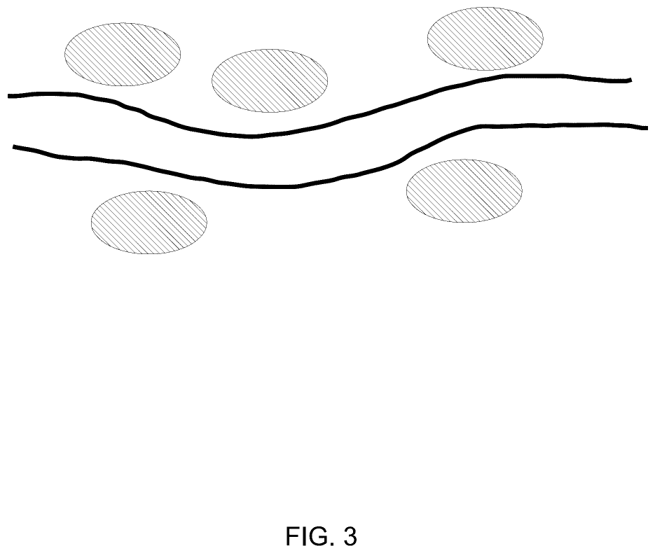

FIG. 3 is a diagram of an electrode according to various embodiments.

Referring to FIG. 3, in some embodiments, the surface treatment 202 on the high aspect ratio carbon elements 201 includes polymeric particles disposed on the carbon elements that promotes adhesion of the active material to the network. In some such embodiments the polymeric particles comprises a self-assembled and or self-limiting polymer layer. In some embodiments, the polymeric particles bond to the active material, e.g., via hydrogen bonding.

In some embodiments, the polymeric particles includes functional groups (e.g., side functional groups) that bond to the active material, e.g., via non-covalent bonding such a π-π bonding. In some such embodiments the polymeric particles may form a stable covering layer over at least a portion of the elements 201.

In some embodiments, the polymeric particles on some of the elements 201 may bond with a current collector 101 or adhesion layer 102 underlying the active layer 200. For example, in some embodiments the polymeric particles includes side functional groups that bond to the surface of the current collector 101 or adhesion layer 102, e.g., via non-covalent bonding such a π-π bonding. In some such embodiments the polymeric particles may form a stable covering layer over at least a portion of the elements 201. In some embodiments, this arrangement provides for excellent mechanical stability of the electrode 10, as discussed in greater detail below.

In some embodiments, the polymeric material is miscible in solvents of the type described in the examples above. For example, in some embodiments the polymeric material is miscible in a solvent that includes an alcohol such as methanol, ethanol, or 2-propanol (isopropyl alcohol, sometimes referred to as IPA) or combinations thereof. In some embodiments, the solvent may include one or more additives used to further improve the properties of the solvent, e.g., low boiling point additives such as acetonitrile (ACN), de-ionized water, and tetrahydrofuran.

Suitable examples of materials which may be used for the polymeric particles include water soluble polymers such as polyvinylpyrrolidone.

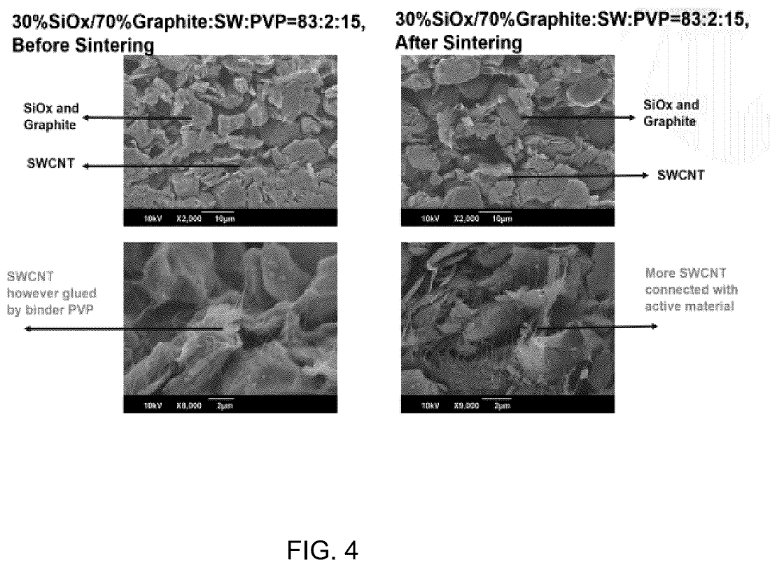

FIG. 4 is an example of an electron micrograph of an active layer according to various embodiments.

Referring to FIG. 4, an electron micrograph of an exemplary active material layer of the type described herein is shown. Tendril like high aspect ratio carbon elements (formed of CNT bundles) are clearly shown enmeshing the active material particles. In some embodiments, the active layer lacks any bulky polymeric material taking up space within the layer.

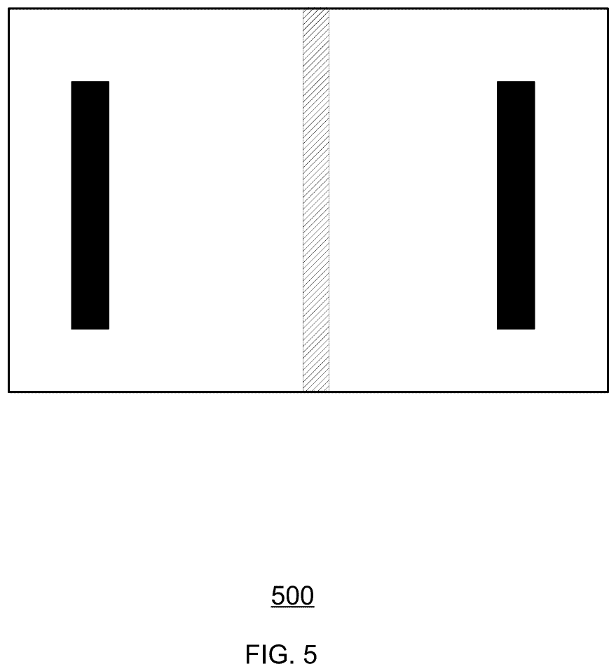

FIG. 5 is a schematic of an energy storage device.

Referring to FIG. 5, an energy storage cell 500 is shown which includes a first electrode 501 a second electrode 502, a permeable separator 503 disposed between the first electrode 501 and the second electrode 502, and an electrolyte 504 wetting the first and second electrodes. One or both of the electrodes 501, 502 may be of the type described herein.

In some embodiments, the energy storage cell 500 may be a battery, such as a lithium ion battery. In some such embodiments, the electrolyte may be a lithium salt dissolved in a solvent, e.g., of the types described in Qi Li, Juner Chen, Lei Fan, Xueqian Kong, Yingying Lu, Progress in electrolytes for rechargeable Li-based batteries and beyond, Green Energy & Environment, Volume 1, Issue 1, Pages 18-42, the entire contents of which are incorporated herein by reference.

In some such embodiments, the energy storage cell may have an operational voltage in the range of 1.0 V to 5.0 V, or any subrange thereof such as 2.3V-4.3V.

In some such embodiments, the energy storage cell 500 may have an operating temperature range comprising −40° C. to 100° C. or any subrange thereof such as −10° C. to 60° C.

In some such embodiments, the energy storage cell 500 may have a gravimetric energy density of at least 100 Wh/kg, 200 Wh/kg, 300 Wh/kg, 400 Wh/kg, 500 Wh/kg, 1000 Wh/kg or more.

In some such embodiments, the energy storage cell 500 may have a volumetric energy density of at least 200 Wh/L, 400 Wh/L, 600 Wh/L, 800 Wh/L, 1,000 Wh/L, 1,500 Wh/L, 2,000 Wh/L or more.

In some such embodiments, the energy storage cell 500 may have a C rate in the range of 0.1 to 50.

In some such embodiments, the energy storage cell 500 may have a cycle life of at least 1,000, 1500, 2,000, 2,500, 3,000, 3,500, 4,000 or more charge discharge cycles.

In some embodiments, the energy storage cell 500 may be a lithium ion capacitor of the type described in U.S. Pat. App. Ser. No. 63/021,492, filed May 8, 2020, the entire contents of which are incorporated herein by reference.

In some such embodiments, the energy storage cell 500 may have an operating temperature range comprising −60° C. to 100° C. or any subrange thereof such as −40° C. to 85° C.

In some such embodiments, the energy storage cell 500 may have a gravimetric energy density of at least 10 Wh/kg, 15 Wh/kg, 20 Wh/kg, 30 Wh/kg, 40 Wh/kg, 50 Wh/kg, or more.

In some such embodiments, the energy storage cell 500 may have a volumetric energy density of at least 20 Wh/L, 30 Wh/L, 40 Wh/L, 50 Wh/L, 60 Wh/L, 70 Wh/L, 80 Wh/L or more.

In some such embodiments, the energy storage cell 500 may have a gravimetric power density of at least 5 kW/kg, 7.5 W/kg, 10 kW/kg, 12.5 kW/kg, 14 kW/kg, 15 kW/kg or more.

In some such embodiments, the energy storage cell 500 may have a volumetric power density of at least 10 kW/L, 15 kW/L, 20 kW/L, 22.5 kW/L, 25 kW/L, 28 kW/L, 30 kW/L or more.

In some such embodiments, the energy storage cell 500 may have a C rate in the range of 1.0 to 100.

In some such embodiments, the energy storage cell 500 may have a cycle life of at least 100,000, 500,000, 1,000,000 or more charge discharge cycles.

### Fabrication Methods

Electrode 100 comprising active layer 106 of FIG. 1A and electrode 125 comprising active layer 132 of FIG. 1B as described herein may be made using any suitable manufacturing process. As will be understood by one skilled in the art, in some embodiments the electrode 10 may be made using wet coating techniques of the types described in International Patent Publication No. WO/2018/102652 published Jun. 7, 2018 in further view of the teachings described herein.

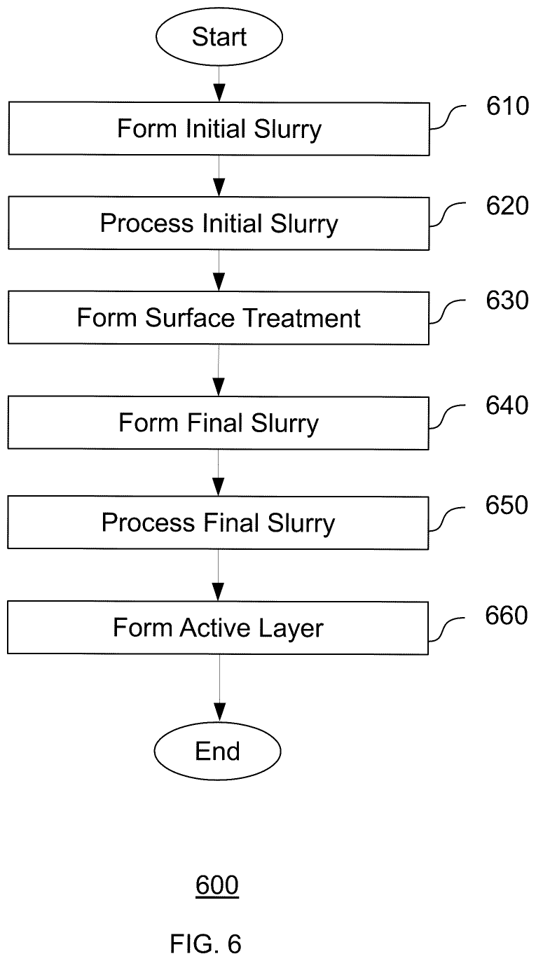

FIG. 6 is a flow chart of a method for making an electrode according to various embodiments. The description of process 600 is provided with respect to electrode 100 of FIG. 1A. Process 600 may be similarly implemented in connection with manufacturing electrodes according to various embodiments disclosed herein, including electrode 125 of FIG. 1B.

Referring to FIG. 6, in some embodiments, the active layer of an electrode (e.g., 106 of electrode 100) may be formed using process 600. The manufacturing or processing of an active layer and/or electrode is further described in U.S. Patent Application No. PCT/US2021/53519 filed on Oct. 5, 2021, the entirety of which is hereby incorporated herein by reference for all purposes.

At 610, high aspect ratio carbon elements 201 and a surface treatment material (e.g., a surfactant or polymer material as described herein) are combined with a solvent (of the type described herein) to form an initial slurry.

At 620, the initial slurry is processed to ensure good dispersion of the solid materials in the slurry. In some embodiments, this processing includes introducing mechanical energy into the mixture of solvent and solid materials (e.g., using a sonicator, which may be sometimes also be referred to as a “sonifier”) or other suitable mixing device (e.g., a high shear mixer). In some embodiments, the mechanical energy introduced into the mixture is at least 0.4 kilowatt-hours per kilogram (kWh/kg), 0.5 kWh/kg, 0.6 kWh/kg, 0.7 kWh/kg, 0.8 kWh/kg, 0.9 kWh/kg, 1.0 kWh/kg, or more. For example, the mechanical energy introduced into the mixture per kilogram of mixture may be in the range of 0.4 kWh/kg to 1.0 kWh/kg or any subrange thereof such as 0.4 kWh/kg to 0.6 kWh/kg.

In some embodiments an ultrasonic bath mixer may be used. In other embodiments, a probe sonicator may be used. Probe sonication may be significantly more powerful and effective when compared to ultrasonic baths for nanoparticle applications. High shear forces created by ultrasonic cavitation have the ability to break up particle agglomerates and result in smaller and more uniform particles sizes. Among other things, sonication can result in stable and homogenous suspensions of the solids in the slurry. Generally, this results in dispersing and deagglomerating and other breakdown of the solids. Examples of probe sonication devices include the Q Series Probe Sonicators available from QSonica LLC of Newtown, Connecticut. Another example includes the Branson Digital SFX-450 sonicator available commercially from Thomas Scientific of Swedesboro, New Jersey.

In some embodiments, however, the localized nature of each probe within the probe assembly can result in uneven mixing and suspension. Such may be the case, for example, with large samples. This may be countered by use of a setup with a continuous flow cell and proper mixing. For example, with such a setup, mixing of the slurry will achieve reasonably uniform dispersion.

In some embodiments the initial slurry, once processed will have a viscosity in the range of 5,000 cps to 25,000 cps or any subrange thereof, e.g., 6,000 cps to 19,000 cps.

At 630, the surface treatment 202 may be fully or partially formed on the high aspect ratio carbon elements 201 in the initial slurry. In some embodiments, at this stage the surface treatment 202 may self-assemble as described in detail above with reference to FIGS. 2 and 3. The resulting surface treatment 201 may include functional groups or other features which, as described in further steps below, may promote adhesion between the high aspect ratio carbon elements 201 and active material particles 300.

At 640, the active material particles 300 may be combined with the initial slurry to form a final slurry containing the active material particles 300 along with the high aspect ratio carbon elements 201 with the surface treatment 202 formed thereon.

In some embodiments, the active material 300 may be added directly to the initial slurry. In other embodiments, the active material 300 may first be dispersed in a solvent (e.g., using the techniques described above with respect to the initial solvent) to form an active material slurry. This active material slurry may then be combined with the initial slurry to form the final slurry.

At 650, the final slurry is processed to ensure good dispersion of the solid materials in the final slurry. In various embodiments any suitable mixing process known in the art may be used. In some embodiments this processing may use the techniques described above with reference to 620. In some embodiments, a planetary mixer such as a multi-axis (e.g., three or more axis) planetary mixer may be used. In some such embodiments the planetary mixer can feature multiple blades, e.g., two or more mixing blades and one or more (e.g., two, three, or more) dispersion blades such as disk dispersion blades.

In some embodiments, during 650, the matrix 200 enmeshing the active material 300 may fully or partially self-assemble, as described in detail above with reference to FIGS. 2 and 3. In some embodiments, interactions between the surface treatment 202 and the active material 300 promote the self-assembly process.

In some embodiments the final slurry, once processed will have a viscosity in the range of 1,000 cps to 10,000 cps or any subrange thereof, e.g., 2,500 cps to 6000 cps

At 660, the active layer 106 is formed from the final slurry. In some embodiments, final slurry may be cast wet directly onto the current collector conductive layer 102 (or optional adhesion layer 104) and dried. As an example, casting may be by applying at least one of heat and a vacuum until substantially all of the solvent and any other liquids have been removed, thereby forming the active layer 106. In some such embodiments, protecting various parts of the underlying layers may be desirable. For example, protecting an underside of the conductive layer 102 may be desirable where the electrode 100 is intended for two-sided operation. Protection may include, for example, protection from the solvent by masking certain areas, or providing a drain to direct the solvent away.

In other embodiments, the final slurry may be at least partially dried elsewhere and then transferred onto the adhesion layer 104 or the conductive layer 102 to form the active layer 106, using any suitable technique (e.g., roll-to-roll layer application). In some embodiments the wet combined slurry may be placed onto an intermediate material with an appropriate surface and dried to form the layer (e.g., the active layer 106). While any material with an appropriate surface may be used as the intermediate material, exemplary intermediate material includes PTFE as subsequent removal from the surface is facilitated by the properties thereof. In some embodiments, the designated layer is formed in a press to provide a layer that exhibits a desired thickness, area and density.

In some embodiments, the final slurry may be formed into a sheet, and coated onto the adhesion layer 104 or the conductive layer 102 as appropriate. For example, in some embodiments, the final slurry may be applied to through a slot die to control the thickness of the applied layer. In other embodiments, the slurry may be applied and then leveled to a desired thickness, e.g., using a doctor blade. A variety of other techniques may be used for applying the slurry. For example, coating techniques may include, without limitation: comma coating; comma reverse coating; doctor blade coating; slot die coating; direct gravure coating; air doctor coating (air knife); chamber doctor coating; off set gravure coating; one roll kiss coating; reverse kiss coating with a small diameter gravure roll; bar coating; three reverse roll coating (top feed); three reverse roll coating (fountain die); reverse roll coating and others.

The viscosity of the final slurry may vary depending on the application technique. For example, for comma coating, the viscosity may range between about 1,000 cps to about 200,000 cps. Lip-die coating provides for coating with slurry that exhibits a viscosity of between about 500 cps to about 300,000 cps. Reverse-kiss coating provides for coating with slurry that exhibits a viscosity of between about 5 cps and 1,000 cps. In some applications, a respective layer may be formed by multiple passes.

In some embodiments, the active layer 106 formed from the final slurry may be compressed (e.g., using a calendaring apparatus) before or after being applied to the electrode 100. In some embodiments, the slurry may be partially or completely dried (e.g., by applying heat, vacuum or a combination thereof) prior to or during the compression process. For example, in some embodiments, the active layer may be compressed to a final thickness (e.g., in the direction normal to the current collector layer 102) of less than 90%, 80%, 70%, 50%, 40%, 30%, 20%, 10% or less of its pre-compression thickness.

In various embodiments, when a partially dried layer is formed during a coating or compression process, the layer may be subsequently fully dried, (e.g., by applying heat, vacuum or a combination thereof). In some embodiments, substantially all of the solvent is removed from the active layer 106.

In some embodiments, solvents used in formation of the slurries are recovered and recycled into the slurry-making process.

In some embodiments, active layer 106 may be compressed, e.g., to break some of the constituent high aspect ratio carbon elements or other carbonaceous material to increase the surface area of the respective layer. In some embodiments, this compression treatment may increase one or more of adhesion between the layers, ion transport rate within the layers, and the surface area of the layers. In various embodiments, compression can be applied before or after the respective layer is applied to or formed on the electrode 100.

In some embodiments where calendaring is used to compress active layer 106, the calendaring apparatus may be set with a gap spacing equal to less than 90%, 80%, 70%, 50%, 40%, 30%, 20%, 10% or less of the layer's pre-compression thickness (e.g., set to about 33% of the layer's pre-compression thickness). The calendar rolls can be configured to provide suitable pressure, e.g., greater than 1 ton per cm of roll length, greater than 1.5 ton per cm of roll length, greater than 2.0 ton per cm of roll length, greater than 2.5 ton per cm of roll length, or more. In some embodiments, the post compression active layer will have a density in the range of 1 g/cc to 10 g/cc, or any subrange thereof such as 2.5 g/cc to 4.0 g/cc. In some embodiments the calendaring process may be carried out at a temperature in the range of 20° C. to 140° C. or any subrange thereof. In some embodiments active layer 106 may be pre-heated prior to calendaring, e.g., at a temperature in the range of 20° C. to 100° C. or any subrange thereof.

Once the electrode 100 has been assembled, the electrode 100 may be used to assemble the energy storage device. Assembly of the energy storage device may follow conventional steps used for assembling electrodes with separators and placement within a housing such as a canister or pouch, and further may include additional steps for electrolyte addition and sealing of the housing.

In various embodiments, process 600 may include any of the following features (individually or in any suitable combination)

In some embodiments, the initial slurry has a solid content in the range of 0.1%-20.0% (or any subrange thereof) by weight. In some embodiments, the final slurry has a solid content in the range of 10.0%-80% (or any subrange thereof) by weight.

In various embodiments, the solvent used may any of those described herein with respect to the formation of the surface treatment 202. In some embodiments, the surfactant material used to form the surface treatment 202 may be soluble in a solvent which exhibits advantageous properties. For example, in some embodiments, the solvent may include water or an alcohol such as methanol, ethanol, or 2-propanol (isopropyl alcohol, sometimes referred to as IPA) or combinations thereof. In some embodiments, the solvent may include one or more additives used to further improve the properties of the solvent, e.g., low boiling point additives such as acetonitrile (ACN), de-ionized water, and tetrahydrofuran.

In some embodiments, if a low boiling point solvent is used the solvent may be quickly removed using a thermal drying process performed at a relatively low temperature. As will be understood by those skilled in the art, this can improve the speed and or cost of manufacture of the electrode 100. For example, in some embodiments, the solvent may have a boiling point less than 250° C., 225° C., 202° C., 200° C., 185° C., 180° C., 175° C., 150° C., 125° C., or less, e.g., less than or equal to 100° C.

In some embodiments, the solvent may exhibit other advantageous properties. In some embodiments the solvent may have a low viscosity, such a viscosity at 20° C. of less than or equal to 3.0 centipoise, 2.5 centipoise, 2.0 centipoise, 1.5 centipoise, or less. In some embodiments the solvent may have a low surface tension such a surface tension at 20° C. of less than or equal to 40 mN/m, 35 mN/m, 30 mN/m, 25 mN/m or less. In some embodiments the solvent may have a low toxicity, e.g., toxicity comparable to alcohols such as isopropyl alcohol.

In some embodiments, during the formation of the active layer, a material forming the surface treatment may be dissolved in a solvent substantially free of pyrrolidone compounds. In some embodiments, the solvent is substantially free of n-methyl-2-pyrrolidone.

In some embodiments, the surface treatment 201 is formed from a material that includes a surfactant of the type described herein.

In some embodiments, dispersing high aspect ratio carbon elements and a surface treatment material in a solvent to form an initial slurry comprises applying forces to agglomerated carbon elements to cause the elements to slide apart from each other along a direction transverse to a minor axis of the elements. In some embodiments, techniques for forming such dispersions may be adapted from those disclosed in International Patent Publication No. WO/2018/102652 published Jun. 7, 2018, which is hereby incorporated herein in its entirety for all purposes, in further view of the teachings described herein.

In some embodiments, the high aspect ratio carbon elements 201 can be functionalized prior to forming a slurry used to form the electrode 100. For example, in one aspect a method is disclosed that includes dispersing high aspect ratio carbon elements 201 and a surface treatment material in an aqueous solvent to form an initial slurry, wherein said dispersion step results in the formation of a surface treatment on the high aspect ratio carbon; drying the initial slurry to remove substantially all moisture resulting in a dried powder of the high aspect ratio carbon with the surface treatment thereon. In some embodiments, the dried powder may be combined, e.g., with a slurry of solvent and active material to form a final solvent of the type described above with reference to method 600.

In some embodiments, drying the initial slurry comprises lyophilizing (freeze-drying) the initial slurry. In some embodiments, the aqueous solvent and initial slurry are substantially free of substances damaging to the high aspect ratio carbon elements. In some embodiments, the aqueous solvent and initial slurry are substantially free of acids. In some embodiments, the initial slurry consists essentially of the high aspect ratio carbon elements, the surface treatment material, and water.

Some embodiments further include dispersing the dried powder of the high aspect ratio carbon with the surface treatment in a solvent and adding and active material to form a secondary slurry; coating the secondary slurry onto a substrate; and drying the secondary slurry to form an electrode active layer. In some embodiments, the preceding steps can be performed using techniques adapted from those disclosed in International Patent Publication No. WO/2018/102652 published Jun. 7, 2018 in further view of the teachings described herein.

In some embodiments, the final slurry may include polymer additives such as polyacrilic acid (PAA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP). In some embodiments, the active layer may be treated by applying heat to pyrolyze the additive such that the surface treatment 202 may be formed a layer of carbonaceous material which results from the pyrolization of the polymeric additive. This layer of carbonaceous material (e.g., graphitic or amorphous carbon) may attach (e.g., via covalent bonds) to or otherwise promote adhesion with the active material particles 300. The heat treatment may be applied by any suitable means, e.g., by application of a laser beam. Examples of suitable pyrolization techniques are described in U.S. Patent Application Ser. No. 63/028,982 filed May 22, 2020, which is hereby incorporated herein in its entirety for all purposes.

### Surfactants

The techniques described above include the use of surfactants to for a surface treatment 202 on high aspect ratio carbon nanotubes 201 in order to promote adhesion with the active material particles 300. While several advantageously suitable surfactants have been described, it is to be understood that other surfactant material may be used, including the following.

Surfactants are molecules or groups of molecules having surface activity, including wetting agents, dispersants, emulsifiers, detergents, and foaming agents. A variety of surfactants can be used in preparation surface treatments as described herein. Typically, the surfactants used contain a lipophilic nonpolar hydrocarbon group and a polar functional hydrophilic group. The polar functional group can be a carboxylate, ester, amine, amide, imide, hydroxyl, ether, nitrile, phosphate, sulfate, or sulfonate. The surfactants can be used alone or in combination. Accordingly, a combination of surfactants can include anionic, cationic, nonionic, zwitterionic, amphoteric, and ampholytic surfactants, so long as there is a net positive or negative charge in the head regions of the population of surfactant molecules. In some instances, a single negatively charged or positively charged surfactant is used in the preparation of the present electrode compositions.

A surfactant used in preparation of the present electrode compositions can be anionic, including, but not limited to, sulfonates such as alkyl sulfonates, alkylbenzene sulfonates, alpha olefin sulfonates, paraffin sulfonates, and alkyl ester sulfonates; sulfates such as alkyl sulfates, alkyl alkoxy sulfates, and alkyl alkoxylated sulfates; phosphates such as monoalkyl phosphates and dialkyl phosphates; phosphonates; carboxylates such as fatty acids, alkyl alkoxy carboxylates, sarcosinates, isethionates, and taurates. Specific examples of carboxylates are sodium oleate, sodium cocoyl isethionate, sodium methyl oleoyl taurate, sodium laureth carboxylate, sodium trideceth carboxylate, sodium lauryl sarcosinate, lauroyl sarcosine, and cocoyl sarcosinate. Specific examples of sulfates include sodium dodecyl sulfate (SDS), sodium lauryl sulfate, sodium laureth sulfate, sodium trideceth sulfate, sodium tridecyl sulfate, sodium cocyl sulfate, and lauric monoglyceride sodium sulfate.

Suitable sulfonate surfactants include, but are not limited to, alkyl sulfonates, aryl sulfonates, monoalkyl and dialkyl sulfosuccinates, and monoalkyl and dialkyl sulfosuccinamates. Each alkyl group independently contains about two to twenty carbons and can also be ethoxylated with up to about 8 units, preferably up to about 6 units, on average, for example, 2, 3, or 4 units, of ethylene oxide, per each alkyl group. Illustrative examples of alky and aryl sulfonates are sodium tridecyl benzene sulfonate (STBS) and sodium dodecylbenzene sulfonate (SDBS).

Illustrative examples of sulfosuccinates include, but are not limited to, dimethicone copolyol sulfosuccinate, diamyl sulfosuccinate, dicapryl sulfosuccinate, dicyclohexyl sulfosuccinate, diheptyl sulfosuccinate, dihexyl sulfosuccinate, diisobutyl sulfosuccinate, dioctyl sulfosuccinate, C12-15 pareth sulfosuccinate, cetearyl sulfosuccinate, cocopolyglucose sulfosuccinate, cocoyl butyl gluceth-10 sulfosuccinate, deceth-5 sulfosuccinate, deceth-6 sulfosuccinate, dihydroxyethyl sulfosuccinylundecylenate, hydrogenated cottonseed glyceride sulfosuccinate, isodecyl sulfosuccinate, isostearyl sulfosuccinate, laneth-5 sulfosuccinate, laureth sulfosuccinate, laureth-12 sulfosuccinate, laureth-6 sulfosuccinate, laureth-9 sulfosuccinate, lauryl sulfosuccinate, nonoxynol-10 sulfosuccinate, oleth-3 sulfosuccinate, oleyl sulfosuccinate, PEG-10 laurylcitrate sulfosuccinate, sitosereth-14 sulfosuccinate, stearyl sulfosuccinate, tallow, tridecyl sulfosuccinate, ditridecyl sulfosuccinate, bisglycol ricinosulfosuccinate, di(1,3-di-methylbutyl)sulfosuccinate, and silicone copolyol sulfosuccinates.

Illustrative examples of sulfosuccinamates include, but are not limited to, lauramido-MEA sulfosuccinate, oleamido PEG-2 sulfosuccinate, cocamido MIPA-sulfosuccinate, cocamido PEG-3 sulfosuccinate, isostearamido MEA-sulfosuccinate, isostearamido MIPA-sulfosuccinate, lauramido MEA-sulfosuccinate, lauramido PEG-2 sulfosuccinate, lauramido PEG-5 sulfosuccinate, myristamido MEA-sulfosuccinate, oleamido MEA-sulfosuccinate, oleamido PIPA-sulfosuccinate, oleamido PEG-2 sulfosuccinate, palmitamido PEG-2 sulfosuccinate, palmitoleamido PEG-2 sulfosuccinate, PEG-4 cocamido MIPA-sulfosuccinate, ricinoleamido MEA-sulfosuccinate, stearamido MEA-sulfosuccinate, stearyl sulfosuccinamate, tallamido MEA-sulfosuccinate, tallow sulfosuccinamate, tallowamido MEA-sulfosuccinate, undecylenamido MEA-sulfosuccinate, undecylenamido PEG-2 sulfosuccinate, wheat germamido MEA-sulfosuccinate, and wheat germamido PEG-2 sulfosuccinate.

Some examples of commercial sulfonates are AEROSOL® OT-S, AEROSOL® OT-MSO, AEROSOL® TR70% (Cytec Inc., West Paterson, N.J.), NaSul CA-HT3 (King Industries, Norwalk, Conn.), and C500 (Crompton Co., West Hill, Ontario, Canada). AEROSOL® OT-S is sodium dioctyl sulfosuccinate in petroleum distillate. AEROSOL® OT-MSO also contains sodium dioctyl sulfosuccinate. AEROSOL® TR70% is sodium bistridecyl sulfosuccinate in mixture of ethanol and water. NaSul CA-HT3 is calcium dinonylnaphthalene sulfonate/carboxylate complex. C500 is an oil soluble calcium sulfonate.

Alkyl or alkyl groups refers to saturated hydrocarbons having one or more carbon atoms, including straight-chain alkyl groups (for example, methyl, ethyl, propyl, butyl, pentyl, hexyl, heptyl, octyl, nonyl, decyl, and so on), cyclic alkyl groups (or cycloalkyl or alicyclic or carbocyclic groups) (for example, cyclopropyl, cyclopentyl, cyclohexyl, cycloheptyl, cyclooctyl, and so on), branched-chain alkyl groups (for example, isopropyl, tert-butyl, sec-butyl, isobutyl, and so on), and alkyl-substituted alkyl groups (for example, alkyl-substituted cycloalkyl groups and cycloalkyl-substituted alkyl groups).

Alkyl can include both unsubstituted alkyls and substituted alkyls. Substituted alkyls refers to alkyl groups having substituents replacing one or more hydrogens on one or more carbons of the hydrocarbon backbone. Such substituents can include, alkenyl, alkynyl, halogeno, hydroxyl, alkylcarbonyloxy, arylcarbonyloxy, alkoxycarbonyloxy, aryloxy, aryloxycarbonyloxy, carboxylate, alkylcarbonyl, arylcarbonyl, alkoxycarbonyl, aminocarbonyl, alkylaminocarbonyl, dialkylaminocarbonyl, alkylthiocarbonyl, alkoxyl, phosphate, phosphonato, phosphinato, cyano, amino (including alkyl amino, dialkylamino, arylamino, diarylamino and alkylarylamino), acylamino (including alkylcarbonylamino, arylcarbonylamino, carbamoyl and ureido), imino, sulfhydryl, alkylthio, arylthio, thiocarboxylate, sulfates, alkylsulfinyl, sulfonates, sulfamoyl, sulfonamido, nitro, trifluoromethyl, cyano, azido, heterocyclic, alkylaryl or aromatic (including heteroaromatic) groups.

In some embodiments, substituted alkyls can include a heterocyclic group. Heterocyclic groups include closed ring structures analogous to carbocyclic groups in which one or more of the carbon atoms in the ring is an element other than carbon, for example, nitrogen, sulfur or oxygen. Heterocyclic groups can be saturated or unsaturated. Exemplary heterocyclic groups include, aziridine, ethylene oxide (epoxides, oxiranes), thiirane (episulfides), dioxirane, azetidine, oxetane, thietane, dioxetane, dithietane, dithiete, azolidine, pyrrolidine, pyrroline, oxolane, dihydrofuran and furan.

For an anionic surfactant, the counter ion is typically sodium but can alternatively be potassium, lithium, calcium, magnesium, ammonium, amines (primary, secondary, tertiary or quandary) or other organic bases. Exemplary amines include isopropylamine, ethanolamine, diethanolamine, and triethanolamine. Mixtures of the above cations can also be used.

A surfactant used in preparation of the present materials can be cationic. Such cationic surfactants include, but are not limited to, pyridinium-containing compounds, and primary, secondary tertiary or quaternary organic amines. For a cationic surfactant, the counter ion can be, for example, chloride, bromide, methosulfate, ethosulfate, lactate, saccharinate, acetate and phosphate. Examples of cationic amines include polyethoxylated oleyl/stearyl amine, ethoxylated tallow amine, cocoalkylamine, oleylamine and tallow alkyl amine, as well as mixtures thereof.

Examples of quaternary amines with a single long alkyl group are cetyltrimethyl ammonium bromide (CTAB), benzyldodecyldimethylammonium bromide (BddaBr), benzyldimethylhexadecylammonium chloride (BdhaCl), dodecyltrimethylammonium bromide, myristyl trimethyl ammonium bromide, stearyl dimethyl benzyl ammonium chloride, oleyl dimethyl benzyl ammonium chloride, lauryl trimethyl ammonium methosulfate (also known as cocotrimonium methosulfate), cetyl-dimethyl hydroxyethyl ammonium dihydrogen phosphate, bassuamidopropylkonium chloride, cocotrimonium chloride, distearyldimonium chloride, wheat germ-amidopropalkonium chloride, stearyl octyidimonium methosulfate, isostearaminopropal-konium chloride, dihydroxypropyl PEG-5 linoleammonium chloride, PEG-2 stearmonium chloride, behentrimonium chloride, dicetyl dimonium chloride, tallow trimonium chloride and behenamidopropyl ethyl dimonium ethosulfate.

Examples of quaternary amines with two long alkyl groups are didodecyldimethylammonium bromide (DDAB), distearyldimonium chloride, dicetyl dimonium chloride, stearyl octyldimonium methosulfate, dihydrogenated palmoylethyl hydroxyethylmonium methosulfate, dipalmitoylethyl hydroxyethylmonium methosulfate, dioleoylethyl hydroxyethylmonium methosulfate, and hydroxypropyl bisstearyldimonium chloride.

Quaternary ammonium compounds of imidazoline derivatives include, for example, isostearyl benzylimidonium chloride, cocoyl benzyl hydroxyethyl imidazolinium chloride, cocoyl hydroxyethylimidazolinium PG-chloride phosphate, and stearyl hydroxyethylimidonium chloride. Other heterocyclic quaternary ammonium compounds, such as dodecylpyridinium chloride, amprolium hydrochloride (AH), and benzethonium hydrochloride (BH) can also be used.

A surfactant used in preparation of the present materials can be nonionic, including, but not limited to, polyalkylene oxide carboxylic acid esters, fatty acid esters, fatty alcohols, ethoxylated fatty alcohols, poloxamers, alkanolamides, alkoxylated alkanolamides, polyethylene glycol monoalkyl ether, and alkyl polysaccharides. Polyalkylene oxide carboxylic acid esters have one or two carboxylic ester moieties each with about 8 to 20 carbons and a polyalkylene oxide moiety containing about 5 to 200 alkylene oxide units. An ethoxylated fatty alcohol contains an ethylene oxide moiety containing about 5 to 150 ethylene oxide units and a fatty alcohol moiety with about 6 to about 30 carbons. The fatty alcohol moiety can be cyclic, straight, or branched, and saturated or unsaturated. Some examples of ethoxylated fatty alcohols include ethylene glycol ethers of oleth alcohol, steareth alcohol, lauryl alcohol and isocetyl alcohol. Poloxamers are ethylene oxide and propylene oxide block copolymers, having from about 15 to about 100 moles of ethylene oxide. Alkyl polysaccharide (“APS”) surfactants (for example, alkyl polyglycosides) contain a hydrophobic group with about 6 to about 30 carbons and a polysaccharide (for example, polyglycoside) as the hydrophilic group. An example of commercial nonionic surfactant is FOA-5 (Octel Starreon LLC., Littleton, Colo.).

Specific examples of suitable nonionic surfactants include alkanolamides such as cocamide diethanolamide (“DEA”), cocamide monoethanolamide (“MEA”), cocamide monoisopropanolamide (“MIPA”), PEG-5 cocamide MEA, lauramide DEA, and lauramide MEA; alkyl amine oxides such as lauramine oxide, cocamine oxide, cocamidopropylamine oxide, and lauramidopropylamine oxide; sorbitan laurate, sorbitan distearate, fatty acids or fatty acid esters such as lauric acid, isostearic acid, and PEG-150 distearate; fatty alcohols or ethoxylated fatty alcohols such as lauryl alcohol, alkylpolyglucosides such as decyl glucoside, lauryl glucoside, and coco glucoside.

A surfactant used in preparation of the present materials can be zwitterionic, having both a formal positive and negative charge on the same molecule. The positive charge group can be quaternary ammonium, phosphonium, or sulfonium, whereas the negative charge group can be carboxylate, sulfonate, sulfate, phosphate or phosphonate. Similar to other classes of surfactants, the hydrophobic moiety can contain one or more long, straight, cyclic, or branched, aliphatic chains of about 8 to 18 carbon atoms. Specific examples of zwitterionic surfactants include alkyl betaines such as cocodimethyl carboxymethyl betaine, lauryl dimethyl carboxymethyl betaine, lauryl dimethyl alpha-carboxyethyl betaine, cetyl dimethyl carboxymethyl betaine, lauryl bis-(2-hydroxyethyl)carboxy methyl betaine, stearyl bis-(2-hydroxypropyl)carboxymethyl betaine, oleyl dimethyl gamma-carboxypropyl betaine, and lauryl bis-(2-hydroxypropyl)alphacarboxy-ethyl betaine, amidopropyl betaines; and alkyl sultaines such as cocodimethyl sulfopropyl betaine, stearyidimethyl sulfopropyl betaine, lauryl dimethyl sulfoethyl betaine, lauryl bis-(2-hydroxyethyl)sulfopropyl betaine, and alkylamidopropylhydroxy sultaines.

A surfactant used in preparation of the present materials can be amphoteric. Examples of suitable amphoteric surfactants include ammonium or substituted ammonium salts of alkyl amphocarboxy glycinates and alkyl amphocarboxypropionates, alkyl amphodipropionates, alkyl amphodiacetates, alkyl amphoglycinates, and alkyl amphopropionates, as well as alkyl iminopropionates, alkyl iminodipropionates, and alkyl amphopropylsulfonates. Specific examples are cocoamphoacetate, cocoamphopropionate, cocoamphodiacetate, lauroamphoacetate, lauroamphodiacetate, lauroamphodipropionate, lauroamphodiacetate, cocoamphopropyl sulfonate, caproamphodiacetate, caproamphoacetate, caproamphodipropionate, and stearoamphoacetate.

A surfactant used in preparation of the present materials can also be a polymer such as N-substituted polyisobutenyl succinimides and succinates, alkyl methacrylate vinyl pyrrolidinone copolymers, alkyl methacrylate-dialkylaminoethyl methacrylate copolymers, alkylmethacrylate polyethylene glycol methacrylate copolymers, polystearamides, and polyethylenimine.

A surfactant used in preparation of the present materials can also be a polysorbate type nonionic surfactant such as polyoxyethylene (20) sorbitan monolaurate (Polysorbate 20), polyoxyethylene (20) sorbitan monopalmitate (Polysorbate 40), polyoxyethylene (20) sorbitan monostearate (Polysorbate 60) or polyoxyethylene (20) sorbitan monooleate (Polysorbate 80).

A surfactant used in preparation of the present materials can be an oil-based dispersant, which includes alkylsuccinimide, succinate esters, high molecular weight amines, and Mannich base and phosphoric acid derivatives. Some specific examples are polyisobutenyl succinimide-polyethylenepolyamine, polyisobutenyl succinic ester, polyisobutenyl hydroxybenzyl-polyethylenepolyamine, and bis-hydroxypropyl phosphorate.

The surfactant used in preparation of the present materials can be a combination of two or more surfactants of the same or different types selected from the group consisting of anionic, cationic, nonionic, zwitterionic, amphoteric and ampholytic surfactants. Suitable examples of a combination of two or more surfactants of the same type include, but are not limited to, a mixture of two anionic surfactants, a mixture of three anionic surfactants, a mixture of four anionic surfactants, a mixture of two cationic surfactants, a mixture of three cationic surfactants, a mixture of four cationic surfactants, a mixture of two nonionic surfactants, a mixture of three nonionic surfactants, a mixture of four nonionic surfactants, a mixture of two zwitterionic surfactants, a mixture of three zwitterionic surfactants, a mixture of four zwitterionic surfactants, a mixture of two amphoteric surfactants, a mixture of three amphoteric surfactants, a mixture of four amphoteric surfactants, a mixture of two ampholytic surfactants, a mixture of three ampholytic surfactants, and a mixture of four ampholytic surfactants.

### Polymeric Particles

The techniques described above include the use of polymers to form a surface treatment 201 on high aspect ratio carbon nanotubes in order to promote adhesion with the active material particles 300. While several advantageously suitable polymers have been described, it is to be understood that other polymer material may be used, including the following.

The polymer used in preparation of the present materials can be polymer material such a water processable polymer material and/or an alcohol processable polymer material. In various embodiments any of the follow polymers (and combinations thereof) may be used: polyacrilic acid (PAA), poly(vinyl alcohol) (PVA), poly(vinyl acetate) (PVAc), polyacrylonitrile (PAN), polyisoprene (PIpr), polyaniline (PANi), polyethylene (PE), polyimide (PI), polystyrene (PS), polyurethane (PU), polyvinyl butyral (PVB), polyvinyl pyrrolidone (PVP). In some embodiments. Another exemplary polymer material is fluorine acrylic hybrid Latex (TRD202A), and is supplied by JSR Corporation.

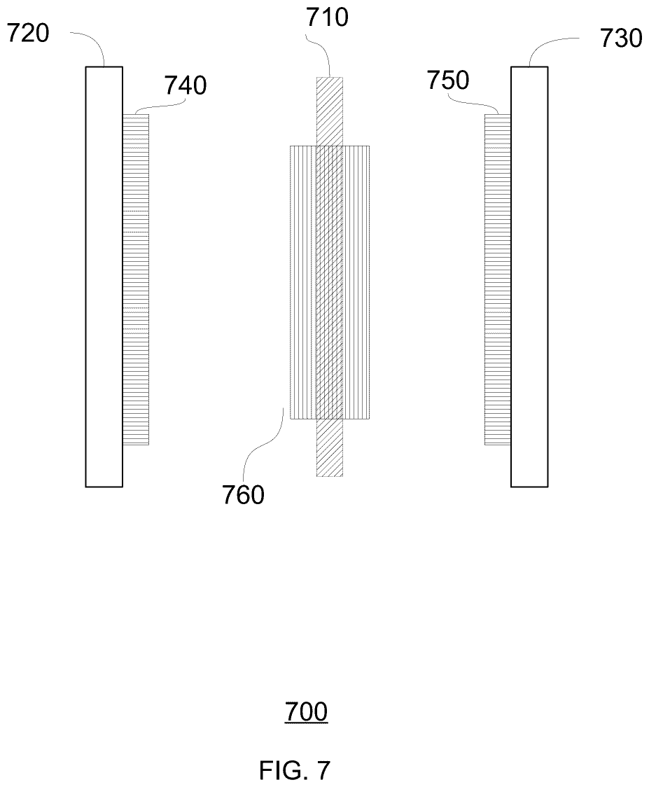

FIG. 7 shows a schematic of a pouch cell battery.

According to various embodiments, the teachings herein provide electrodes that do not have PVDF binders in cathodes, or other conventional binders in anodes. Instead, as detailed above a 3D carbon scaffold or matrix holds active material particles together to form a cohesive layer that is also strongly attached to the metallic current collector. Such active material structure is created during slurry preparation and subsequently in a roll to roll (“R2R”) coating and drying process. One of the main advantages of this technology is its scalability and “drop-in” nature because various embodiments are compatible with conventional electrode manufacturing processes.

The 3D carbon matrix is formed during a slurry preparation using the techniques described herein: high aspect ratio carbon materials are properly dispersed and chemically functionalized using, e.g., a 2-step slurry preparation process (such as the type described above with reference to process 600 of FIG. 6). The chemical functionalization is designed to form an organized self-assembled structure with the surface of active material particles, e.g. NMC particles for use in a cathode or silicon particles (“Si”) or Silicon Oxide (“SiOx”) particles in the case of an anode. The so formed slurry may be based on water and/or alcohol solvents for cathodes and water for anodes, and such solvents are very easily evaporated and handled during the manufacturing process. Electrostatic interactions promote the self-organized structure in the slurry, and after the drying process the bonding between the so formed carbon matrix with active material particles and the surface of the current collector is promoted by the surface treatment (e.g., functional groups on the matrix) as well as the strong entanglement of the active material in the carbon matrix.

As will be understood by one skilled in the art, the mechanical properties of the electrodes can be readily modified depending on the application, and the mass loading requirements by tuning the surface functionalization vs. entanglement effect.

After coating and drying, the electrodes undergo a calendaring step to control the density and porosity of the active material. In NMC cathode electrodes, densities of 3.5 g/cc or more and 20% porosity or more can be achieved. Depending on mass loading and LIB cell requirements the porosity can be optimized. As for SiOx/Si anodes, the porosity is specifically controlled to accommodate active material expansion during the lithiation process.

In some typical applications, the teachings herein may provide a reduction in $/kWh of up to 20%. By using friendly solvents that are easily evaporated, the electrode throughput is higher, and more importantly, the energy consumption from the long driers is significantly reduced. The conventional NMP recovery systems are also much simplified when alcohol or other solvent mixtures are used.

The teachings herein provide a 3D matrix that dramatically boosts electrode conductivity by a factor of 10× to 100× compared to electrodes using conventional binders such as PVDF, which enables fast charging at a battery level. Thick electrode coatings in cathode up to 150 μm per side (or more) of current collector are possible with this technology. The solvents used in the slurry in combination with a strong 3D carbon matrix are designed to achieve thick wet coatings without cracking during the drying step. Thick cathodes with high capacity anodes are what enable a substantial jump in energy density reaching 400 Wh/kg or more.

Fast charging is achieved by combining high capacity anodes that are lithiated through an alloying process (Si/SiOx) and by reducing the overall impedance of the cell when combining anodes and cathodes as described herein. The teachings herein provide fast charging by having highly conductive electrodes, and in particular highly conductive cathode electrodes.

One exemplary embodiments includes a Li-ion battery energy storage devices in a pouch cell format that combines Ni-rich NMC active material in the cathodes and SiOx and graphite blend active material in the anodes, where both anodes and cathodes are made using a 3D carbon matrix process as described herein.

A schematic of the electrode arrangement pouch cell devices is shown in FIG. 7. As shown, a double-sided cathode 700 using cathode layers 760 (e.g., active layers according to various embodiments disclosed herein) on opposing sides of an aluminum foil current collector 710 are disposed between two single sided anodes 720 and 730 each having an anode layer 740 and 750 (e.g., an active layer comprising a network of carbon elements such as disclosed herein) disposed on a copper foil current collector. The electrodes are be separated by permeable separator material (not shown) wetted with electrolyte (not shown). The arrangement can be housed in a pouch cell of the type well known in the art.

These devices may feature high mass loading of Ni-rich NMC cathode electrodes and their manufacturing method: mass loading=20-30 mg/cm², specific capacity>210 mAh/g. SiOx/Graphite anode (SiOx content=˜20 wt. %) based electrodes and their material synthesis and manufacturing method: mass loading 8-14 mg/cm², reversible specific capacity≥550 mAh/g. Long life performance specially for SiOx/Graphite anode based Li-ion based electrolyte for battery: from −30 to 60° C. High-energy, high-power density, and long cycle life Ni-rich NMC cathode/SiOx+Graphite/Carbon+based Li-ion battery pouch cells: capacity≥5 Ah, Specific Energy≥300 Wh/kg, Energy Density≥800 Wh/L, with a cycle life of more than 500 cycles under 1C-Rate charge-discharge, and ultra-high-power fast charge-discharge C-Rate (Up to 5C-Rate) capabilities.

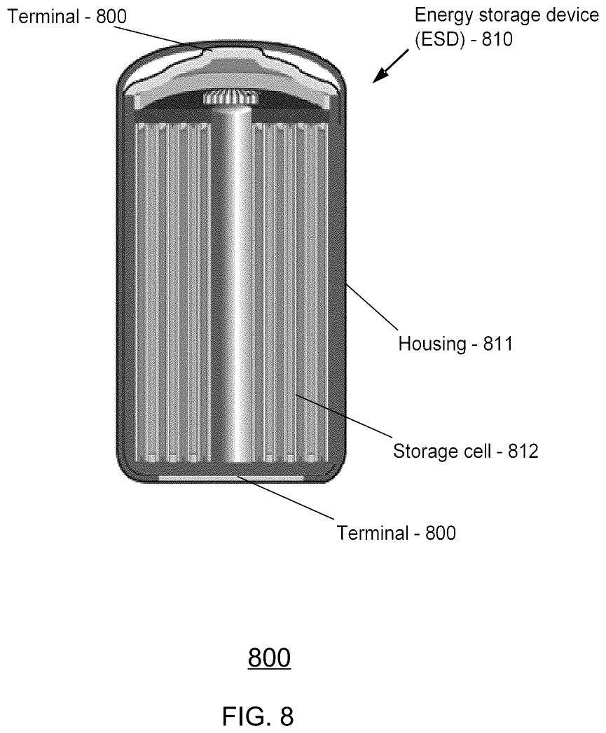

FIG. 8 is a schematic cutaway diagram depicting aspects of an energy storage device (ESD).

Generally, examples of energy storage device (ESD) disclosed herein are illustrative. That is, the energy storage device (ESD) is not limited to the embodiments disclosed herein.

More specific examples of energy storage device (ESD) include supercapacitors such as double-layer capacitors (devices storing charge electrostatically), psuedocapacitors (which store charge electrochemically) and hybrid capacitors (which store charge electrostatically and electrochemically). Generally, electrostatic double-layer capacitors (EDLCs) use carbon electrodes or derivatives with much higher electrostatic double-layer capacitance than electrochemical pseudocapacitance, achieving separation of charge in a Helmholtz double layer at the interface between the surface of a conductive electrode and an electrolyte. Generally, electrochemical pseudocapacitors use metal oxide or conducting polymer electrodes with a high amount of electrochemical pseudocapacitance additional to the double-layer capacitance. Pseudocapacitance is achieved by Faradaic electron charge-transfer with redox reactions, intercalation or electrosorption. Hybrid capacitors, such as the lithium-ion capacitor, use electrodes with differing characteristics: one exhibiting mostly electrostatic capacitance and the other mostly electrochemical capacitance.

Other examples of energy storage devices (ESD) include rechargeable batteries, storage batteries, or secondary cells which are a type of electrical battery that can be charged, discharged into a load, and recharged many times. During charging, the positive active material is oxidized, producing electrons, and the negative material is reduced, consuming electrons. These electrons constitute the current flow from the external circuit. Generally, the electrolyte serves as a buffer for internal ion flow between the electrodes (e.g., anode and cathode). Battery charging and discharging rates are often discussed by referencing a “C” rate of current. The C rate is that which would theoretically fully charge or discharge the battery in one hour. “Depth of discharge” (DOD) is normally stated as a percentage of the nominal ampere-hour capacity. For example, zero percent (0%) DOD means no discharge.

In FIG. 8, a cross section of an energy storage device (ESD) 810 is shown. The energy storage device (ESD) 810 includes a housing 811. The housing 811 has two terminals 800 disposed on an exterior thereof. The terminals 800 provide for internal electrical connection to a storage cell 812 contained within the housing 811 and for external electrical connection to an external device such as a load or charging device (not shown).

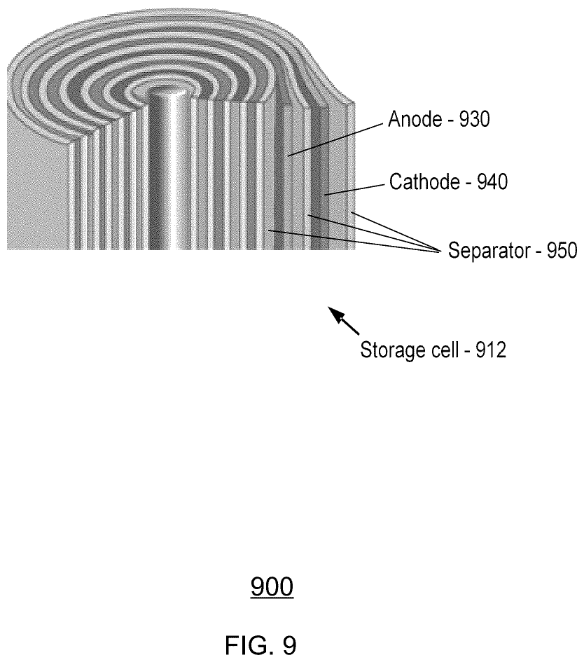

FIG. 9 is a schematic cutaway diagram depicting aspects of a prior art storage cell of the energy storage device (ESD) of FIG. 8.

A cutaway portion of the storage cell 12 is depicted in FIG. 9. As shown in this illustration, the storage cell 912 includes a multi-layer roll of energy storage materials. That is, sheets or strips of energy storage materials are rolled together into a roll format. The roll of energy storage materials include opposing electrodes referred to as an “anode 930” and as a “cathode 940.” The anode 930 and the cathode 940 are separated by a separator 950. Not shown in the illustration but included as a part of the storage cell 912 is an electrolyte. Generally, the electrolyte permeates or wets the cathode 940 and the anode 930 and facilitates migration of ions within the storage cell 912. According to various embodiments, cathode 940 correspond to, or is similar to, electrode 100 of FIG. 1A, or electrode 125 of FIG. 1B. In some embodiments, cathode 940 corresponds to an electrode comprising the network of high aspect ratio carbon elements disclosed herein and/or the polymeric additive disclosed herein.

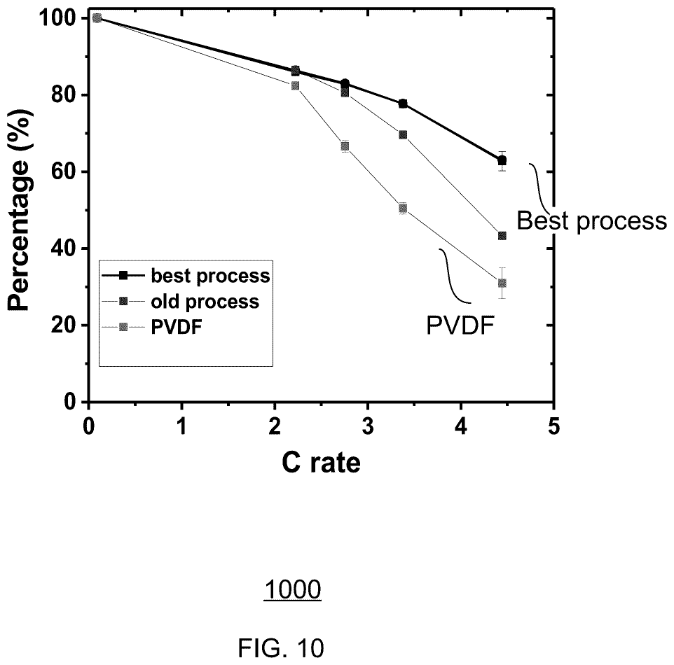

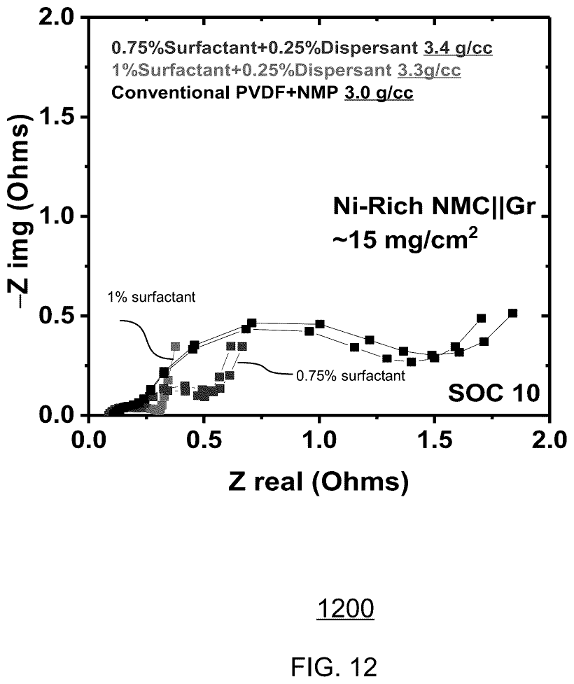

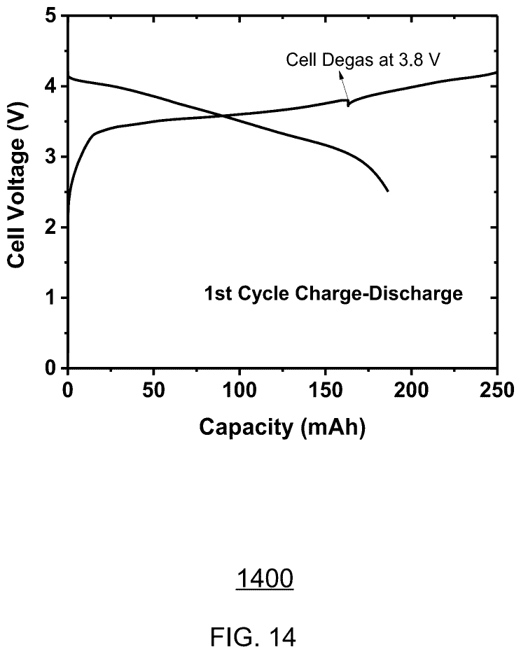

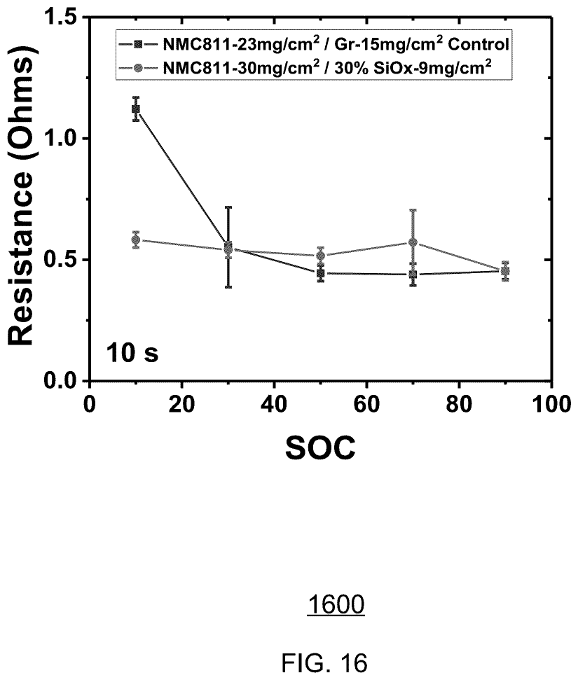

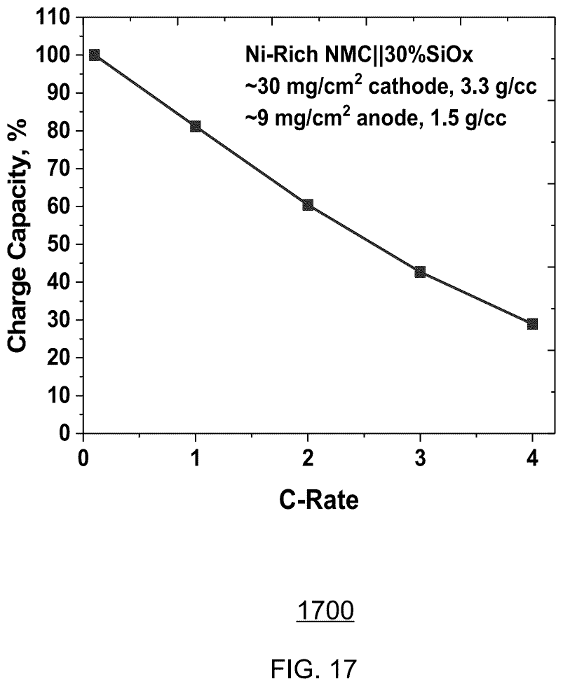

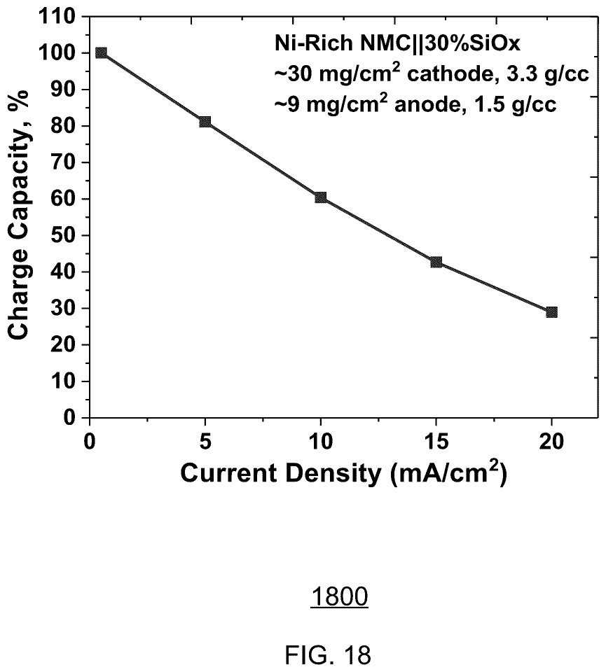

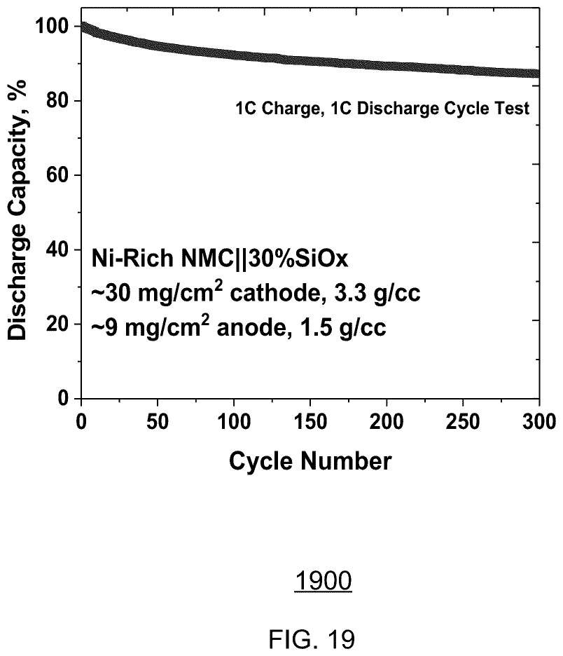

FIGS. 10-19 are graphs depicting aspects of electrical performance of energy storage cells assembled according to various embodiments.

FIG. 10 is a graph depicting is C rate for a half-cell constructed according to the teachings herein. The half-cell included areal loading of NCM active material that was 22.5 mg/cm². In this example, the “best process” curve represents binder-free electrodes fabricated according to the teachings herein. The “old process” curve represents binder-free electrodes fabricated without these surfactants and dispersants disclosed herein. The “PVDF” curve represents performance for cells using electrodes fabricated with prior art technology. In this example, the half-cell was of pouch cell construction. Initial specific and C-Rate test results at provided in the table below. The working electrode size was 45×45 mm, Li counter electrode 46×46 mm. Electrolyte was 1M LiPF6 in EC/DMC (1/1 by vol)+1% VC.

Data for FIG. 10

| | | Initial | |
|---|---|---|---|
| | | Discharge | |
| Electrode Manufacturing Process | Press | Specific | |
| (~15 mg/cm²) | Density | Capacity | ICE, % |
| 1% Surfactant + 0.25% Dispersant + | 3.1 g/cc | 204 mAh/g | 98% |
| 3%-3D nano-carbon | | | |
| 1% Surfactant + 0.25% Dispersant + | 3.5 g/cc | 204 mAh/g | 98.5% |
| 3 %-3D nano-carbon | | | |
| Conventional PVDF + NMP process | 3.5 g/cc | 194 mAh/g | 94.2% |

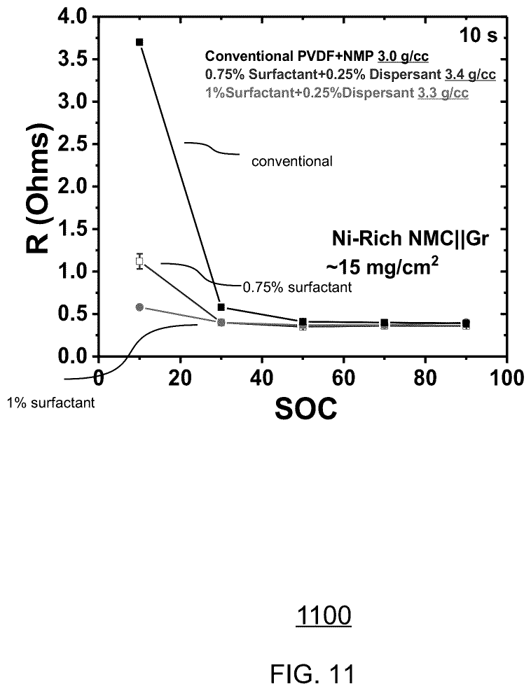

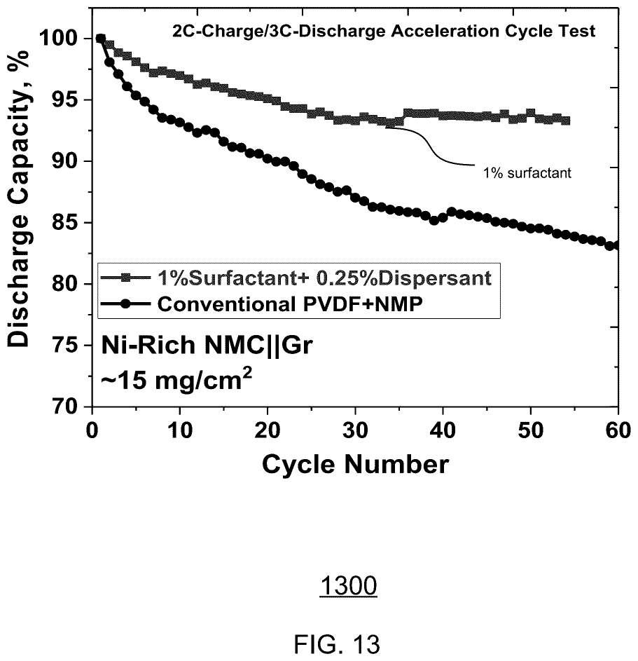

In FIG. 11, test results are shown for a full pouch cell. In this example, the cathode was Ni-rich NMC with 45×45 mm and the anode was graphite electrodes with 46×46 mm. The electrolyte was 1M LiPF6 in EC/DMC (1/1 by vol)+1% VC. N/P ratio=˜1.1. It may be seen that HPPC resistance is much lower compared with traditional PVDF process. As shown in FIG., lower charge resistance in cathodes according to the teachings herein results in improved performance at ten percent state-of-charge. FIG. 13 shows that cycling stability is improved with a cathode fabricated according to the teachings herein.

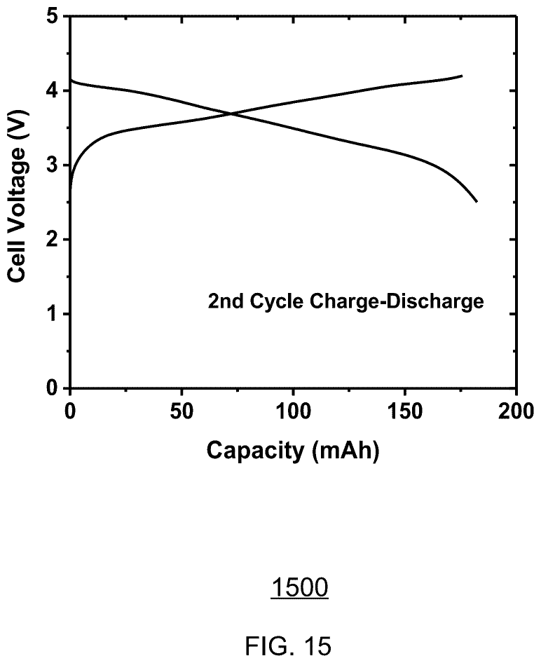

Another pouch cell was constructed for testing. In this embodiment, the cathode was Ni-rich NMC with 45×45 mm, 28-30 mg/cm² mass loading, and the anode was a combination of graphite/SiOx (45% SiOx) electrodes with 46×46 mm, 8-9 mg/cm² mass loading. The electrolyte was 1.1M LiPF6 in PC:FEC:EMC:DEC=20:10:50:20. N/P ratio=˜1.04 to 1.10. Both NMC cathode and 45% SiOx anode electrode manufacturing process were used with the process set forth herein and use a hybrid surfactant and dispersant combined with 3D nano-carbon matrix (e.g., a NX electrode). The Li-ion battery full cell specific energy was about 332 Wh/kg with 90% pouch cell package efficiency, and 351 Wh/kg if the package efficiency increases to 95%. The energy density was about 808 Wh/L with 90% pouch cell package efficiency and 10% pouch cell volume expansions, and the energy density was about 853 Wh/L with 95% pouch cell package efficiency and 10% pouch cell volume expansions. The initial 1st cycle charge specific capacity of the cathode and anode based on claimed electrode manufacturing process was about 228 mAh/g and 852 mAh/g; the initial 1st cycle discharge specific capacity of the cathode and anode based on claimed electrode manufacturing process was about 210 mAh/g and 750 mAh/g. LiB full cell capacity in this example is 1st charge capacity 240 mAh, and 1st discharge capacity 216 mAh from 4.2 to 2.5 V under 0.1C-Rate constant current charge-discharge. The initial coulombic efficiency is about ˜90%. Aspects of this data and electrical performance for this cell are set forth in FIGS. 15-19.

Example properties of a cell using the resulting electrodes are set forth in the table below. Further, the exemplary cell did not exhibit cracking or stress as may commonly arise with some physical tests.

| Cell NX NMC811 \|\| 45%SiOx-2 | Cathode | Anode | Unit |
|---|---|---|---|
| Active Layer Weight | 1.194 | 0.344 | g |
| Al Foil weight | 0.086 | | g |
| Cu Foil weight | | 0.173 | g |
| Active Layer Thickness | 0.168 | 0.13 | mm |
| Porosity | 18.30% | 25.00% | |
| Al Foil Thickness | 0.015 | | mm |
| Cu Foil Thickness | | 0.008 | mm |
| Electrolyte weight in electrodes | 0.07470792 | 0.082524 | g |
| Separator weight | 0.033 | | g |
| Separator thickness | 0.04 | | mm |
| Electrolyte weight in separator | 0.05517792 | | g |
| Total cell weight | 2.04240984 | | g |
| Total cell volume | 0.763876 | | mL |
| First Discharge Energy from 4.2 | 0.7548 | | Wh |
| to 2.5 V | | | |
| Energy Density without packaging | 369.5634369 | | Wh/kg |
| Energy Density with packaging | 332.6070932 | | Wh/kg |
| (90% packaging efficiency) | | | |
| Energy Density with packaging | 351.085265 | | Wh/kg |
| (95% packaging efficiency) | | | |
| Energy Density without packaging | 988.1184904 | | Wh/L |
| Energy Density with packaging | 899.1878263 | | Wh/L |
| (91% packaging efficiency) | | | |
| Energy Density with packaging | 948.5937508 | | Wh/L |
| (96% packaging efficiency) | | | |
| Energy Density with packaging | 862.3579553 | | Wh/L |
| (96% packaging efficiency) | | | |
| and 10% volume expansions | | | |

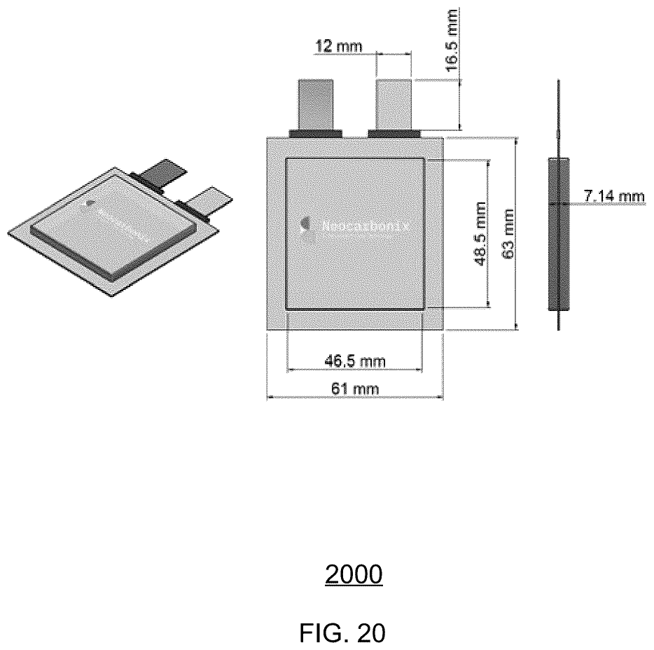

FIG. 20 illustrates an example battery cell using an example of the electrode disclosed herein (e.g., a NX electrode). The battery cell had a dimension of approximately 46.5 mm×48.5 mm×7.14 mm. The battery cell illustrated in FIG. 20 corresponds to a 1.5-3.5 Ah battery cell. The illustrated battery cell (e.g., having an NXNMC811 electrode) exhibited a 1st cycle charge specific capacity of greater than or equal to 210 mAh/g, and an areal capacity of substantially 5.6 mAh/cm².

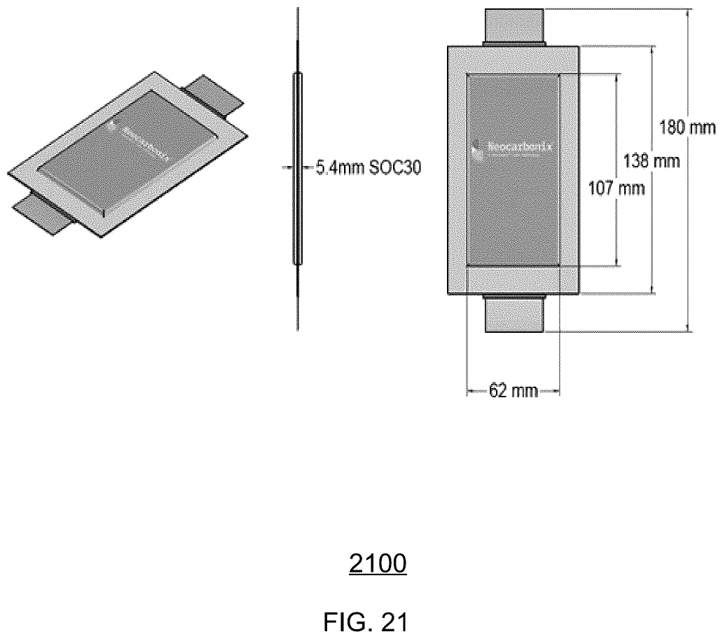

FIG. 21 illustrates an example battery cell using an example of the electrode disclosed herein (e.g., a NX electrode such as an electrode comprising a 3D nano-carbon matrix). The battery cell had a dimension of approximately 62 mm×107 mm×5.4 mm. The battery cell illustrated in FIG. 21 corresponds to a 9.0-12.0 Ah battery cell. The illustrated battery cell (e.g., having an NX NMC811 electrode) exhibited a 1st cycle charge specific capacity of greater than or equal to 1116 mAh/g, and an areal capacity of substantially 6.5 mAh/cm².

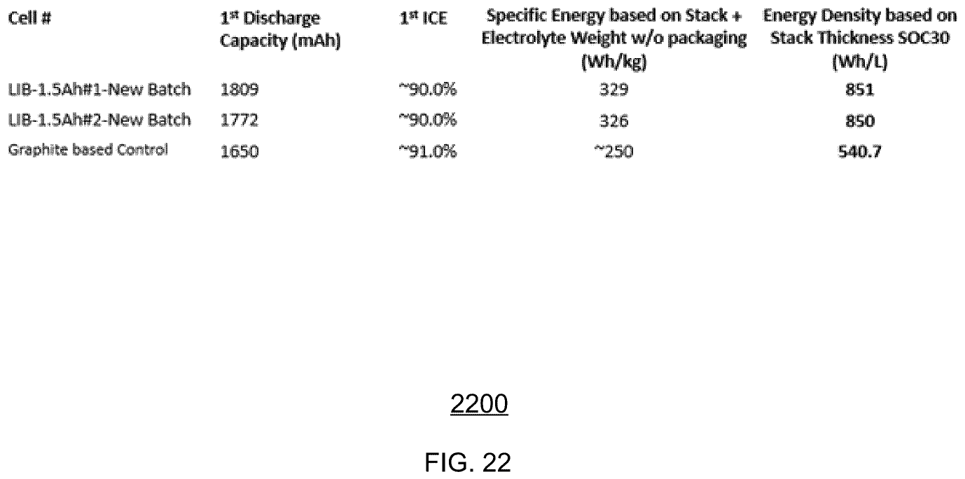

FIG. 22 illustrates a chart of properties for various examples of battery cells (e.g., pouch cells). The battery cells had a dimension of approximately 46 mm×46 mm×3 mm. The battery cell package efficiency is about ˜86% for 9 layers of a NMC811 cathode and 10 layers of a Si anode (e.g., a 1.5 Ah cell); however, the cell package efficiency may be increased to 95% efficiency in large-format pouch cells>5 Ah with more stack layers. Results show that Si anode (5.5-5.0 mg/cm²) can improve specific energy by at least 30% and energy density compared with graphite anode electrodes (16 mg/cm² to match 24 mg/cm² NX NMC811 cathode) with the same small pouch cell format and layer numbers.

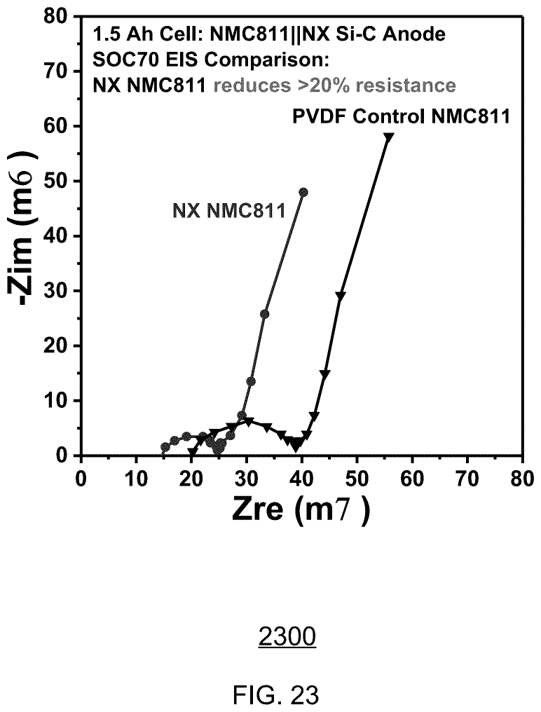

FIG. 23 illustrates a graph comparing performance of a battery cell comprising a cathode according to various embodiments compared to a control battery cell having a conventional PVDF cathode. As illustrated in FIG. 23, the use of the cathode having the 3D nano-carbon matrix (e.g., NX NMC811) reduces resistance by at least 20%.

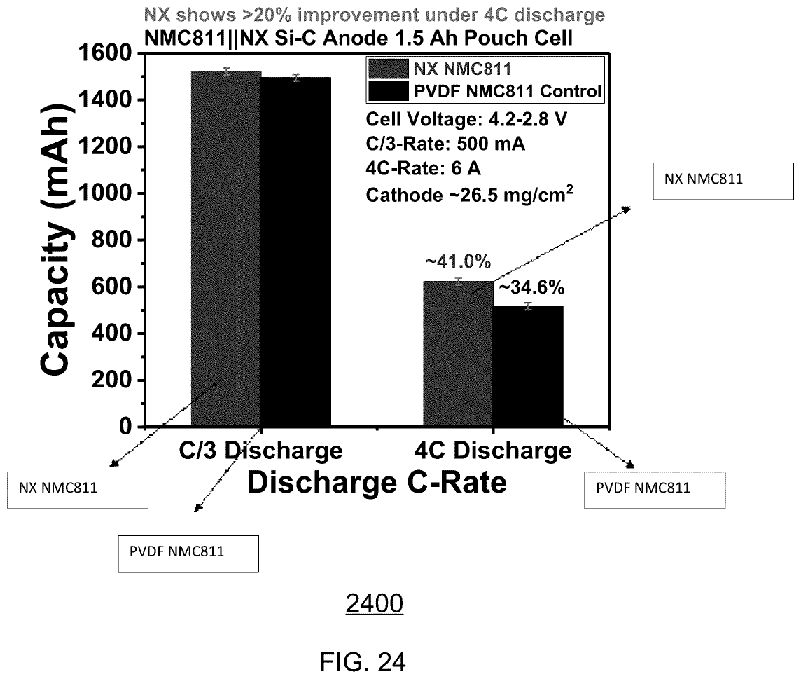

FIG. 24 illustrates a chart comparing performance of a battery cell comprising a cathode according to various embodiments compared to a control battery cell having a conventional PVDF cathode. As illustrated in FIG. 24, the use of the cathode having the 3D nano-carbon matrix (e.g., NX NMC811) reduces resistance by at least 20%.

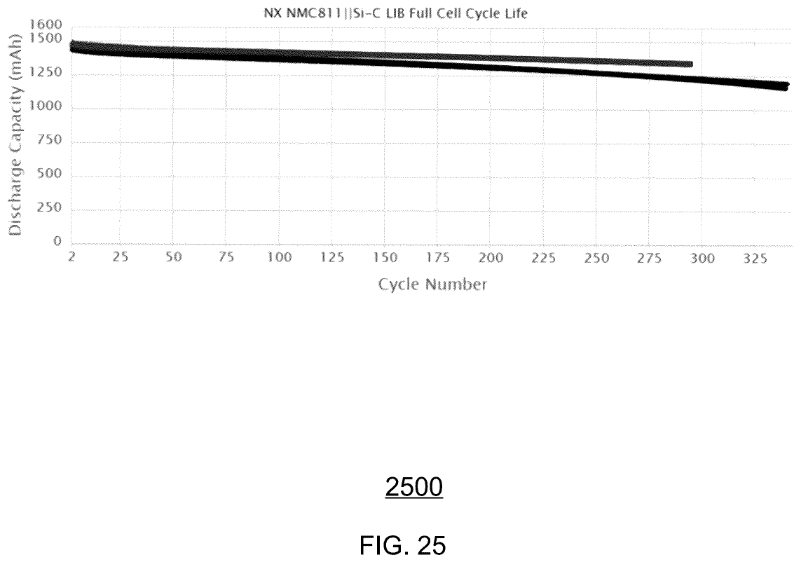

FIG. 25 illustrates a graph comparing performance of a battery cell comprising a cathode according to various embodiments compared to a control battery cell having a conventional PVDF cathode. The battery cells compared in FIG. 25 comprise a NX Si—C anode electrode (e.g., an electrode having a 3D nano-carbon matrix), are 1.5 Ah cells, and is measured according to a 1C1C cycling of 4.2-2.8V. As illustrated in FIG. 25, the use of the cathode having the 3D nano-carbon matrix (e.g., NX NMC811) has a larger discharge density, and the difference in the discharge density increases as the cycle number increases. After 250 cycles, the battery cell according to various embodiments (e.g., a battery cell having a cathode comprising a 3D nano-carbon matrix) has a discharge capacity that is at least 1275 mAh, and preferably at least 1375 mAh. After 250 cycles, the battery cell according to various embodiments (e.g., a battery cell having a cathode comprising a 3D nano-carbon matrix) has a discharge capacity that is approximately 10% greater than a control battery cell (e.g., a battery cell having a cathode comprising PVDF).

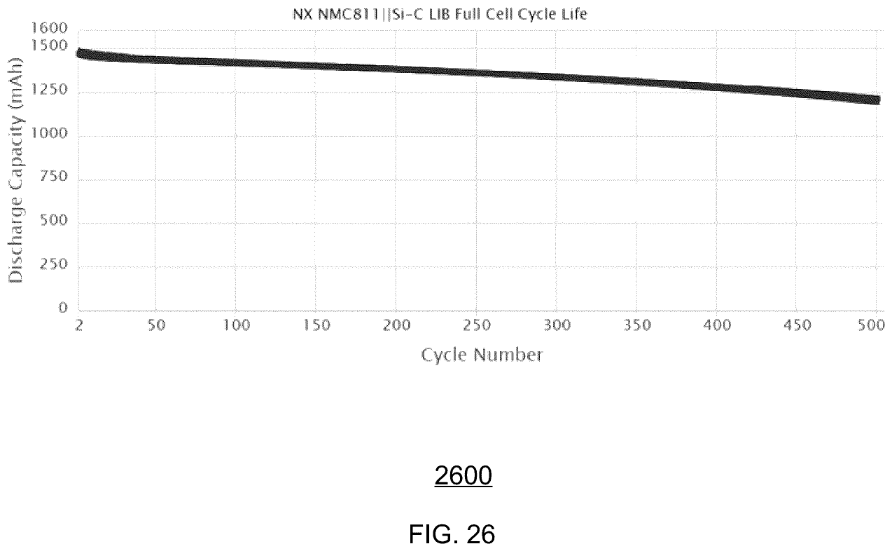

FIG. 26 illustrates a graph illustrating performance of a battery cell comprising an electrode according to various embodiments. The battery cells measured in FIG. 26 comprise a NX Si—C anode electrode (e.g., an electrode having a 3D nano-carbon matrix), a cathode according to various embodiments (e.g., a cathode having a 3D nano-carbon matrix), are 1.5 Ah cells, and is measured according to a 1C1C cycling of 4.2-2.8V. As illustrated in FIG. 26, the battery cell comprising the cathode having the 3D nano-carbon matrix (e.g., NX NMC811) has a discharge capacity retention of approximately 82.7% after 500 cycles. The battery cell comprising the cathode having the 3D nano-carbon matrix (e.g., NX NMC811) has a discharge capacity that decreases less than 300 mAh after 500 cycles.

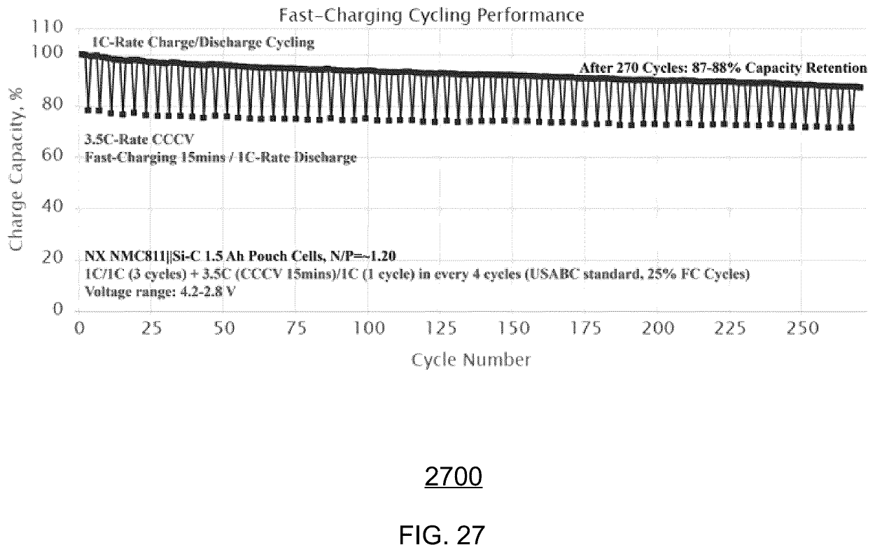

FIG. 27 illustrates a graph illustrating performance of a battery cell comprising an electrode according to various embodiments. FIG. 27 provides a graph a fast-charging cycling performance. The battery cells measured in FIG. 27 comprise a NX Si—C anode electrode (e.g., an electrode having a 3D nano-carbon matrix), a cathode according to various embodiments (e.g., a cathode having a 3D nano-carbon matrix), are 1.5 Ah cells (e.g., a pouch cell), and is measured according to a 1C/1C (3cycle)+3.5C (CCCV 15 min)/1C (1cycles) in every 4 cycles over a voltage range of 4.2-2.8V. As illustrated in FIG. 27, the battery cell comprising the cathode having the 3D nano-carbon matrix (e.g., NX NMC811) has a discharge capacity retention of at least 87% after 500 cycles. In some embodiments, the battery cell comprising the cathode having the 3D nano-carbon matrix (e.g., NX NMC811) has a discharge capacity retention of 87%-88% after 500 cycles. The battery cell comprising the cathode having the 3D nano-carbon matrix (e.g., NX NMC811) has a discharge capacity that decreases less than 300 mAh after 270 cycles.

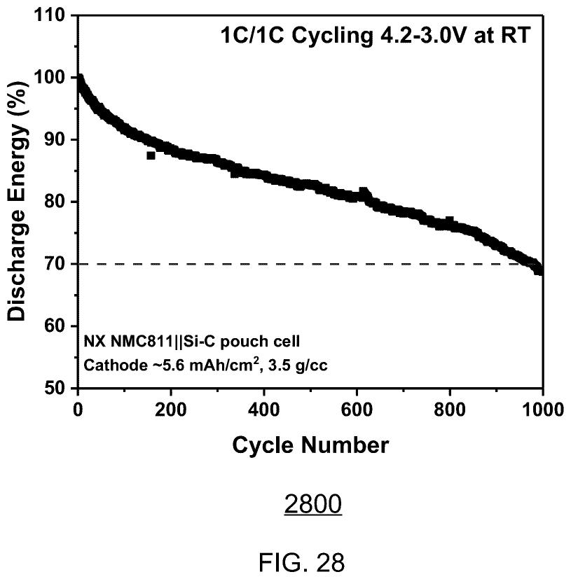

FIG. 28 illustrates a graph illustrating performance of a battery cell comprising an electrode according to various embodiments. FIG. 28 provides a graph of a discharge energy in relation to cycling. The battery cells measured in FIG. 28 comprise a NX Si—C anode electrode (e.g., an electrode having a 3D nano-carbon matrix), a cathode according to various embodiments (e.g., a cathode having a 3D nano-carbon matrix), has a cathode comprising a loading of 5.6 mAh/cm², and an electrode density of 3.5 g/cc, and is measured according to a 1C/1C cycling over a voltage range of 4.2-3.0V. As illustrated in FIG. 28, the battery cell comprising the cathode having the 3D nano-carbon matrix (e.g., NX NMC811) has a discharge capacity retention of at least 70% after 600 cycles, and preferably a discharge capacity retention at least 80% after 600 cycles. In some embodiments, the battery cell comprising the cathode having the 3D nano-carbon matrix (e.g., NX NMC811) has a discharge capacity retention of approximately 70% after 1000 cycles. In some embodiments, the battery cell comprising the cathode having the 3D nano-carbon matrix (e.g., NX NMC811) has a discharge capacity retention of between 80% and 90% after 600 cycles.

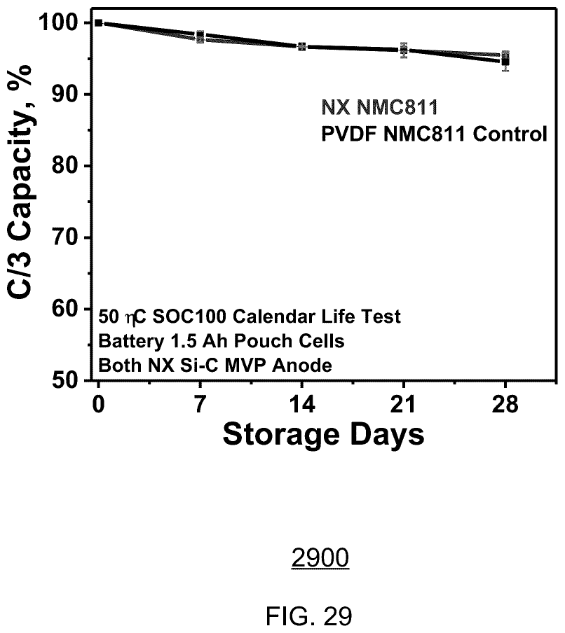

FIG. 29 illustrates a graph illustrating performance of a battery cell comprising an electrode according to various embodiments. FIG. 29 provides a graph of a capacity in relation to storage time. For example, the battery cells were measured according to a 50 degrees Celsius SOC100 calendar life test. The battery cells measured in FIG. 29 are 1.5 Ah pouch battery cells that comprise a NX Si—C anode electrode (e.g., an electrode having a 3D nano-carbon matrix), a cathode according to various embodiments (e.g., a cathode having a 3D nano-carbon matrix). As illustrated in FIG. 29, the battery cell comprising the cathode having the 3D nano-carbon matrix (e.g., NX NMC811) has a capacity retention of at least 95% after 21 days. In some embodiments, the battery cell comprising the cathode having the 3D nano-carbon matrix (e.g., NX NMC811) has capacity retention of approximately at least 95% after 28 days. In some embodiments, the battery cell comprising the cathode comprising the 3D nano-carbon matrix (e.g., NX NMC811) has capacity retention of approximately at least 96% after 28 days. In some embodiments, the battery cell comprising the cathode having the 3D nano-carbon matrix (e.g., NX NMC811) has a capacity retention after 28 days that is at least 1% better than a control 1.5 Ah pouch battery cell having a PVDF cathode.

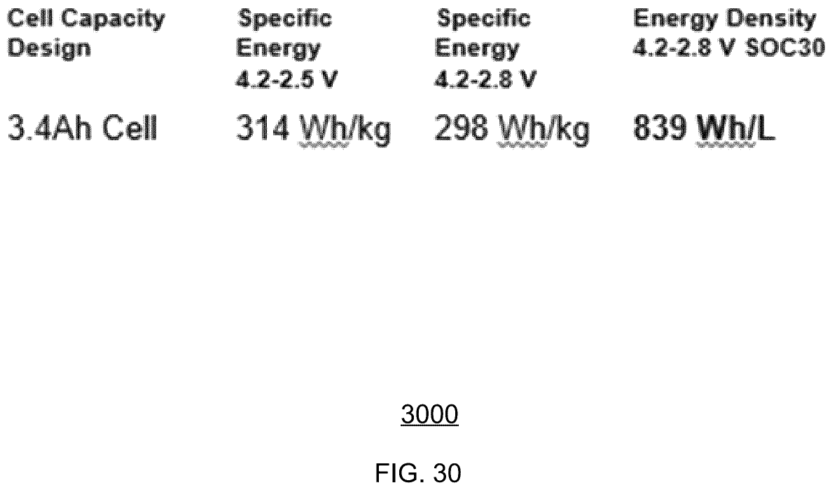

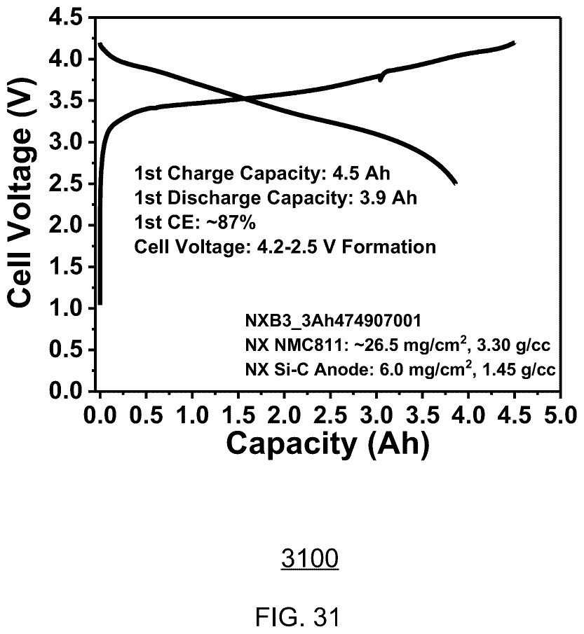

FIGS. 30 and 31 illustrate performance of a battery cell comprising an electrode according to various embodiments of the present application. The battery cell for which performance is provided in FIGS. 30 and 31 is a pouch cell including dimensions of a 46.5 mm×46.5 mm×7.14 mm, and a cathode comprising a 3D nano-carbon matrix (e.g., NX NMC811). FIG. 30 provides a chart that indicates the cell capacity design, the specific energies, and energy density. FIG. 31 provides a graph of the cell voltage in relation to capacity.

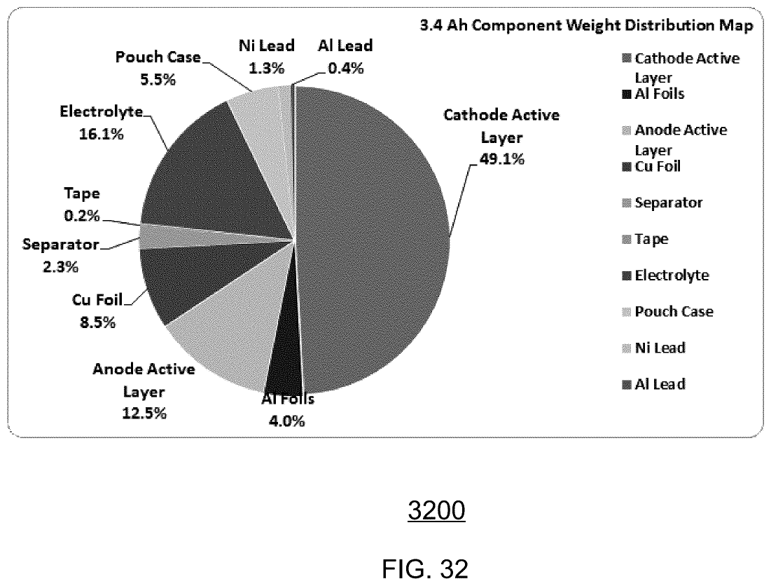

FIG. 32 illustrates a weight distribution of a battery cell according to various embodiments. The battery cell for which weight distribution is measured in FIG. 32 is a 3.4 Ah pouch cell comprising a cathode including the 3D nano-carbon matrix (e.g., NX NMC811).

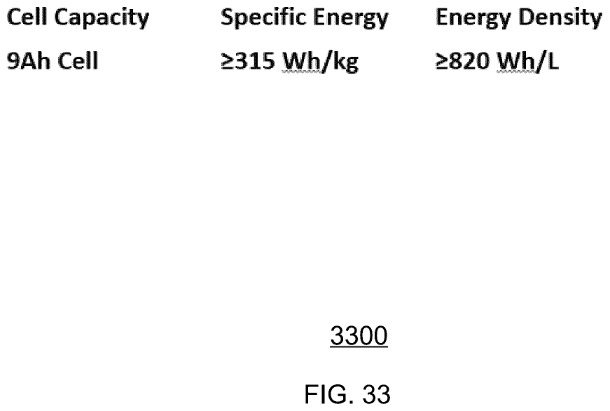

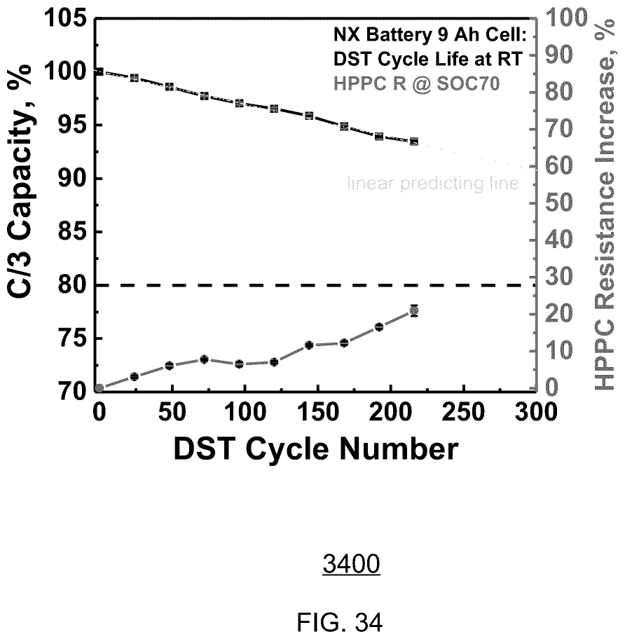

FIGS. 33 and 34 illustrate performance of a battery cell comprising an electrode according to various embodiments of the present application. The battery cell for which performance is provided in FIGS. 33 and 34 is a pouch cell including dimensions of 62 mm×107 mm and 5.4 mm, and a cathode comprising a 3D nano-carbon matrix (e.g., NX NMC811). FIG. 33 provides a chart that indicates the cell capacity design, the specific energies, and energy density. FIG. 34 provides a graph of the capacity relative to DST cycle number. According to various embodiments, the battery cell comprises a specific energy of greater than or equal to 315 Wh/kg, an energy density of greater than or equal to 820 Wh/L, and a cell capacity of 9 Ah. The battery cell according to various embodiments exhibits a DST cycle stability of at least about 70% at 1000 cycles, at least 92.5% at 225 cycles, and/or greater than 90 percent at 300 cycles.

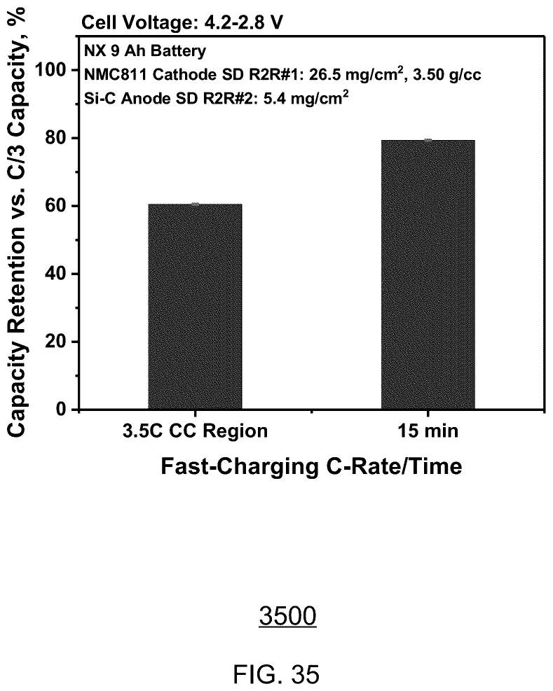

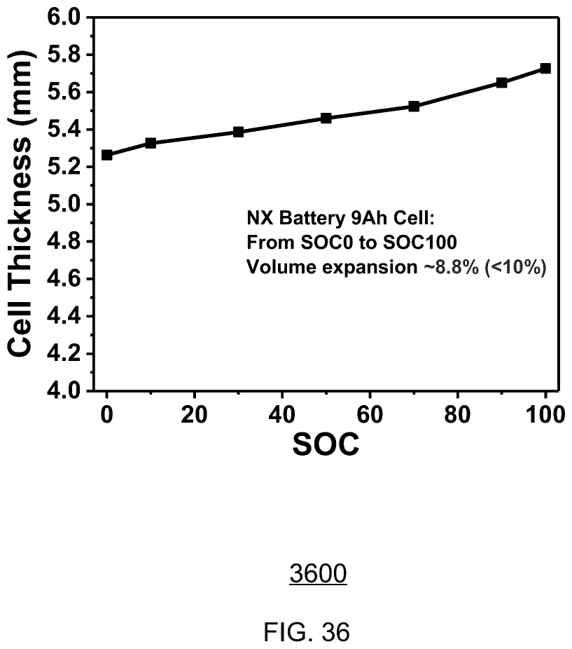

FIGS. 35 and 36 illustrates a chart of a performance of a battery cell comprising an electrode according to various embodiments of the present application. As illustrated in FIG. 36, battery cell according to various embodiments (e.g., a 9 Ah pouch cell comprising a cathode comprising a 3D nano-carbon matrix) exhibits a volume expansion of less than 10% from 0% charge to 100% charge. In some embodiments, such battery cell exhibits a volume expansion of less than 9% from 0% charge to 100%. In some embodiments, such battery cell exhibits a volume expansion of about 8.8% from 0% charge to 100%.

### Example

This example demonstrates cell performance when anodes containing anode active material graphite/SiOx, cathodes containing cathode active material LMFP are used in a cell that is free of a fluorinated binder. The binder used in the anode and cathode is relatively free of fluorine and has less than 900 parts per million. The amount of fluorine used in the cell is less than 900 parts per million based on a total weight of the cell. The polymeric binder used is free of per- and polyfluoroalkyl substances (PFASs).

The cathode active material (CAM) which is a mixture of NCM811 and LMFP is present in the cathode layer in an amount of greater than 95 wt %, based on a total weight of the cathode active layer. The cathode active material is greater than 95 wt %, based on a total weight of the cathode active layer for all of the figures detailed below.

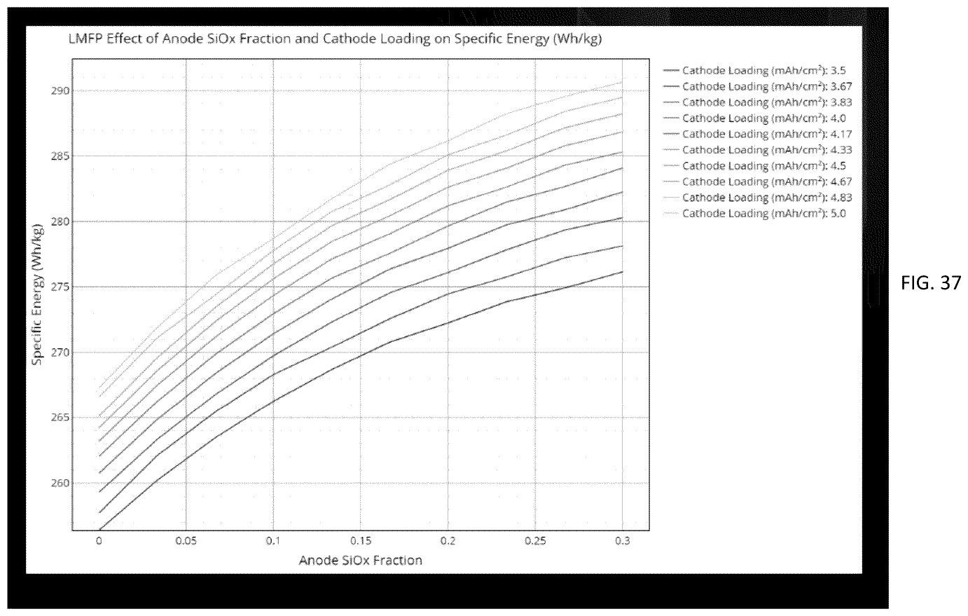

FIG. 37 is a graph depicting the specific energy as a function of the SiOx fraction used in the anode active layer. The discharge capacity per unit area (mAh/cm²) of the battery was 3.5 to 5.0 during the specific energy measurements. From the graph it may be seen that the specific energy is higher for higher voltages and for higher amounts of SiOx relative to the graphite in the anode active layer. The cell shows a high energy density of greater than 275 watt-hours per kilogram (Wh/kg), greater than 280 watt-hours per kilogram. The cell displays a long cycle life of greater than 1000 cycles at 80% initial capacity.

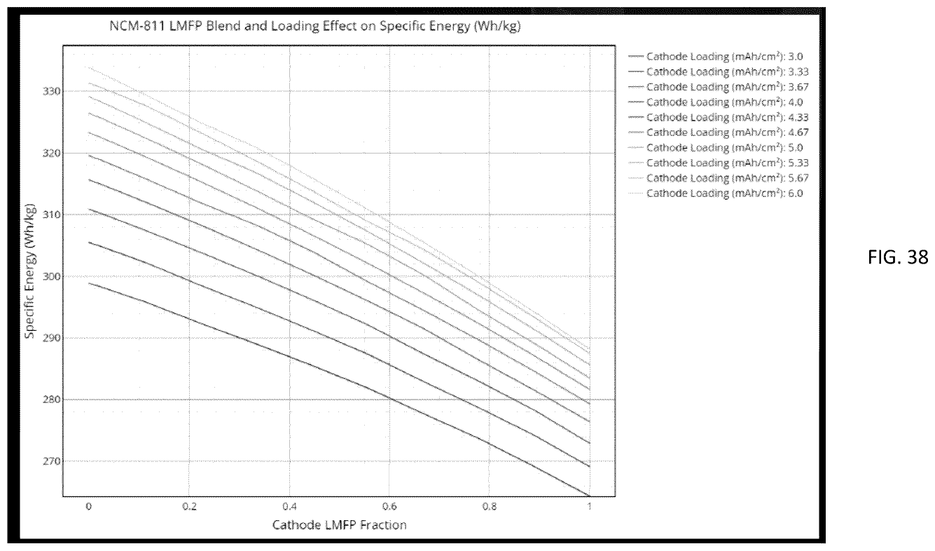

FIG. 38 shows the specific energy as a function of the LMFP fraction used in the cathode. As noted above, the cathode active layer contained a blend of NCM811 and LMFP. The anode contained 10 wt % of SiOx relative to the graphite. From the FIG. 38 it may be seen that the discharge capacity per unit area (mAh/cm²) of the battery was 3.5 to 6.0 during the specific energy measurements. From the graph it may be seen that the specific energy is higher for higher voltages and for lower amounts LMFP relative to the NMC in the cathode active layer. The cell shows a high energy density of greater than 305 watt-hours per kilogram (Wh/kg), greater than 320 watt-hours per kilogram. The cell displays a long cycle life of greater than 1000 cycles at 80% initial capacity.

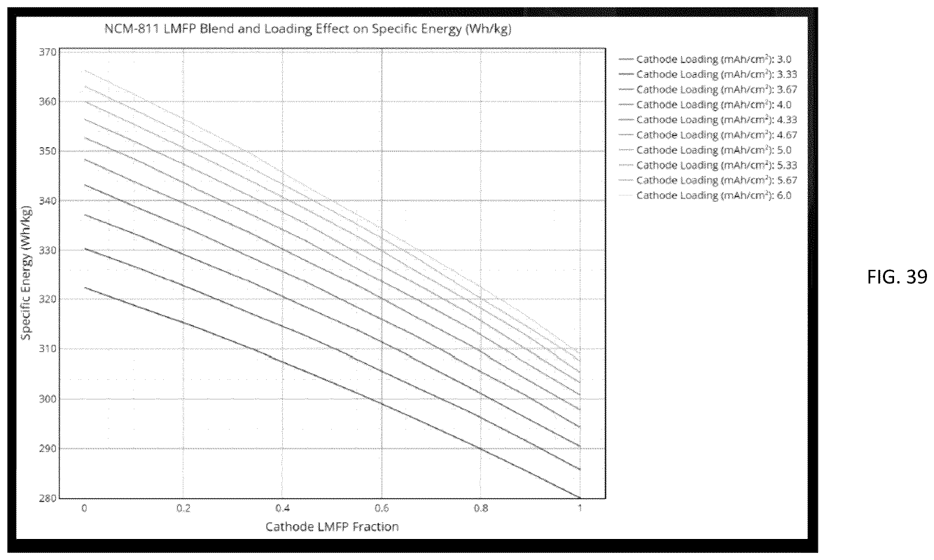

FIG. 39 shows the specific energy as a function of the LMFP fraction used in the cathode. As noted above, the cathode active layer contained a blend of NCM811 and LMFP. The anode contained 30 wt % of SiOx relative to the graphite. From the FIG. 39 it may be seen that the discharge capacity per unit area (mAh/cm²) of the battery was 3.0 to 6.0 during the specific energy measurements. From the graph it may be seen that the specific energy is higher for higher voltages and for lower amounts LMFP relative to the NMC in the cathode active layer. The cell shows a high energy density of greater than 330 watt-hours per kilogram (Wh/kg), greater than 360 watt-hours per kilogram. The cell displays a long cycle life of greater than 1000 cycles at 80% initial capacity.

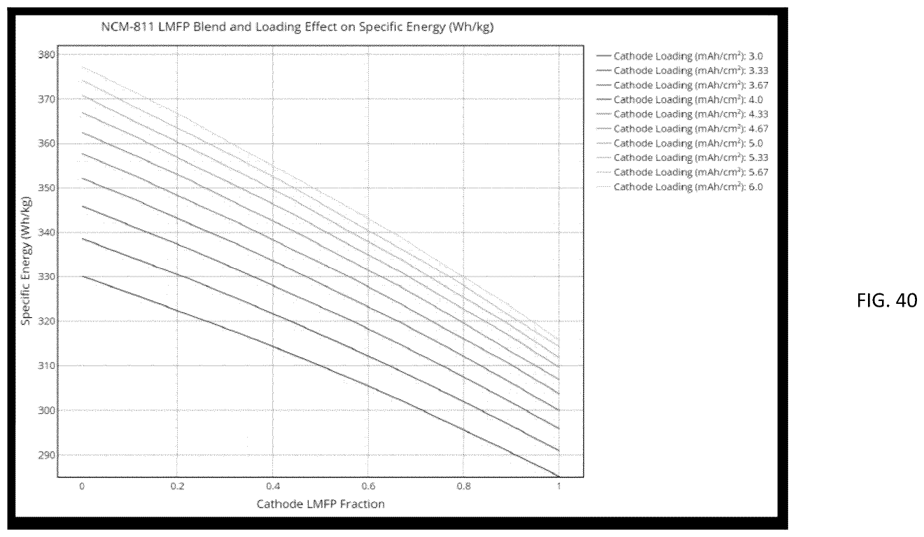

FIG. 40 shows the specific energy as a function of the LMFP fraction used in the cathode. As noted above, the cathode active layer contained a blend of NCM811 and LMFP. The anode contained 40 wt % of SiOx relative to the graphite. From the FIG. 40 it may be seen that the discharge capacity per unit area (mAh/cm²) of the battery was 3.0 to 6.0 during the specific energy measurements. From the graph it may be seen that the specific energy is higher for higher voltages and for lower amounts LMFP relative to the NMC in the cathode active layer. The cell shows a high energy density of greater than 360 watt-hours per kilogram (Wh/kg), greater than 370 watt-hours per kilogram. The cell displays a long cycle life of greater than 1000 cycles at 80% initial capacity.

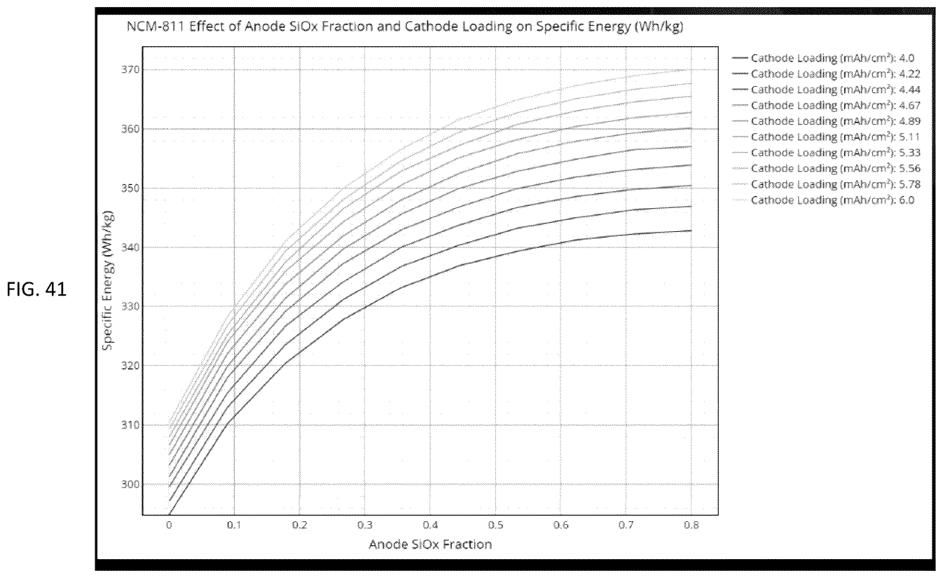

FIG. 41 is a graph depicting the specific energy as a function of the SiOx fraction used in the anode active layer. The discharge capacity per unit area (mAh/cm²) of the battery was 4.0 to 6.0 during the specific energy measurements. From the graph it may be seen that the specific energy is higher for higher voltages and for higher amounts of SiOx relative to the graphite in the anode active layer. The cell shows a high energy density of greater than 350 watt-hours per kilogram (Wh/kg), greater than 360 watt-hours per kilogram. The cell displays a long cycle life of greater than 1000 cycles at 80% initial capacity.

From the FIGS. 37-41 it may be seen that improved energy storage cell performance is achieved when the SiOx is present in amounts of greater than 50 wt %, preferably greater than 70 wt %, and more preferably greater than 80 wt %, based on a total weight of the anode active material. As noted above, the anode active material comprises SiOx and graphite, where x is 1 to 4.

From the FIGS. 37-41 it may be seen that improved energy storage cell performance is achieved when the LMFP is present in amounts of less than 50 wt %, preferably less than 30 wt %, and more preferably less than 20 wt %, based on a total weight of the cathode active material, with the remainder being a NCM.

Various other components may be included and called upon for providing for aspects of the teachings herein. For example, additional materials, combinations of materials and/or omission of materials may be used to provide for added embodiments that are within the scope of the teachings herein. A variety of modifications of the teachings herein may be realized. Generally, modifications may be designed according to the needs of a user, designer, manufacturer or other similarly interested party. The modifications may be intended to meet a particular standard of performance considered important by that party.

The appended claims or claim elements should not be construed to invoke 35 U.S.C. § 112(f) unless the words “means for” or “step for” are explicitly used in the particular claim.

When introducing elements of the present invention or the embodiment(s) thereof, the articles “a,” “an,” and “the” are intended to mean that there are one or more of the elements. Similarly, the adjective “another,” when used to introduce an element, is intended to mean one or more elements. The terms “including” and “having” are intended to be inclusive such that there may be additional elements other than the listed elements. As used herein, the term “exemplary” is not intended to imply a superlative example. Rather, “exemplary” refers to an example of an embodiment that is one of many possible embodiments.

The following example are merely illustrative of various disclosed herein and are not intended to limit the scope hereof. Unless otherwise stated, all examples were based upon simulations.

In general, the invention may alternately comprise, consist of, or consist essentially of, any appropriate components herein disclosed.

What is claimed is:

1. An energy storage device, comprising:
an electrolyte;
an active layer comprising:
an anode active material that comprises silicon and graphite;
a cathode active layer comprising:
a cathode active material that comprises a blend of LMFP and NCM; where the NCM is present in a larger amount than the LMFP;
where each of the anode active material and the cathode active material comprises a polymeric binder that has less than 900 parts per million of fluorine.

2. The energy storage device of claim 1, wherein the silicon comprises particles in the form of SiOx, where x is 1 to 4.

3. The energy storage device of claim 1, wherein the silicon is microsilicon.

4. The energy storage device of claim 2, wherein the SiOx is present in amount of greater than 50 wt %, based on a total weight of the anode active material.

5. The energy storage device of claim 1, wherein the SiOx is present in amount of greater than 80 wt %, based on a total weight of the anode active material.

6. The energy storage device of claim 1, wherein LMFP is present in an amount of less than 50 wt %, based on a total weight of the cathode active material.

7. The energy storage device of claim 1, wherein the anode active layer comprises the anode active material in an amount of greater than equal to 90 wt %, based on a total weight of the anode active layer.

8. The energy storage device of claim 1, wherein the anode active layer comprises the anode active material in an amount of greater than equal to 95 wt %, based on a total weight of the anode active layer.

9. The energy storage device of claim 1, wherein the cathode active layer comprises the cathode active material in an amount of greater than equal to 90 wt %, based on a total weight of the anode active layer.

10. The energy storage device of claim 1, wherein the cathode active layer comprises the cathode active material in an amount of greater than equal to 95 wt %, based on a total weight of the anode active layer.

11. The energy storage device of claim 1, wherein the anode active layer further comprises an electrically conducting additive.

12. The energy storage device of claim 1, wherein the cathode active layer further comprises an electrically conducting additive.
